(19) United States
(12) Patent Application Publication
(10) Pub. No.: US 2015/0310142 A1
(43) Pub. Date: Oct. 29, 2015

(54) METHODS AND SYSTEMS OF PROVIDING ITEMS TO CUSTOMERS VIA A NETWORK

(71) Applicants: Arthur T. Niemeyer, Austin, TX (US); Bruce A. Mayer, Austin, TX (US); James D. Keeler, Austin, TX (US); Mitchell D. Wilson, Austin, TX (US); Dylan P. Spurgin, Austin, TX (US); Matthew C. Brace, Austin, TX (US)

(72) Inventors: Arthur T. Niemeyer, Austin, TX (US); Bruce A. Mayer, Austin, TX (US); James D. Keeler, Austin, TX (US); Mitchell D. Wilson, Austin, TX (US); Dylan P. Spurgin, Austin, TX (US); Matthew C. Brace, Austin, TX (US)

(73) Assignee: INVODO, INC., Austin, TX (US)

(21) Appl. No.: 14/640,216

(22) Filed: Mar. 6, 2015

Related U.S. Application Data
(62) Division of application No. 13/601,537, filed on Aug. 31, 2012.
Application No. 13/601,537 is a continuation-in-part of application No. 13/428,128, filed on Mar. 23, 2012.
(60) Provisional application No. 61/627,349, filed on Oct. 11, 2011.

(51) Int. Cl. G06F 17/50; H04L 29/08

(52) U.S. Cl. CPC G06F 17/5009; H04L 67/10; H04L 67/02

(57) ABSTRACT

In one or more embodiments, a system can simulate one or more physical mobile devices and can allow respective one or more users to utilize respective one or more simulations via a network. For example, a user, utilizing an application such as a web browser, can interact with a simulated mobile device. For instance, the user can select a function of the simulated mobile device, the simulated mobile device can provide, to the user, a simulation of the function, the first user can manipulate the simulated mobile device, and output of the function can be displayed to the user in accordance with the manipulation of the simulated mobile device. In one or more embodiments, the system can determine and display multiple images, of the simulated mobile, device based on multiple directions of a pointer path. For example, the system can determine the directions based on positions acquired at time intervals.

This application is a divisional of U.S. application Ser. No. 13/601,537, filed 31 Aug. 2012, which is a continuation-in-part of U.S. application Ser. No. 13/428,128, filed 23 Mar. 2012, titled “Methods And Systems Of Providing Items To Customers Via a Network”, which claims benefit of U.S. Provisional Application Ser. No. 61/627,349, filed 11 Oct. 2011, titled “Methods and Systems of Providing Items to Customers via a Network”. Each of U.S. application Ser. No. 13/601,537, filed 31 Aug. 2012, titled “Methods and Systems of Providing Items to Customers Via a Network,” U.S. application Ser. No. 13/428,128, filed 23 Mar. 2012, titled “Methods And Systems Of Providing Items To Customers Via a Network” and U.S. Provisional Application Ser. No. 61/627,349, filed 11 Oct. 2011, titled “Methods and Systems of Providing Items to Customers via a Network” is hereby incorporated by reference in its entirety as though fully and completely set forth herein.

### BACKGROUND

1. Technical Field

This disclosure relates generally to the field of electronic commerce and, more specifically, this disclosure pertains to the field of presenting video or other dynamic media.

2. Description of the Related Art

Videos are used in electronic commerce (e-commerce) on web sites to promote products and provide information to customers that visit the e-commerce site. The content of videos are static in that they only display non-dynamic content of a video file. For example, a user can start, pause, rewind, and play the video again, but the content does not change. The video will typically be included in a web page with other content such as text and/or graphics. In some web sites, there are three-dimensional representation (e.g., 3-D photo) views of a product. Aside from changing the angle of the view, there is no interaction with the product within the viewer. In addition, there may be a chat portal for real-time help. The chat portal may contain real-time streaming video between a customer (e.g., a user) and the service representative of the retailer, but the chat portal is not connected, in any manner, to the video player or three-dimensional viewer.

### BRIEF DESCRIPTION OF THE DRAWINGS

The preferred embodiments will become apparent upon reading the following detailed description and upon reference to the accompanying drawings in which:

FIG. 1 provides a block diagram of a network communications system, according to one or more embodiments;

FIGS. 2A-2D provide block diagrams of a computing device, according to one or more embodiments;

FIG. 3 illustrates an exemplary client interface, according to one or more embodiments;

FIGS. 4A-4E provide exemplary diagrams of a media interface displaying an object, according to one or more embodiments;

FIG. 5A provides an exemplary diagram of rotations of an object, according to one or more embodiments;

FIGS. 5B-5I provide a series of two-dimensional graphics representing rotations of an object, according to one or more embodiments;

FIGS. 5J and 5K provide exemplary diagrams of a path of a pointer, according to one or more embodiments;

FIG. 5L provides a method of displaying multiple images, according to one or more embodiments;

FIG. 5M provides an exemplary diagram of multiple positions of a path of pointer, according to one or more embodiments;

FIG. 5N provides an exemplary diagram of multiple vectors that can be determined from multiple positions of a path of pointer, according to one or more embodiments;

FIG. 5O provides exemplary diagrams of sectors, according to one or more embodiments;

FIGS. 5P and 5Q provide exemplary diagrams of vectors intersecting sectors, according to one or more embodiments;

FIG. 5R provides a method of returning to a home frame, according to one or more embodiments;

FIGS. 5S and 5T provide exemplary images associated with and/or corresponding to frames, according to one or more embodiments;

FIGS. 6A-6C provide exemplary diagrams of a simulated object, according to one or more embodiments;

FIG. 6D provides an exemplary diagram of a simulated object with operational aids, according to one or more embodiments;

FIG. 6E provides an exemplary diagram of a network system that supports physical device emulation, according to one or more embodiments;

FIG. 6F provides a method of operating an application programming interface server application, according to one or more embodiments;

FIG. 6G provides a method of operating emulator server application, according to one or more embodiments;

FIG. 6H provides a method of operating another emulator server application, according to one or more embodiments;

FIG. 6I provides a method of operating a client that can interact with an emulator, according to one or more embodiments;

FIG. 6J provides a method of providing multiple simulated objects to multiple CCDs, according to one or more embodiments;

FIGS. 7A-7C provide exemplary diagrams of an interactive media interface, according to one or more embodiments;

FIGS. 7D-7G illustrate a method of operating a media server interface, according to one or more embodiments;

FIG. 8 provides a block diagram of an exemplary process of transforming image data associated with an object into data that can be utilized by a media interface, according to one or more embodiments;

FIG. 9 illustrates a method of transforming image data of a two-dimensional shape into meta data of the shape, according to one or more embodiments;

FIG. 10 provides an exemplary diagram of a two-dimensional shape covered by circles that lie on a polygon;

FIG. 11A provides an exemplary diagram of an exemplary radius at a first angle, according to one or more embodiments;

FIG. 11B provides an exemplary diagram of an exemplary radius at a second angle, according to one or more embodiments;

FIG. 11C provides an exemplary diagram of an exemplary radius at a third angle, according to one or more embodiments;

FIG. 12 illustrates a method of transforming image data of a three-dimensional shape into meta data of the shape, according to one or more embodiments;

FIG. 13A provides an exemplary diagram of a shape enclosed by a polyhedron, according to one or more embodiments;

FIGS. 13B and 13C provide exemplary diagrams of spheres that cover a shape and lie on edges of a polyhedron, according to one or more embodiments;

FIG. 14A provides an exemplary diagram of a radius of a sphere at a first angle of a first spherical dimension and a second angle of a second spherical dimension, according to one or more embodiments;

FIG. 14B provides an exemplary diagram of a different perspective of a radius of a sphere at a first angle of a first spherical dimension, according to one or more embodiments;

FIG. 14C provides an exemplary diagram of a different perspective of a radius of a sphere at a second angle of a second spherical dimension, according to one or more embodiments;

FIG. 15 illustrates another method of transforming image data of a three-dimensional shape into meta data of the shape, according to one or more embodiments;

FIG. 16A provides an exemplary diagram of a shape enclosed by a cube, according to one or more embodiments;

FIG. 16B provides an exemplary diagram of centers of spheres that lie on an edge of a cube, according to one or more embodiments;

FIG. 16C provides an exemplary diagram of centers of spheres that lie on edges of a cube, according to one or more embodiments;

FIG. 16D provides an exemplary diagram of centers of a sphere that lie on a face of a cube, according to one or more embodiments;

FIG. 16E provides an exemplary diagram of centers of spheres that lie on faces of a cube and centers spheres that lie on edges of the cube, according to one or more embodiments;

FIG. 16F provides an exemplary diagram of a radius of a sphere at a first angle of a first spherical dimension and a second angle of a second spherical dimension, according to one or more embodiments;

FIG. 16G provides an exemplary diagram of a different perspective of a radius of a sphere at a first angle of a first spherical dimension, according to one or more embodiments;

FIG. 16H provides an exemplary diagram of a different perspective of a radius of a sphere at a second angle of a second spherical dimension, according to one or more embodiments;

FIG. 17 illustrates a method of reducing data associated with a shape, according to one or more embodiments;

FIG. 18 illustrates a method of producing a shape from reduced data associated with the shape, according to one or more embodiments;

FIG. 19 illustrates a network system that supports storage of data and configurations of physical devices and emulation of the physical devices, according to one or more embodiments;

FIGS. 20-22 provide exemplary network system diagrams of storing mobile device data, according to one or more embodiments;

FIGS. 23-25 provide exemplary network system diagrams of restoring mobile device data, according to one or more embodiments;

FIGS. 26-28 provide exemplary network system diagrams of restoring/storing mobile device data to new mobile devices, according to one or more embodiments;

FIG. 29 illustrates a network system that supports installation of data and configurations of one or more physical mobile devices to one or more respective emulators, according to one or more embodiments;

FIGS. 30-32 provide exemplary local network system diagrams of storing mobile device data, according to one or more embodiments;

FIGS. 33-35 provide exemplary local network system diagrams of restoring mobile device data, according to one or more embodiments;

FIGS. 36 and 37 illustrates a network systems that supports storage of data and configurations of physical mobile devices, according to one or more embodiments;

FIGS. 38-40 provide exemplary network system diagrams of restoring storing mobile device data to new mobile devices, according to one or more embodiments;

FIG. 41 illustrates a local network system that supports installation of data and configurations and utilization of an emulator, according to one or more embodiments;

FIGS. 42 and 43 illustrate an exemplary computing devices, according to one or more embodiments;

FIG. 44 illustrates a network system that supports installation of data and configurations and utilization of multiple emulators, according to one or more embodiments;

FIG. 45 illustrates an exemplary computing system, according to one or more embodiments;

FIG. 46 provides a method of a computer system receiving and storing mobile device data, according to one or more embodiments

FIG. 47 provides a method of a mobile device receiving and storing mobile device data, according to one or more embodiments;

FIGS. 48 and 49 provide methods of transforming telecommunications signals, according to one or more embodiments; and

FIGS. 50 and 51 provide methods of utilizing an emulator as a telephony device, according to one or more embodiments.

While one or more embodiments may be susceptible to various modifications and alternative forms, specific embodiments thereof are shown by way of example in the drawings and will herein be described in detail. It should be understood, however, that the drawings and detailed description thereto are not intended to limit the disclosure to the particular form disclosed, but on the contrary, the disclosure is to cover all modifications, equivalents and alternatives falling within the spirit and scope of any invention as defined by any appended claim(s).

### DETAILED DESCRIPTION

In one or more embodiments, a graphical user interface (GUI) can be provided to a customer (e.g., a user) on a computer, mobile telephone, or other computing device, and the GUI can allow the customer to interact with a simulated object (e.g., a computer system, a digital music player, a wireless telephone, an article of clothing, jewelry, software, etc.) via a public network. For example, the public network can include one or more of an Internet, a cellular communications network (e.g., a cellular telephone network), a satellite communications network (e.g., a satellite telephone communications network), and a wireless metropolitan network (e.g., a WiMax network), among others.

In one or more embodiments, data can be provided to the GUI allowing the GUI to respond to customer input (e.g., user input) provided via a mouse, pointing device, touch screen, voice recognition system, or other instrument for user input to a GUI. For example, the data provided to the GUI can enable the GUI to provide multiple images of the object, at different viewing angles, to the customer in response to the customer input, thereby presenting a simulation of the object in the GUI's. For instance, the data provided to the GUI can include a multiple dimension matrix of two-dimensional images of the object, where the two-dimensional images can include images of the object at different viewing angles. When the multiple dimension matrix is presented to the user via the GUI, it can provide a seemingly non-discontinuous presentation of the object to the customer as the customer changes viewing angles, according to one or more embodiments. Further, this system can reduce one or more of computation time and network bandwidth, according to one or more embodiments.

In one or more embodiments, the GUI can provide, to the customer, a simulated object configured to demonstrate one or more aspects, operations, and/or features of the object and can be configured with information associated with a profile of the customer to represent the one or more aspects, operations, and/or features of the object that are associated with the profile of the customer. In one or more embodiments, the profile of the customer can include one or more of a sport, a gender, a yearly income, an automobile type, a marital status, a credit history, a past transaction, a past purchase, a music genre, an interest, an employment status, an age, a height, a weight, a hair color, an eye color, a shoe size, a dress size, a waist size, an inseam size, a breast size, a chest size, and a membership, among others.

In one or more embodiments, the GUI can provide, to the customer, an interactive communications feature. In one example, the interactive communications feature can provide the customer with a video of a service representative. For instance, a customer service representative can interact with the customer directly via the interactive communications feature.

The customer service representative can interact with the customer by controlling the GUI via a remotely located computer system (e.g., remotely located with respect to a location of the customer and/or the customer service representative), according to one or embodiments. For example, the customer service representative can demonstrate one or more features and/or explain one or more functions of the object. In one instance, the customer service representative can control the GUI to highlight one or more features of the object and/or rotate the object to a specific view of the object. In another instance, the customer service representative can control the GUI to manipulate the multiple dimension matrix or forward or reverse a video of or associated with the object to a particular frame of the video. In one or more embodiments, a first application executing on a computing device of the customer can provide and/or control the GUI, and the customer service representative can remotely control the first application, via the public network, and/or instantiate or launch a second application on the computing device of the customer.

In one or more embodiments, the customer service representative can interact with the customer in a unicast fashion. In one example, the customer service representative can demonstrate, to the customer, the one or more features and/or explain the one or more functions of the object, via the customer's computing device, without demonstrating the one or more features and/or explaining the one or more functions of the object, via other customers' computing devices, to the other customers that can access and/or interact with the simulated object via the public network. For instance, the computing device of the customer can be identified via one or more identifiers, and the customer service representative can interact with the customer via the customer's computing device identified via the one or more identifiers.

In one or more embodiments, the one or more identifiers can include one or more of a network identifier, a port identifier, a sequence identifier, a next sequence identifier, a certificate identifier, and a hash identifier, among others. In one example, the network identifier can include a network address. For instance, the network address can include one or more of an Internet protocol (IP) address (e.g., an IP version 4 address, an IP version 6 address, etc.), a media access control (MAC) address, an electronic serial number (ESN), a mobile information number (MIN), and a mobile directory number (MDN), among others. In a second example, the port identifier can include a port number. In one instance, the port number can be a transmission control protocol (TCP) port number. In another instance, the port number can be a user datagram protocol (UDP) port number.

In a third example, the sequence identifier can include a sequence number. For instance, the sequence number can be a sequence number of a data packet (e.g., a TCP data packet). In a fourth example, the next sequence identifier can include a next sequence number. In one instance, the next sequence number can be a sequence number of a next or expected data packet from another computing device. In another instance, the next sequence identifier can include an acknowledgement number (e.g., a next sequence number that a first computing device expects to receive, as a next sequence number, from a second computing device in communication with the first computing device). In a fifth example, the certificate identifier can include a digital certificate. For instance, the digital certificate can include an X.509 certificate.

In a sixth example, the hash identifier can include a hash value. For instance, the hash value can include a result of a hash process of source data. In one or more embodiments, the hash function can include one or more of a message digest 2 hash process, a message digest 4 hash process, a message digest 5 hash process, a message digest 6 hash process, and a secure hash process (e.g., SHA-0, SHA-1, SHA-2, SHA-3, etc.), among others. In one or more embodiments, each of a customer computing device, a media access server, and a customer service computing device can be uniquely identified by utilizing a unique identifier or a combination of identifiers that creates a unique identifier to provide, via a public network, an electronic-market and/or a cyber-market environment which provides custom media and/or custom responses to customer input received via the customer's computing device.

In one or more embodiments, the GUI can provide a simulated person (e.g., an avatar) that can interact with the customer. For example, the customer can interact with the simulated person and the object (e.g., the object for sale or for service) in a same or similar fashion as the customer would interact with a person (e.g., a human being), such as a customer service representative of a retail establishment. For instance, the simulated person can be configured to demonstrate one or more aspects, configurations, and/or features of the object and can be configured with information associated with a profile of the customer to represent the one or more aspects, configurations, and/or features of the object that are associated with the profile of the customer. In one or more embodiments, the profile of the customer can include one or more of a sport, a gender, a yearly income, an automobile type, a marital status, a credit history, a past transaction, a past purchase, a music genre, an interest, an employment status, an age, a height, a weight, a hair color, an eye color, a shoe size, a dress size, a waist size, an inseam size, a breast size, a chest size, and a membership, among others. In one or more embodiments, a system that implements the simulated person can include one or more of an artificial intelligence system. For example, the artificial intelligence system can include and/or implement one or more of a neural network system, a rule-based expert system, a fuzzy logic system, a machine learning process, a Bayesian Estimator process, and a Learning Vector Quantization process, among other processes and/or methods.

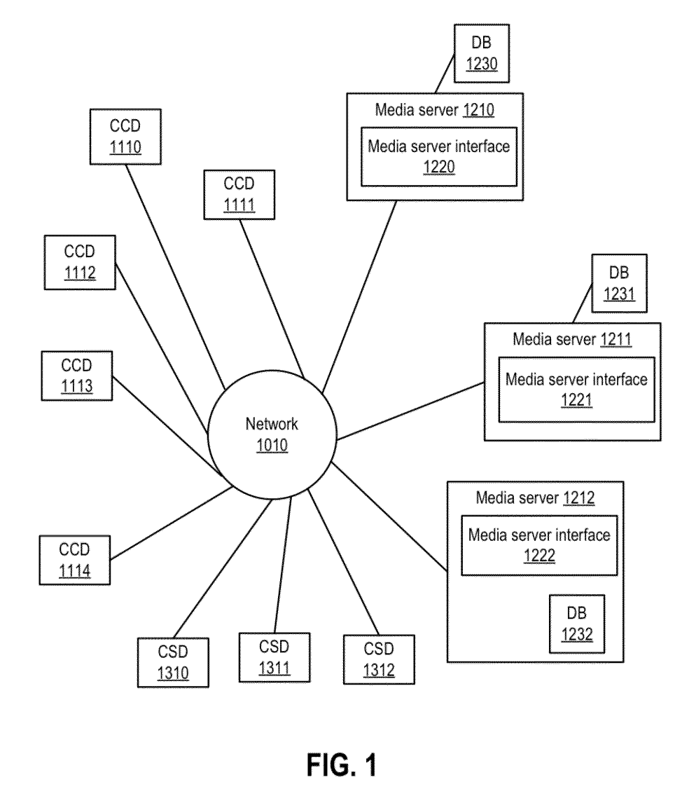

Turning now to FIG. 1, a block diagram of a network communication system is illustrated, according to one or more embodiments. As illustrated, one or more customer computing devices (CCDs) 1110-1114 can be coupled to a network 1010. In one or more embodiments, network 1010 can include one or more of a wireless network and a wired network. Network 1010 can be coupled to one or more types of communications networks, such as one or more of a public switched telephone network (PSTN), a public wide area network (e.g., an Internet), a private wide area network, and a local area network, among others. In one example, network 1010 can be or include an Internet. In another example, network 1010 can form part of an Internet. In one or more embodiments, one or more of CCDs 1110-1114 can be coupled to network 1010 via a wired communication coupling and/or a wireless communication coupling. In one example, a customer computer device (CCD) can be coupled to network 1010 via wired Ethernet, a DSL (digital subscriber loop) modem, or a cable (television) modem, among others. In another example, a CCD can be coupled to network 1010 via wireless Ethernet (e.g., WiFi), a satellite communication coupling, a cellular telephone coupling, or WiMax, among others.

As shown, one or more media servers 1210-1212 can be coupled to network 1010, and media servers 1210-1212 can include media server interfaces 1220-1222, respectively. As illustrated, media servers 1210 and 1211 can be coupled to databases 1230 and 1231, and media server 1212 can include a database (DB) 1232. In one example, DB 1230 can be or include an Oracle database. In a second example, DB 1231 can be or include a Microsoft SQL Server database. In another example, DB 1232 can be or include a MySQL database or a PostgreSQL database.

In one or more embodiments, one or more of media server interfaces 1220-1222 can provide one or more computer system interfaces to one or more of CCDs 1110-1114. In one example, media server interface 1220 can include a web server. In another example, media server interface 1221 can include a server that interacts with a client application of a CCD. In one instance, the client application can include a “smart phone” application. In a second instance, the client application can include a tablet computing device application. In another instance, the client application can include a computing device application (e.g., an application for a desktop or laptop computing device).

As illustrated, one or more customer service devices (CSDs) 1310-1312 can be coupled to network 1010. In one or more embodiments, a service representative (e.g., a customer service representative of a retail establishment, a service representative of a service provider, etc.) can utilize a customer service device (CSD) to interact with a customer utilizing a CCD. For example, the service representative can utilize the CSD to provide information to the customer via the CCD. In one instance, the service representative can utilize the CSD to conduct one or more of a video chat, a text chat, and an audio chat. In a second instance, the service representative can utilize the CSD to illustrate and/or demonstrate one or more features and/or operations of an object for sale or of an object for which service is desired by the customer.

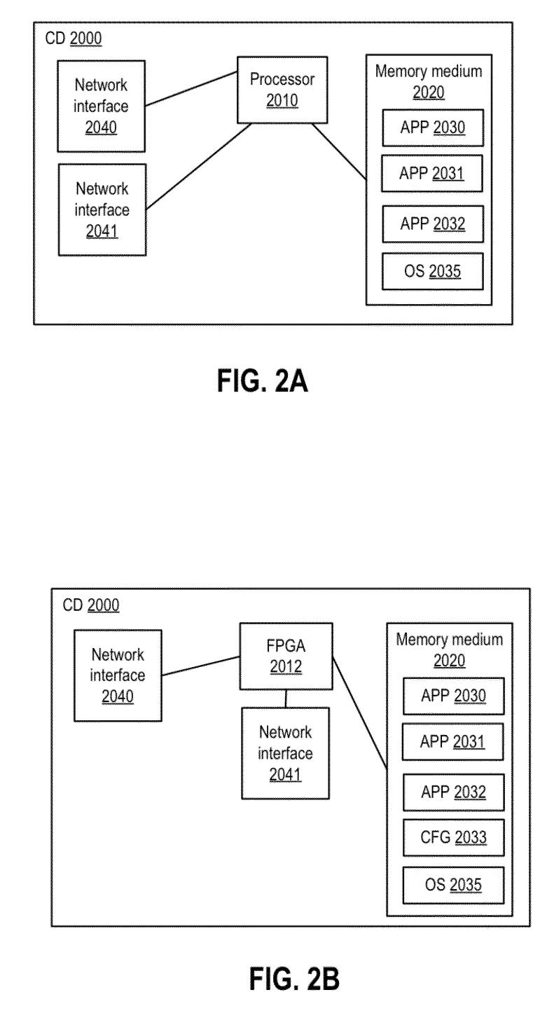

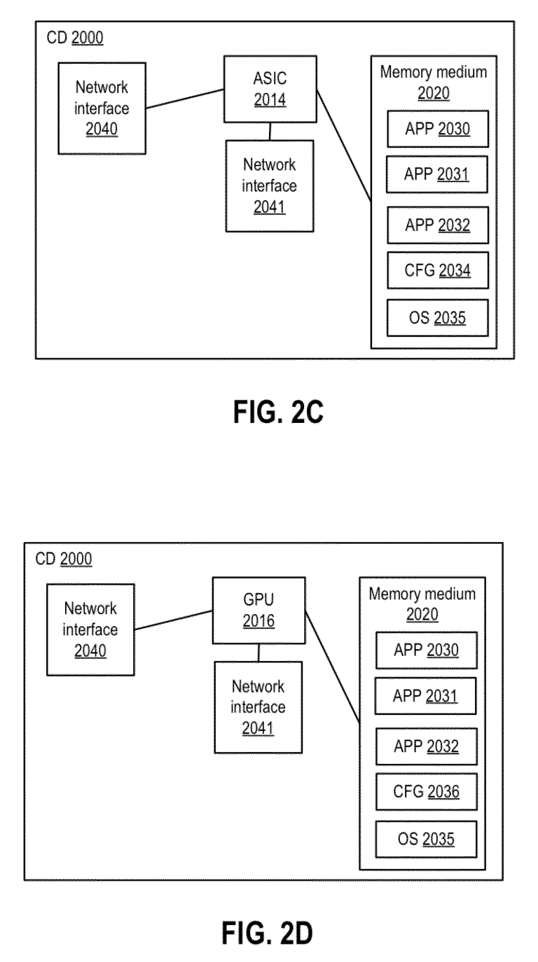

Turning now to FIG. 2A, a computing device is illustrated, according to one or more embodiments. In one or more embodiments, computing device (CD) 2000 illustrated in FIG. 2 can be utilized to implement a CCD and/or a CSD. As shown, CD 2000 can include a processor 2010 coupled to a memory medium 2020. In one or more embodiments, memory medium 2020 can store data and/or instructions that can be executed by processor 2010. For example, memory medium 2020 can store one or more applications (APPs) 2030-2032 and/or an operation system (OS) 2035. For instance, one or more APPs 2030-2032 and/or an OS 2035 can include instructions of an instruction set architecture (ISA) associated with processor 2010. In one or more embodiments, CD 2000 can be coupled to and/or include one or more of a display, a keyboard, and a pointing device (e.g., a mouse, a track ball, a track pad, a stylus, etc.). In one or more embodiments, a touch screen can function as a pointing device. In one example, the touch screen can determine a position via one or more pressure sensors. In another example, the touch screen can determine a position via one or more capacitive sensors.

As illustrated, CD 2000 can include one or more network interfaces 2040 and 2041. In one example, network interface 2040 can interface with a wired network coupling, such as a wired Ethernet, a T-1, a DSL modem, a PSTN, or a cable modem, among others. In another example, network interface 2041 can interface with a wireless network coupling, such as a satellite telephone system, a cellular telephone system, WiMax, or wireless Ethernet, among others.

In one or more embodiments, CD 2000 can be any of various types of devices, including a computer system, a server computer system, a laptop computer system, a notebook computing device, a portable computer, a personal digital assistant (PDA), a handheld mobile computing device, a mobile wireless telephone (e.g., a satellite telephone, a cellular telephone, etc.), an Internet appliance, a television device, a DVD (digital video disc player) device, a Blu-Ray disc player device, a DVR (digital video recorder) device, a wearable computing device, or other wireless or wired device that includes a processor that executes instructions from a memory medium. In one or more embodiments, processor 2010 can include one or more cores. For example, each core of processor 2010 can implement an ISA. In one or more embodiments, one or more of CCDs 1110-1114, media servers 1210-1212, databases 1230 and 1231, and CSDs 1310-1312 can include one or more same or similar structures and/or functionalities described with reference to CD 2000.

Turning now to FIG. 2B, a computing device is illustrated, according to one or more embodiments. As shown, CD 2000 can include a field programmable gate array (FPGA) 2012 coupled to a memory medium 2020. In one or more embodiments, memory medium 2020 can store data and/or configuration information that can be utilized by FPGA 2012 in implementing one or more systems, methods, and/or processes described herein. For example, memory medium 2020 can store a configuration (CFG) 2033, and CFG 2033 can include configuration information and/or one or more instructions that can be utilized by FPGA 2012 to implement one or more systems, methods, and/or processes described herein. For instance, the configuration information and/or the one or more instructions, of CFG 2033, can include a hardware description language and/or a schematic design that can be utilized by FPGA 2012 to implement one or more systems, methods, and/or processes described herein. In one or more embodiments, FPGA 2012 can include multiple programmable logic components that can be configured and coupled to one another in implementing one or more systems, methods, and/or processes described herein.

In one or more embodiments, memory medium 2020 can store data and/or instructions that can be executed by FPGA 2012. For example, memory medium 2020 can store one or more APPs 2030-2032 and/or an OS 2035. For instance, one or more APPs 2030-2032 and/or an OS 2035 can include instructions of an ISA associated with FPGA 2012. In one or more embodiments, CD 2000 can be coupled to and/or include one or more of a display, a keyboard, and a pointing device (e.g., a mouse, a track ball, a track pad, a stylus, etc.). In one or more embodiments, a touch screen can function as a pointing device. In one example, the touch screen can determine a position via one or more pressure sensors. In another example, the touch screen can determine a position via one or more capacitive sensors.

As illustrated, CD 2000 can include one or more network interfaces 2040 and 2041. In one example, network interface 2040 can interface with a wired network coupling, such as a wired Ethernet, a T-1, a DSL modem, a PSTN, or a cable modem, among others. In another example, network interface 2041 can interface with a wireless network coupling, such as a satellite telephone system, a cellular telephone system, WiMax, or wireless Ethernet, among others.

In one or more embodiments, CD 2000 can be any of various types of devices, including a computer system, a server computer system, a laptop computer system, a notebook computing device, a portable computer, a PDA, a handheld mobile computing device, a mobile wireless telephone (e.g., a satellite telephone, a cellular telephone, etc.), an Internet appliance, a television device, a DVD device, a Blu-Ray disc player device, a DVR device, a wearable computing device, or other wireless or wired device that includes a FPGA that processes data according to one or more methods and/or processes described herein. In one or more embodiments, one or more of CCDs 1110-1114, media servers 1210-1212, databases 1230 and 1231, and CSDs 1310-1312 can include one or more same or similar structures and/or functionalities described with reference to CD 2000.

Turning now to FIG. 2C, a computing device is illustrated, according to one or more embodiments. As shown, CD 2000 can include an application specific processor (ASIC) 2014 coupled to a memory medium 2020. In one or more embodiments, memory medium 2020 can store data and/or configuration information that can be utilized by ASIC 2014 in implementing one or more systems, methods, and/or processes described herein. For example, memory medium 2020 can store a CFG 2034, and CFG 2034 can include configuration information and/or one or more instructions that can be utilized by ASIC 2014 to implement one or more systems, methods, and/or processes described herein.

In one or more embodiments, memory medium 2020 can store data and/or instructions that can be executed by ASIC 2014. For example, memory medium 2020 can store one or more APPs 2030-2032 and/or an OS 2035. For instance, one or more APPs 2030-2032 and/or an OS 2035 can include instructions of an ISA associated with ASIC 2014. In one or more embodiments, CD 2000 can be coupled to and/or include one or more of a display, a keyboard, and a pointing device (e.g., a mouse, a track ball, a track pad, a stylus, etc.). In one or more embodiments, a touch screen can function as a pointing device. In one example, the touch screen can determine a position via one or more pressure sensors. In another example, the touch screen can determine a position via one or more capacitive sensors.

As illustrated, CD 2000 can include one or more network interfaces 2040 and 2041. In one example, network interface 2040 can interface with a wired network coupling, such as a wired Ethernet, a T-1, a DSL modem, a PSTN, or a cable modem, among others. In another example, network interface 2041 can interface with a wireless network coupling, such as a satellite telephone system, a cellular telephone system, WiMax, or wireless Ethernet, among others.

In one or more embodiments, CD 2000 can be any of various types of devices, including a computer system, a server computer system, a laptop computer system, a notebook computing device, a portable computer, a PDA, a handheld mobile computing device, a mobile wireless telephone (e.g., a satellite telephone, a cellular telephone, etc.), an Internet appliance, a television device, a DVD device, a Blu-Ray disc player device, a DVR device, a wearable computing device, or other wireless or wired device that includes ASIC that processes data according to one or more methods and/or processes described herein. In one or more embodiments, one or more of CCDs 1110-1114, media servers 1210-1212, databases 1230 and 1231, and CSDs 1310-1312 can include one or more same or similar structures and/or functionalities described with reference to CD 2000.

Turning now to FIG. 2D, a computing device is illustrated, according to one or more embodiments. As shown, CD 2000 can include graphics processing unit (GPU) 2016 coupled to a memory medium 2020. For example, GPU 2016 can be or include a general purpose graphics processing unit (GPGPU). In one or more embodiments, memory medium 2020 can store data and/or configuration information that can be utilized by GPU 2016 in implementing one or more systems, methods, and/or processes described herein. For example, memory medium 2020 can store a CFG 2036, and CFG 2036 can include configuration information and/or one or more instructions that can be utilized by GPU 2016 to implement one or more systems, methods, and/or processes described herein.

In one or more embodiments, memory medium 2020 can store data and/or instructions that can be executed by GPU 2016. For example, memory medium 2020 can store one or more APPs 2030-2032 and/or an OS 2035. For instance, one or more APPs 2030-2032 and/or an OS 2035 can include instructions of an ISA associated with GPU 2016. In one or more embodiments, CD 2000 can be coupled to and/or include one or more of a display, a keyboard, and a pointing device (e.g., a mouse, a track ball, a track pad, a stylus, etc.). In one or more embodiments, a touch screen can function as a pointing device. In one example, the touch screen can determine a position via one or more pressure sensors. In another example, the touch screen can determine a position via one or more capacitive sensors.

As illustrated, CD 2000 can include one or more network interfaces 2040 and 2041. In one example, network interface 2040 can interface with a wired network coupling, such as a wired Ethernet, a T-1, a DSL modem, a PSTN, or a cable modem, among others. In another example, network interface 2041 can interface with a wireless network coupling, such as a satellite telephone system, a cellular telephone system, WiMax, or wireless Ethernet, among others.

In one or more embodiments, CD 2000 can be any of various types of devices, including a computer system, a server computer system, a laptop computer system, a notebook computing device, a portable computer, a PDA, a handheld mobile computing device, a mobile wireless telephone (e.g., a satellite telephone, a cellular telephone, etc.), an Internet appliance, a television device, a DVD device, a Blu-Ray disc player device, a DVR device, a wearable computing device, or other wireless or wired device that includes a GPU that processes data according to one or more methods and/or processes described herein. In one or more embodiments, one or more of CCDs 1110-1114, media servers 1210-1212, databases 1230 and 1231, and CSDs 1310-1312 can include one or more same or similar structures and/or functionalities described with reference to CD 2000.

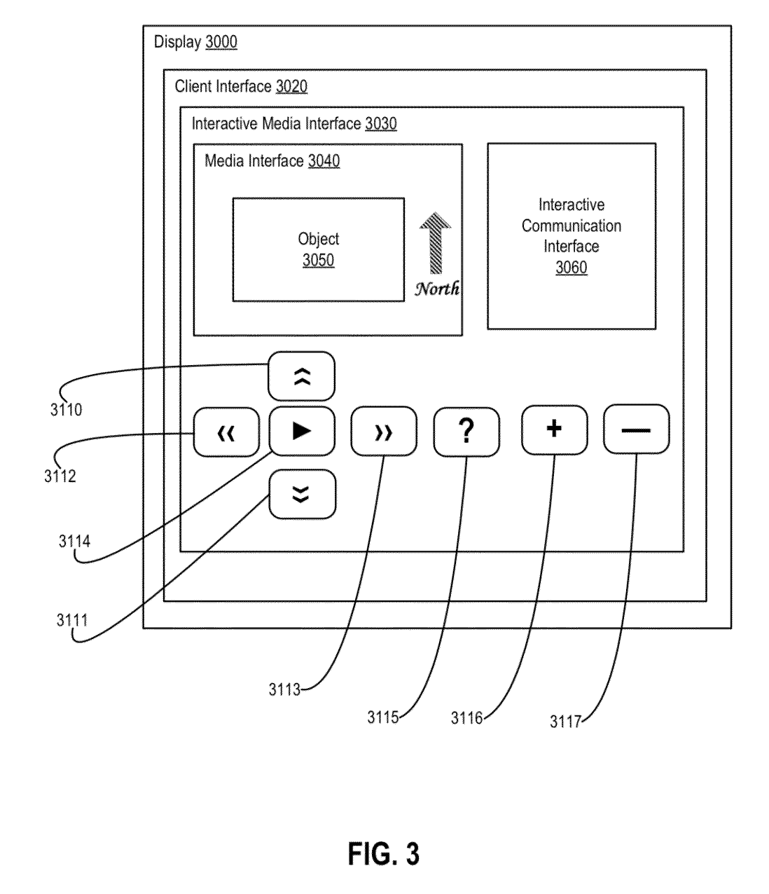

Turning now to FIG. 3, an exemplary client interface is illustrated, according to one or more embodiments. As shown, a display 3000 can display a client interface 3020. In one or more embodiments, display 3000 can be coupled to or included in a computing device. In one example, display 3000 can be coupled to CCD 1111. In another example, display 3000 can be included in CCD 1112. In one or more embodiments, client interface 3020 can be or include a web browser (e.g., Microsoft Internet Explorer, Safari, Firefox, Chrome, Opera, etc.), a window of an application, a full screen display area of display 3000, or a partial screen display area of display 3000. For example, client interface 3020 can be utilized by application (APP) 2030 to provide information to and/or receive user input from a user. In one or more embodiments, an APP (e.g., an APP of APPs 2030-2032) can receive information from a media server (e.g., a media server of media servers 1210-1212) via a network (e.g., network 1010) and can provide the information to a user via client interface 3020.

In one or more embodiments, the APP (e.g., the APP of APPs 2030-2032) can be or include a plug-in to another application (e.g., a web browser) and/or can receive configuration information from a media server. In one example, the plug-in can include a Flash Player (available from Adobe Systems), and the plug-in can interface with the customer via client interface 3030. In one or more embodiments, client interface 3030 can be implemented via one or more of JavaScript, EMCAScript, Java, an extensible markup language (XML), and a hypertext markup language (HTML) (e.g., HTML version four (4), HTML version five (5), etc.). For example, the APP (e.g., the APP of APPs 2030-2032) can be or include a web browser, and the web browser can receive information, from a media server, that includes one or more of JavaScript, EMCAScript, Java (e.g., Java byte code), XML, and HTML version 5, and the web browser can implement client interface 3020 based on the received information that includes one or more of JavaScript, EMCAScript, Java, XML, and HTML version 5.

As illustrated, client interface 3020 can include an interactive media interface 3030 that can provide information to a customer (e.g., a user of a CCD) and/or receive information from a customer. In one example, interactive media interface 3030 can include a media interface 3040 that can display one or more pictures, one or more videos (e.g., motion pictures), one or more graphics, and/or text associated with an object 3050. In one instance, object 3050 can represent and/or include a simulation of an object for sale by a retail establishment. In another instance, object 3050 can represent and/or include a simulation of an object that can be serviced and/or for which service can be provided. In a second example, interactive media interface 3030 can include an interactive communication interface 3060 that can be utilized by one or more of the customer and another user (e.g., a sales representative, a service representing, a representative of a retail establishment, a representative of a service provider, an artificial intelligence system, a neural network system, etc.).

In another example, interactive media interface 3030 can include one or more icons or button 3110-3117 that can be provided to receive user input. In one or more embodiments, object 3050 can include a representation of and/or a simulation of a device, a computer, a cellular telephone, a tablet computing device, a digital music player device, a satellite telephone, a dress, a pair of jeans, a bathing suit, a shoe, lingerie, underwear, a helmet, a sock, stockings, a watch, a necklace, a bracelet, a television, software (e.g., a drawing program, a word processing program, a music player program, a compiler, a computer operating system, a video editing program, etc.), a printer device, a tire, a rim, an automobile part, an automobile, a piece of furniture, or a stapler, among others.

In one or more embodiments, one or more of icons 3110-3113 can be selected by the customer to change a viewing angle of object 3050. In one example, icon 3110 can be selected to rotate object 3050 about a first axis by a number of degrees in a first direction of rotation with respect to the first axis. In a second example, icon 3111 can be selected to rotate object 3050 about the first axis by a number of degrees in a second direction of rotation with respect to the first axis. For instance, the second direction of rotation can be opposite to the first direction of rotation. In a third example, icon 3112 can be selected to rotate object 3050 about a second axis by a number of degrees in a third direction of rotation with respect to the second axis. In another example, icon 3113 can be selected to rotate object 3050 about the second axis by a number of degrees in a fourth direction of rotation with respect to the second axis. For instance, the fourth direction of rotation can be opposite to the third direction of rotation. In one or more embodiments, a pointer can be dragged across media interface 3040 to rotate object 3050 in a direction about an axis.

In one or more embodiments, icon 3114 can be selected to display a video that includes and/or is associated with object 3050. For example, icon 3114 can be selected to display an interactive video that includes and/or is associated with object 3050. For instance, media interface 3040 can display a simulation that includes and/or is associated with object 3050. In one or more embodiments, icon 3115 can be selected to receive information about and/or associated with object 3050. In one example, interactive communication interface 3060 can provide the customer with information when icon 3115 is actuated or selected. In one instance, an avatar (e.g., a graphical approximation and/or rendering of an actual person or a simulated person) can be displayed, via interactive communication interface 3060, that can provide the customer with information. In another instance, interactive communication interface 3060 can provide the customer with a video of a service representative. For example, a customer service representative can interact with the customer directly via text chat and/or video chat via interactive communication interface 3060.

In one or more embodiments, a customer service representative can interact with a customer directly by controlling media interface 3040 via a media server (e.g., a media server of media servers 1210-1212). For example, the customer service representative can, via a media server, rotate object 3050 about an axis, zoom in-on at least a portion of object 3050, zoom out-from object 3050, start a simulation of or associated with object 3050, or start a video of or associated with object 3050, among others. For instance, media server 1210 can receive control information from the customer service representative, via a CSD, and can provide the control information to APP 2030 via network 1010, and APP 2030 can perform, via interactive media interface 3030 and/or media interface 3040, one or more functions associated with the control information.

In one or more embodiments, audio information (e.g., speech, music, etc.) can be provided to the customer via a sound output device included in or coupled to a computing device utilized by the customer. In one example, CCD 1110 can include a speaker, and speech from a customer service representative can be provided to the customer via the speaker. In a second example, CCD 1110 can include a speaker, and speech associated with object 3050 can be provided to the customer via the speaker. In another example, CCD 1110 can include a speaker, and music associated with object 3050 can be provided to the customer via the speaker.

In one or more embodiments, icons 3116 and 3117 can be selected to adjust a size of object 3050. In one example, icon 3116 can be selected to increase a size of object 3050. For instance, increasing a size of object 3050 can include zooming in-on object 3050 and/or magnifying at least a portion of object 3050. In another example, icon 3117 can be selected to decrease a size of object 3050. For instance, decreasing a size of object 3050 can include zooming out-from object 3050.

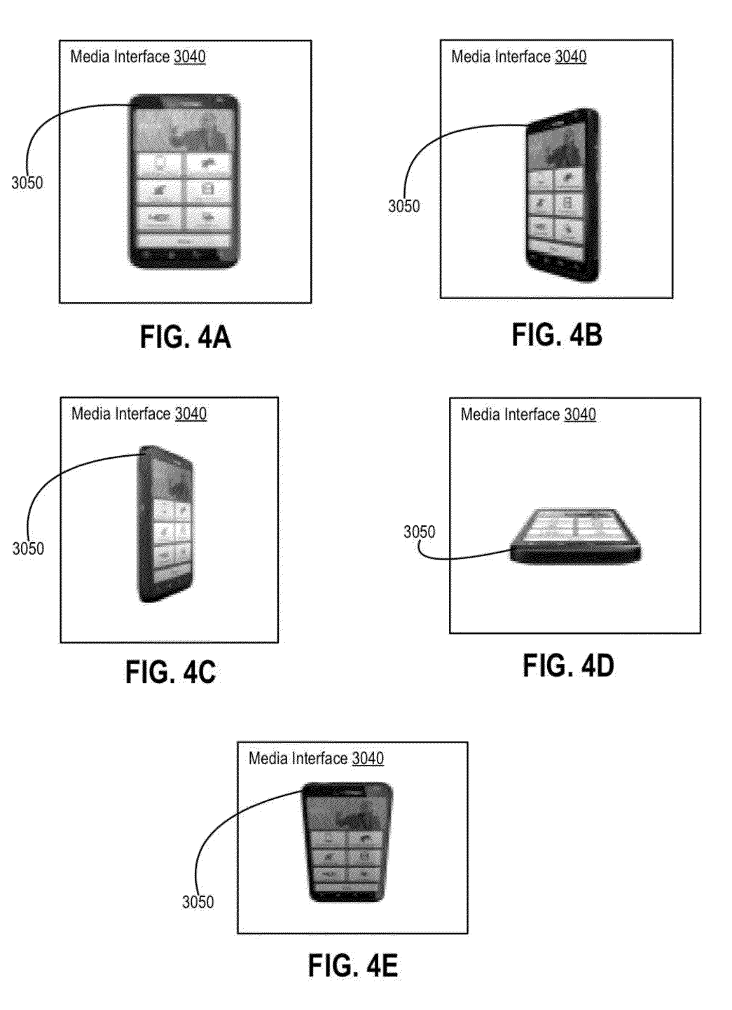

Turning now to FIGS. 4A-4E, exemplary diagrams of a media interface displaying an object are illustrated, according to one or more embodiments. As shown in FIG. 4A, media interface 3040 can display object 3050 which can be a device, such as a cellular telephone, a satellite telephone, a PDA, a digital music player, or a tablet computing device, among others. As illustrated in FIG. 4B, object 3050 can be rotated in a first direction about a vertical axis and displayed to a customer. For instance, object 3050 can be rotated “west”. As shown in FIG. 4C, object 3050 can be rotated in a second direction about a vertical axis and displayed to a customer. For instance, object 3050 can be rotated “east”. As illustrated in FIG. 4D, object 3050 can be rotated in a third direction about a horizontal axis and displayed to a customer. For instance, object 3050 can be rotated “north”. As illustrated in FIG. 4E, object 3050 can be rotated in a fourth direction about a horizontal axis and displayed to a customer. For instance, object 3050 can be rotated “south”.

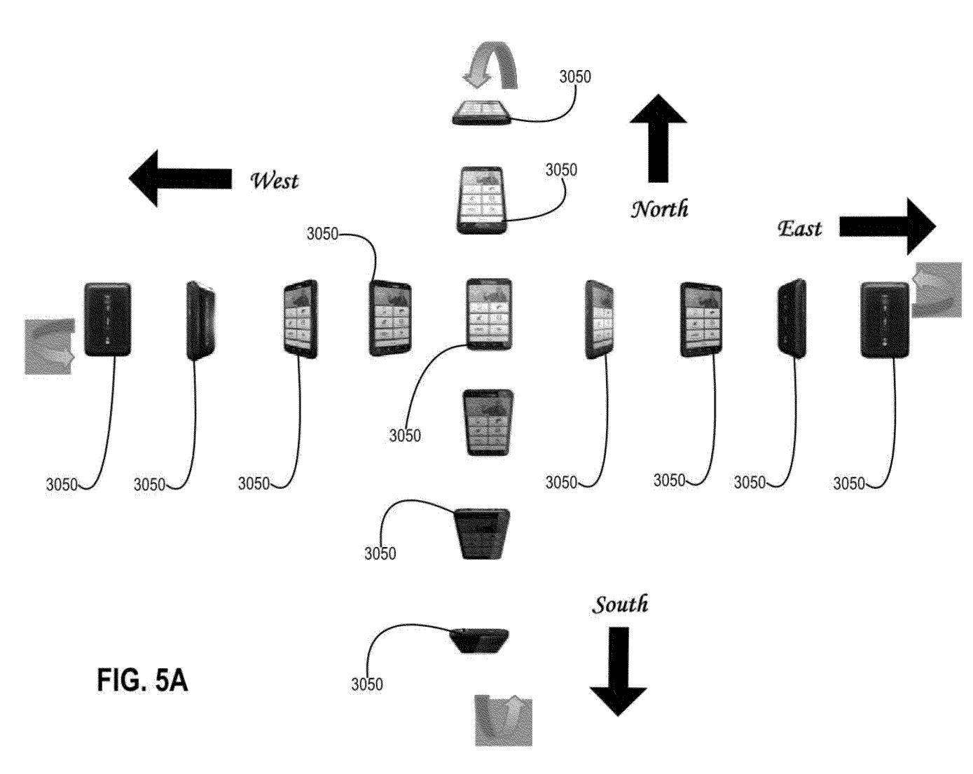

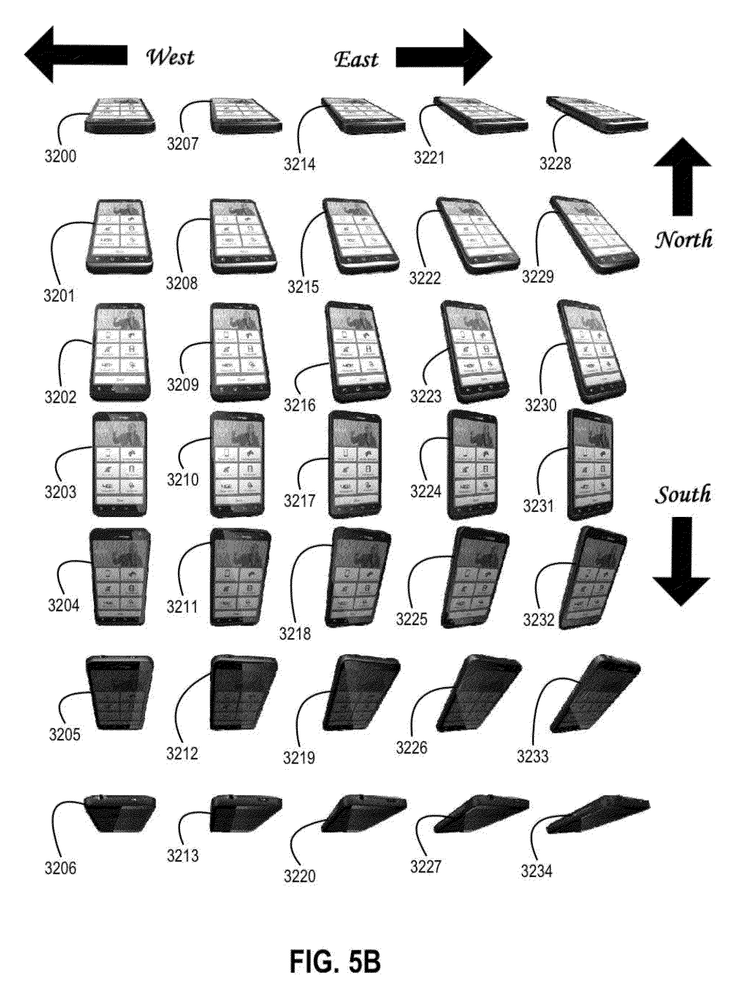

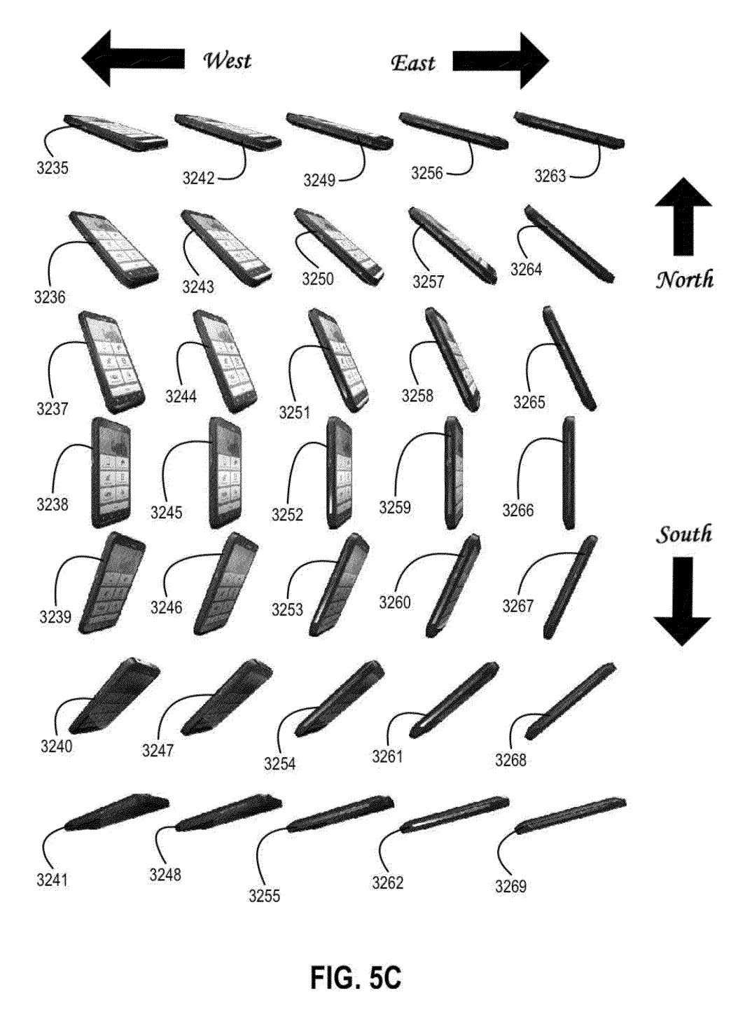

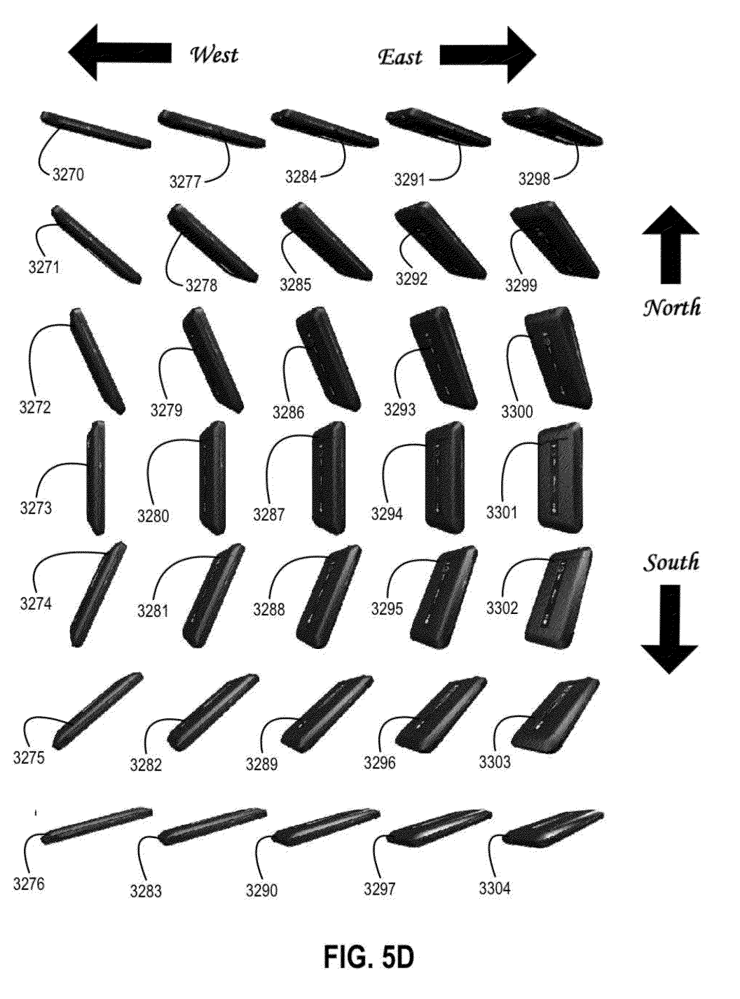

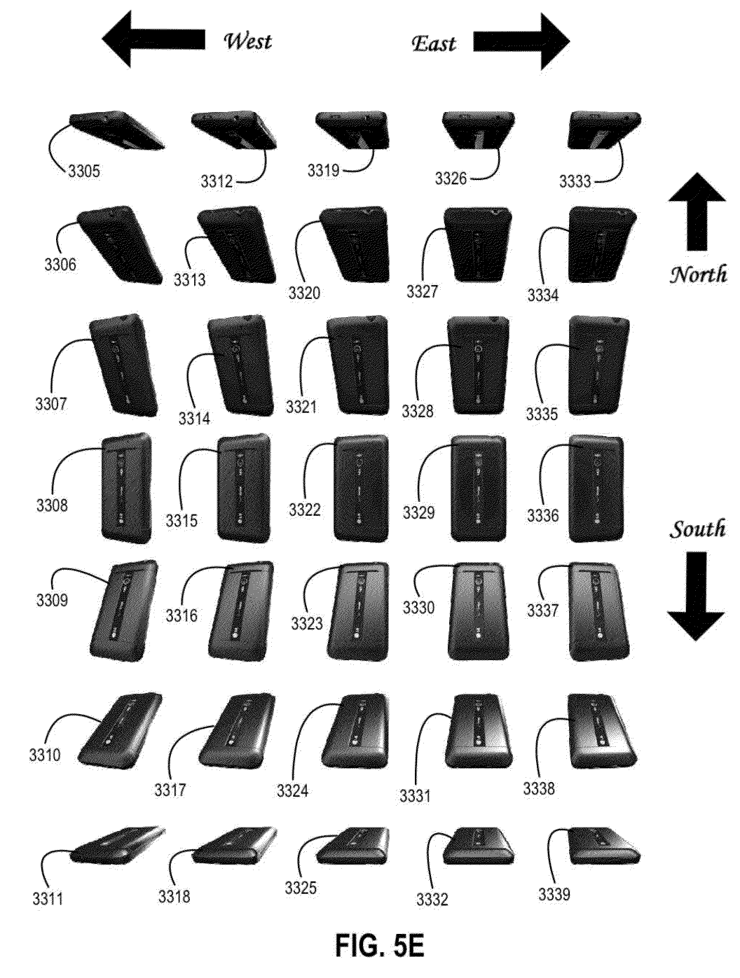

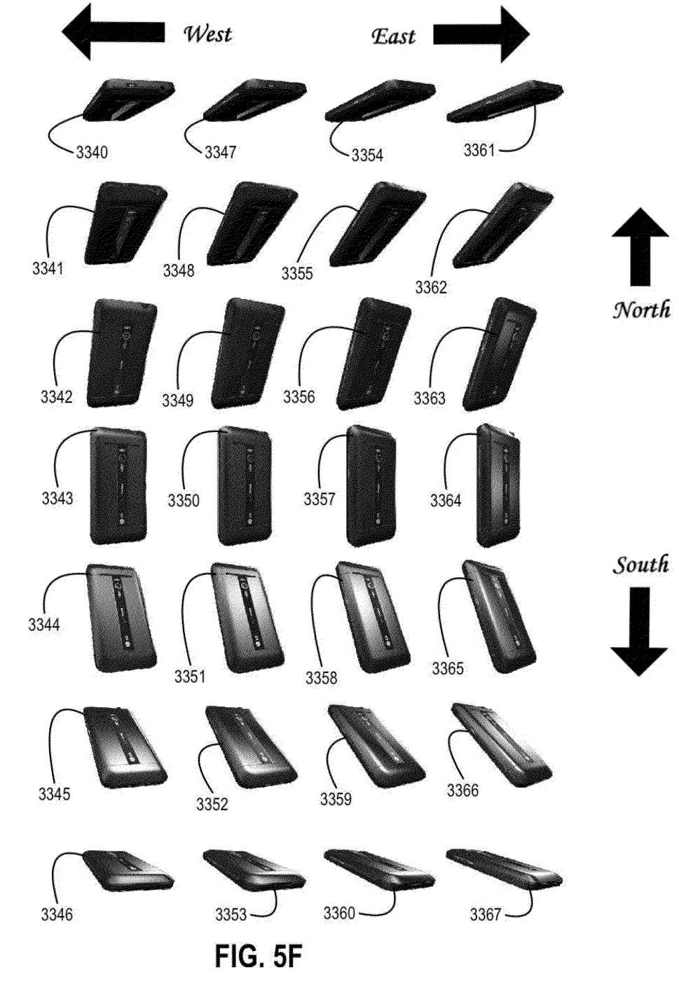

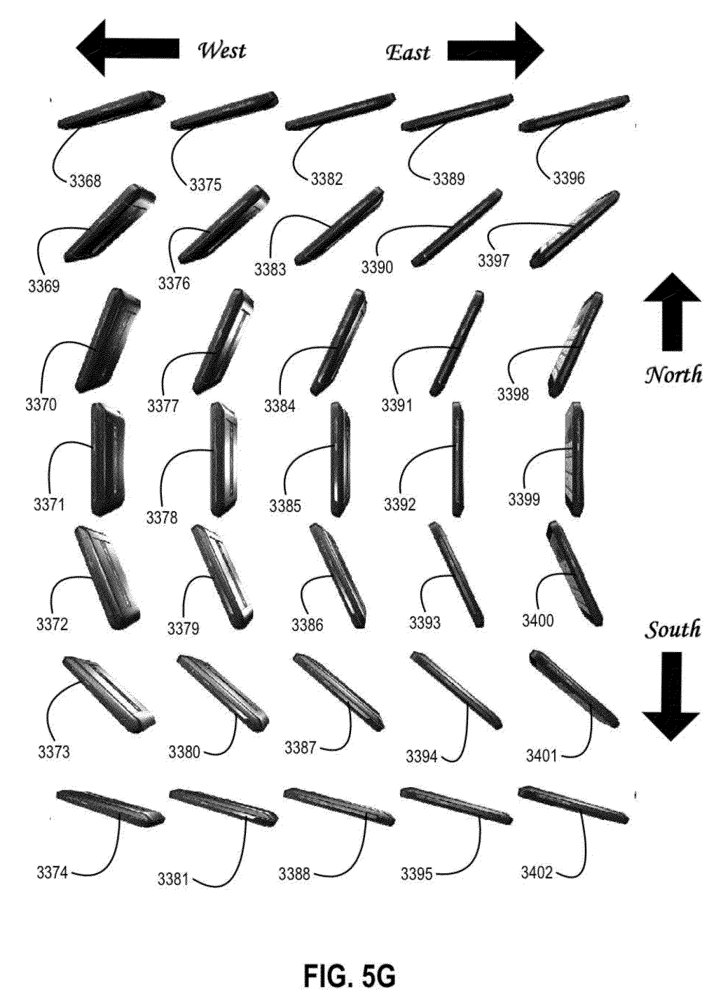

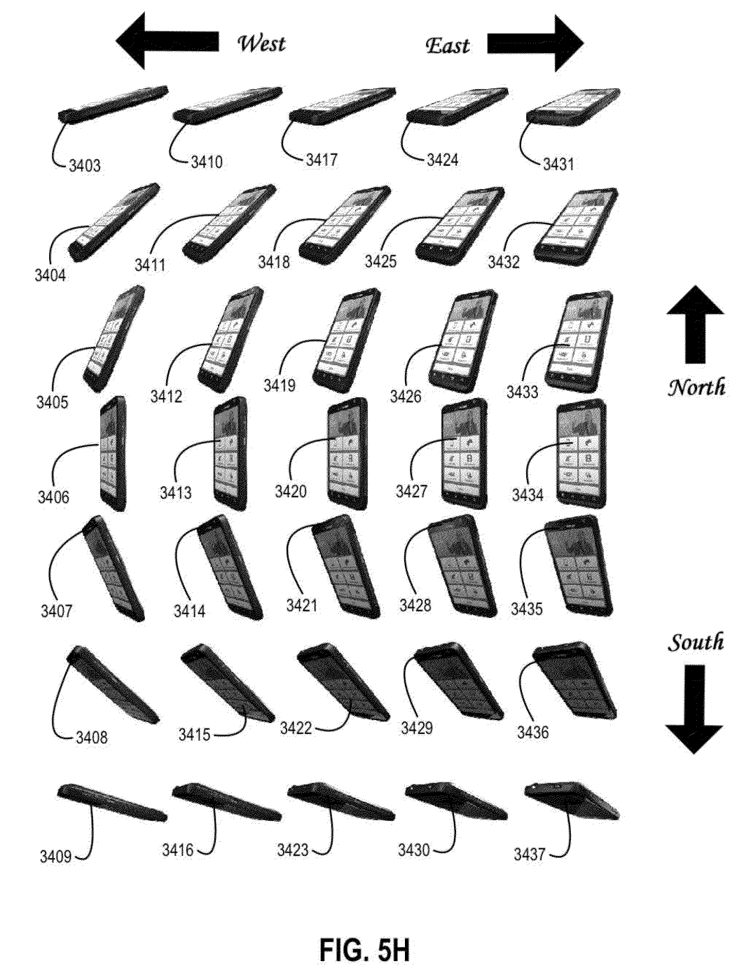

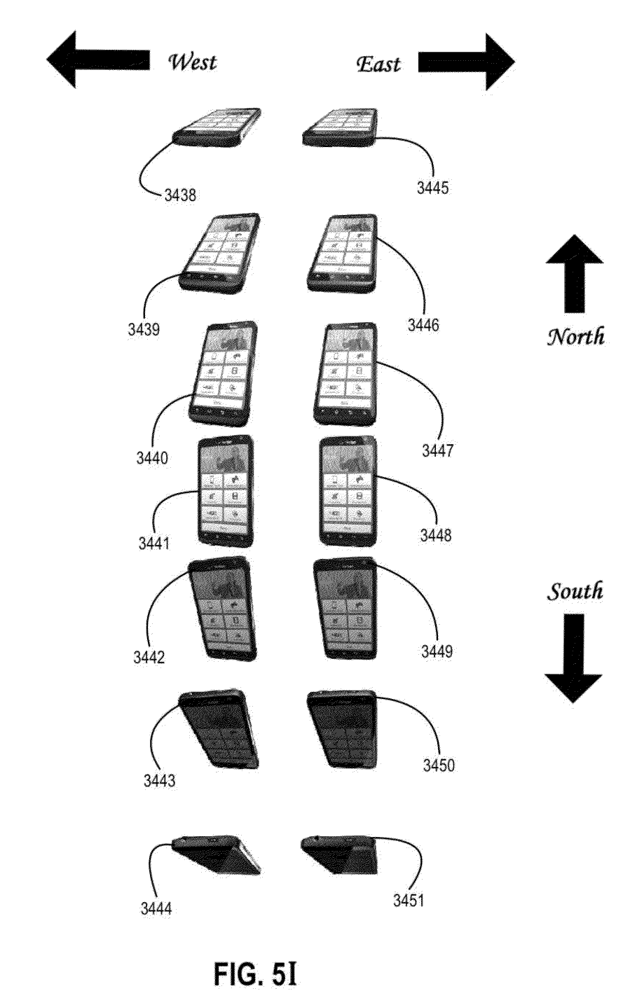

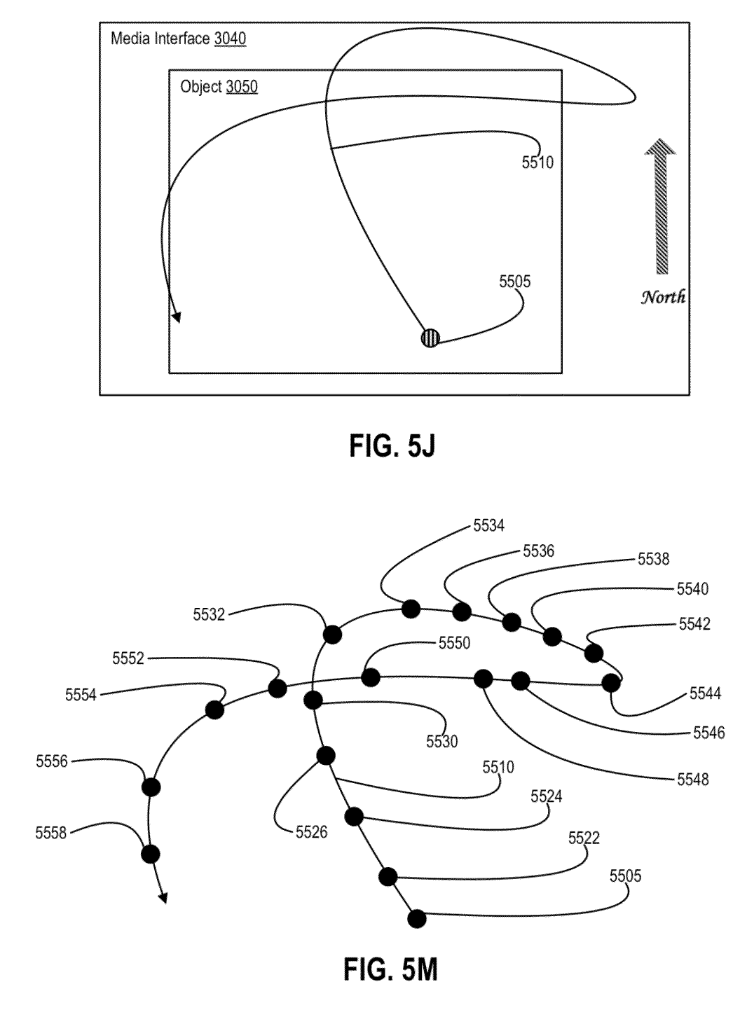

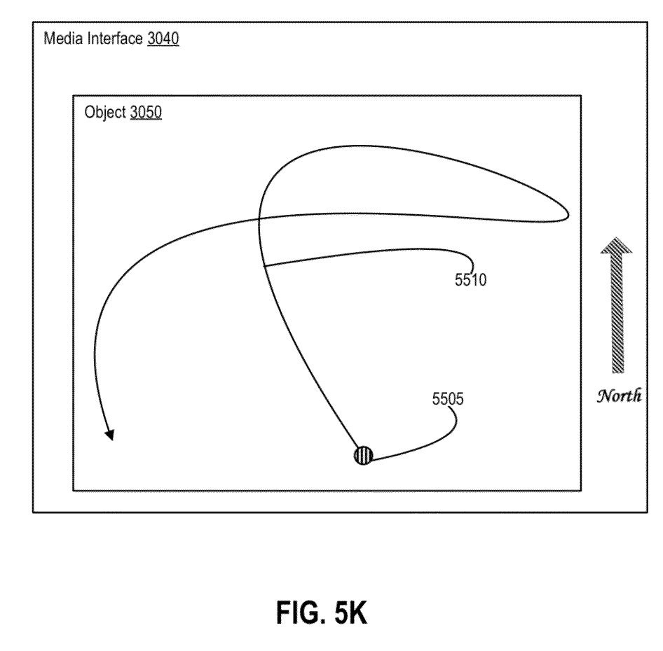

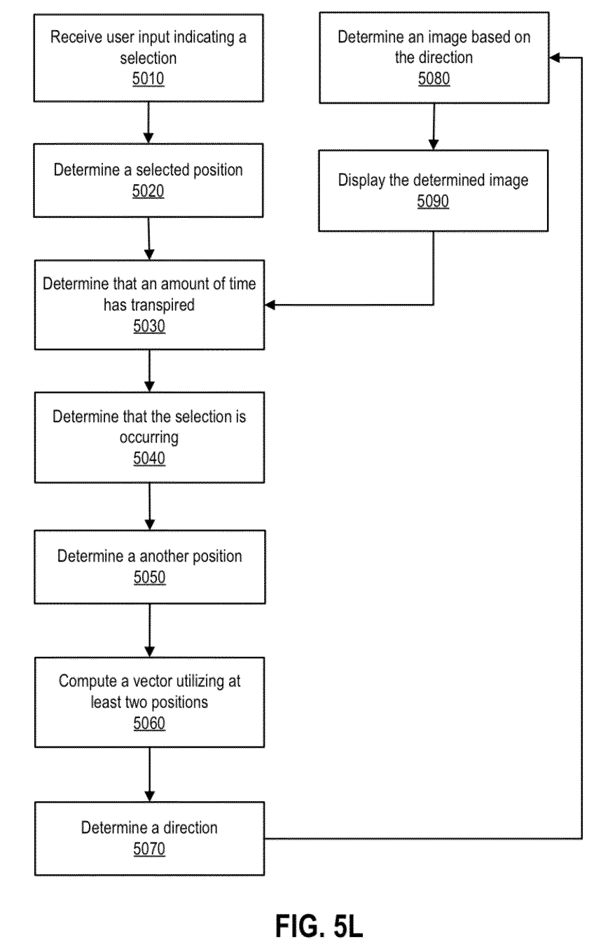

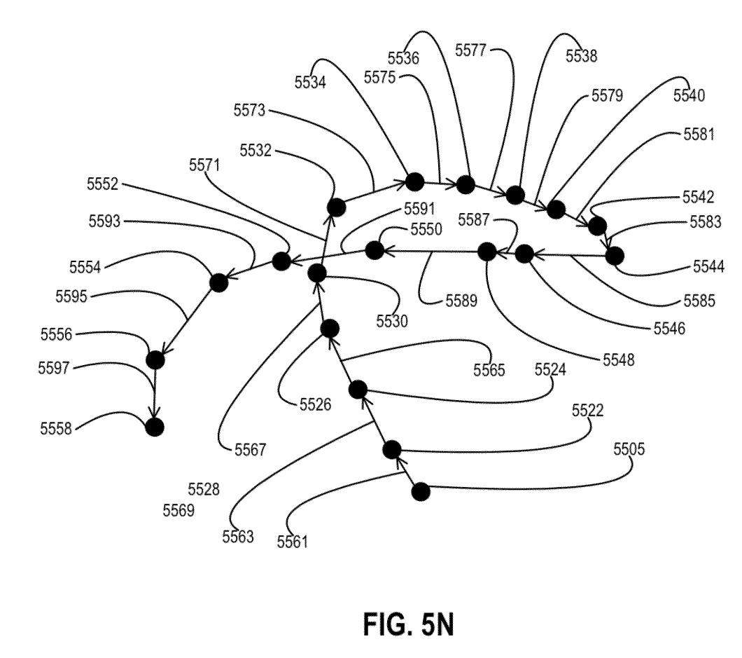

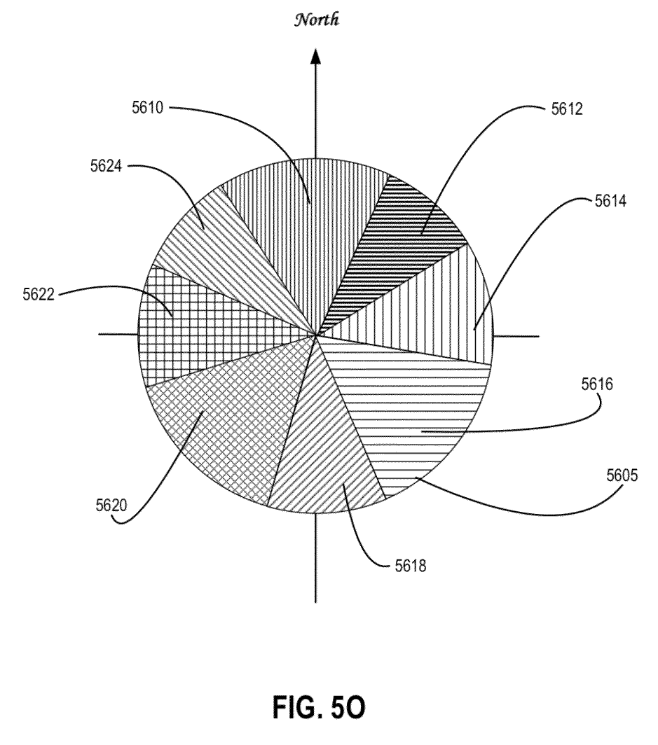

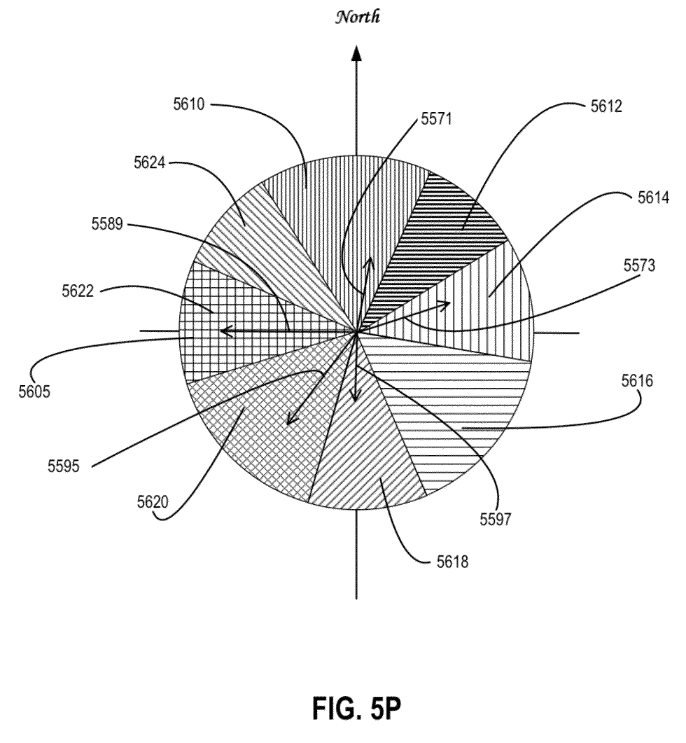

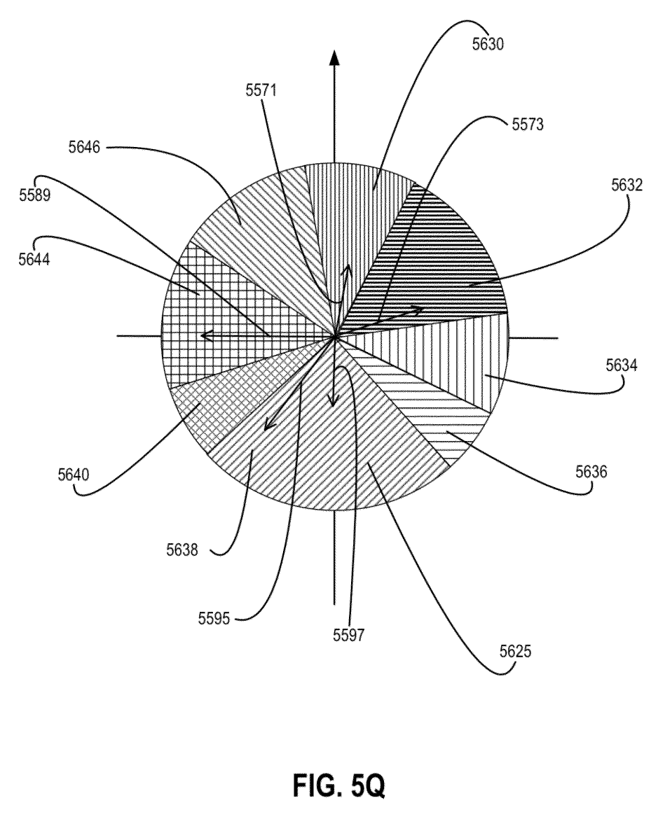

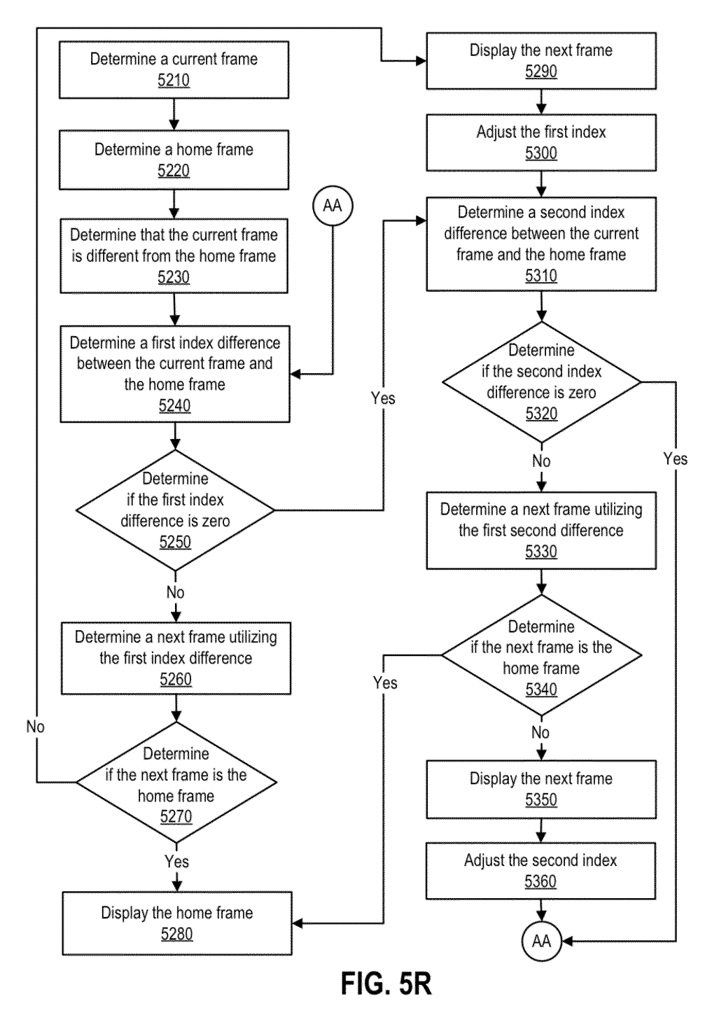

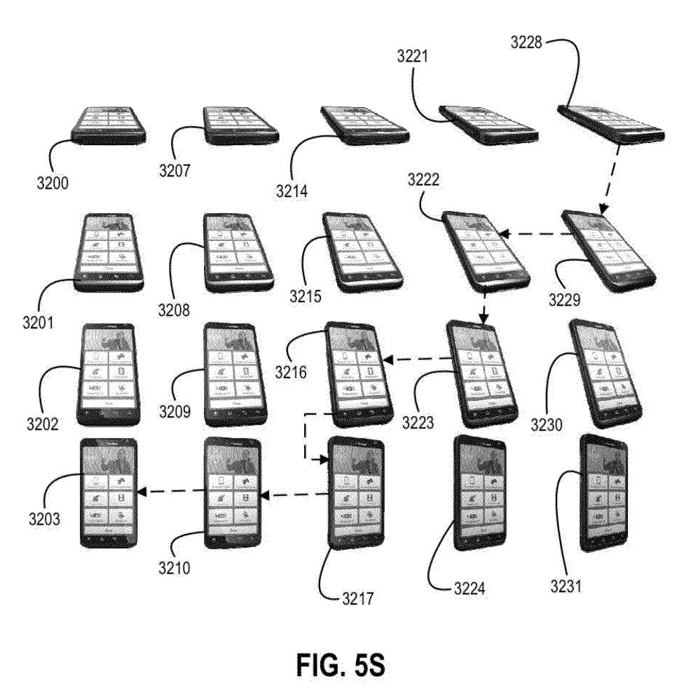

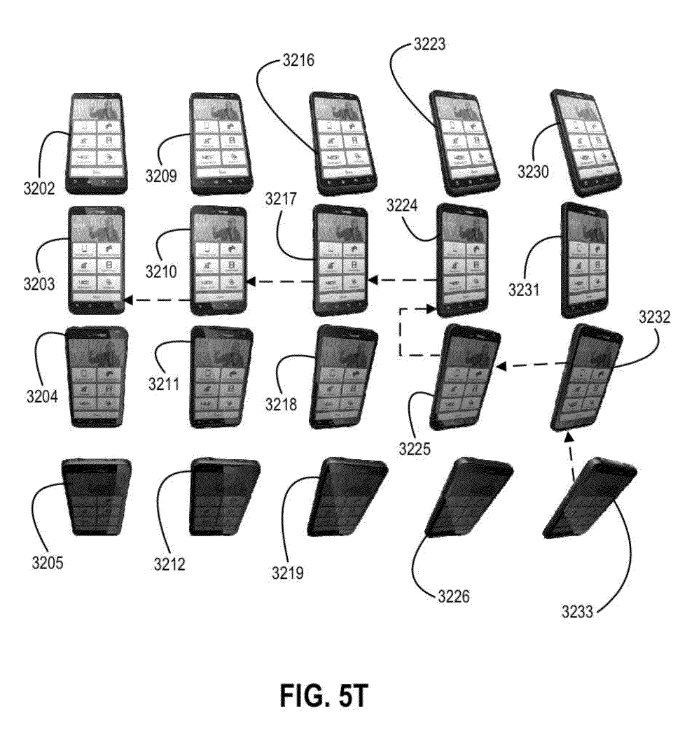

Turning now to FIG. 5A, an exemplary diagram of rotations of an object are illustrated, according to one or more embodiments. As shown, object 3050 can be rotated by a number of angles about a vertical axis. As illustrated, object 3050 can be rotated by a number of angles about a horizontal axis. In one or more embodiments, media interface 3040 can display object 3050 rotated by a first number of angles about a vertical axis and/or by a second number of angles about a horizontal axis as illustrated in FIG. 5A. In one or more embodiments, rotating object 3050 about an axis can appear continuous to a customer by “looping” the rotated images from top to bottom, from bottom to top, from left to right, and/or from right to left. In one example, a next rotation for object 3050 illustrated at the top of FIG. 5 can be object 3050 illustrated at the bottom of FIG. 5A. In a second example, a next rotation for object 3050 illustrated at the farthest left of FIG. 5A can be object 3050 illustrated at the farthest right of FIG. 5A.

In one or more embodiments, a three-dimensional representation and/or simulation of the object can include the rotations of the object. For example, a series of two-dimensional graphics can include the rotations of the object. For instance, the series of two-dimensional graphics can include two-dimensional images 3200-3451 of FIG. 5B-5I or a portion of images 3200-3451. In one or more embodiments, the series of two-dimensional graphics that include the rotations of the object can be stored in a data structure of a memory medium and/or provided to a CCD via a network.

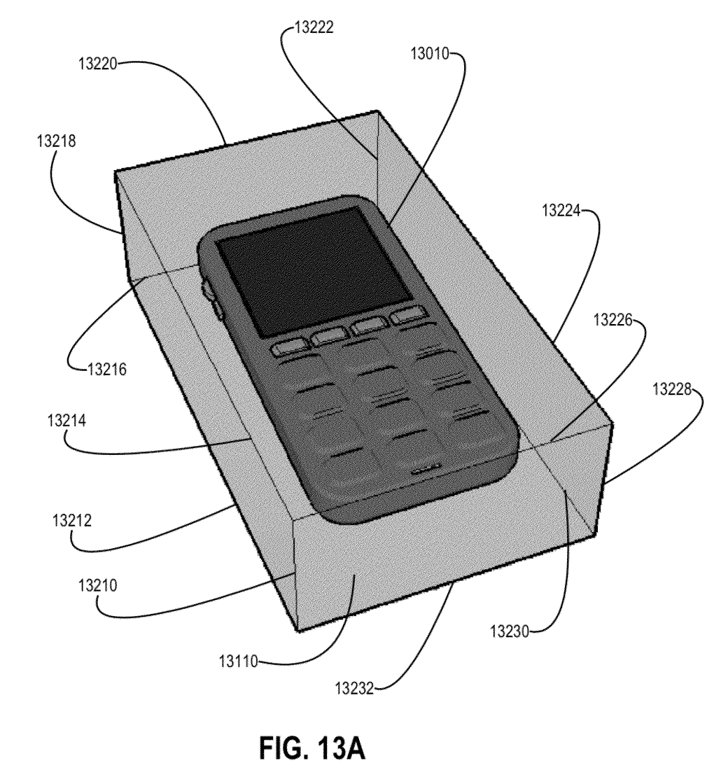

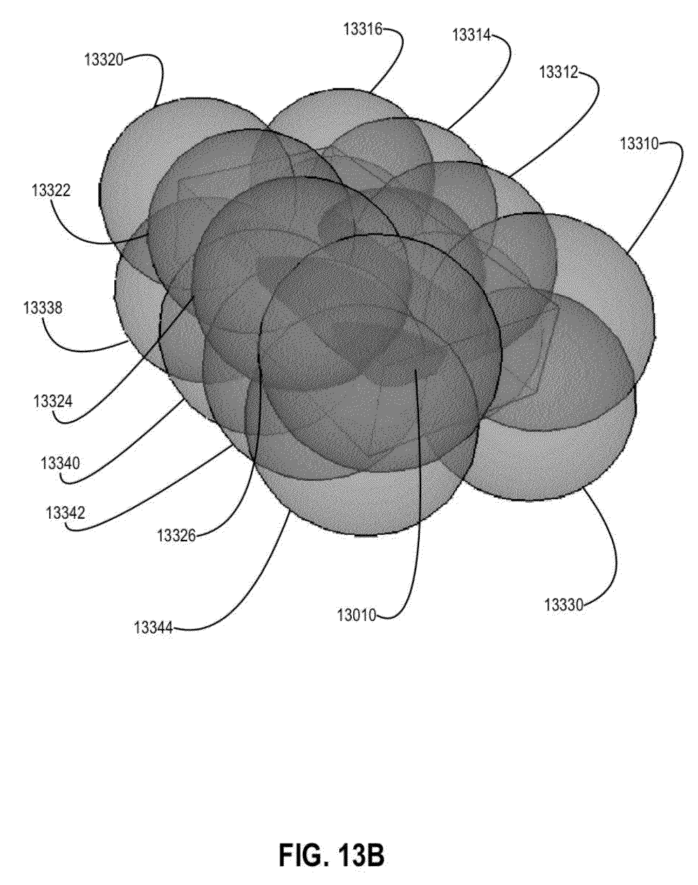

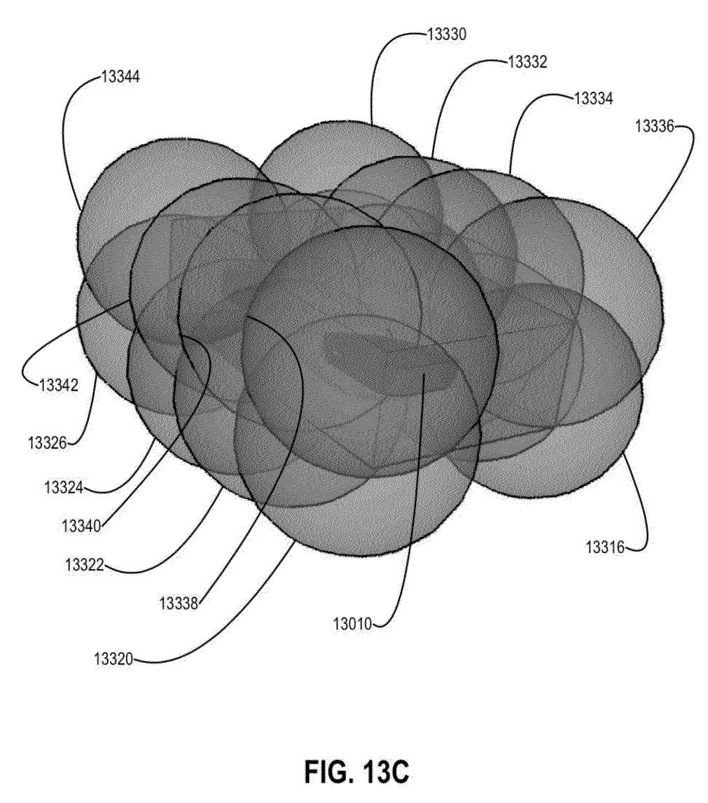

Turning now to FIGS. 5B-5I, exemplary two-dimensional images are illustrated, according to one or more embodiments. As shown, images 3200-3451 can show and/or demonstrated an object (e.g., object 3050) at multiple positions and/or multiple angles. In one or more embodiments, images 3200-3451 can be produced by computing projections of three-dimensional data of an object (e.g., object 3050) onto a plane (e.g., a two-dimensional space, a two-dimensional surface, etc.). For example, each of the images can be produced by computing a projection of three-dimensional data associated with object 13010 (FIG. 13A) onto a plane and/or two-dimensional graphical canvas. For instance, each of one or more of images 3200-3451 can be produced by computing a projection of three-dimensional data associated with object 13010 onto a plane and/or two-dimensional graphical canvas.

In one or more embodiments, media interface 3040 can display two or more of images 3200-3451. For example, simulating and/or emulating an object (e.g., object 3050) can include displaying two or more of images 3200-3451 via one or more of display 3000, client interface 3020, interactive media interface 3030, and media interface 3040. In one instance, user input can be received via one or more of buttons and/or icons 3110-3113, and a first image of the two or more of images 3200-3451 can be changed to a second, different, image of the two or more of images 3200-3451. In a second instance, user input can be received via button and/or icon 3114, and a series of images 3200-3451 can be displayed. In another instance, user input can be received via touch screen and/or a pointing device, and a first image of the two or more of images 3200-3451 can be changed to a second, different, image of the two or more of images 3200-3451.

In one or more embodiments, receiving user input via a touch screen and/or pointing device can include determining that a portion of a user interface is selected and determining at least one movement away from the selected portion of the user interface. For example, a portion of a user interface 5505, as shown in FIG. 5J, can be selected, and at least one movement away from portion of the user interface 5505 can be determined. In one instance, the user input can include a path, such as a path 5510, that indicates one or more movements with respect to portion of the user interface 5505. In another instance, the user input can include a path, such as path 5510, that indicates one or more movements with respect to a coordinate (e.g., an origin coordinate) of the user interface. As illustrated in FIGS. 5J and 5K, path 5510 can include one or more areas and/or coordinates associated with object 3050.

Turning now to FIG. 5L, a method of displaying multiple images is illustrated, according to one or more embodiments. At 5010, user input indicating a selection can be received. For example, user input indicating portion of the user interface 5505 can be received. In one instance, the user input indicating the selection can be received via a mouse or other pointing device (e.g., a stylus, a finger, etc.). In another instance, the user input indicating the selection can be received via a touch screen.

At 5020, a selected position can be determined. For example, portion of the user interface 5505 can be associated a coordinate. In one or more embodiments, the coordinate can be relative to an origin coordinate. For example, the origin coordinate can be in a lower left corner, an upper left corner, a lower right corner, an upper right corner, or a center of an interface (e.g., a display 3000, client interface 3020, interactive media interface, 3030, media interface 3040, etc.).

At 5030, it can be determined that an amount of time has transpired. In one example, a timer can be set, and when the timer reaches a predetermined amount of time transpiring, a signal can be emitted that indicates that the amount of time has transpired. In another example, a timer can be set, and when the timer reaches a predetermined amount of time transpiring, a method and/or process can be executed. In one or more embodiments, the amount of time that transpires can be utilized for multiple iterations (e.g., method elements 5030-5090). For example, the amount of time that transpires can include an interval. In one instance, a signal can be emitted that indicates that the time interval has transpired, and multiple signals can be emitted to indicates that corresponding multiple time intervals have transpired and/or multiple amounts of time have transpired. In another instance, a method and/or process can be executed, and the method and/or process can be executed multiple times corresponding to multiple time intervals transpiring and/or multiple amounts of time transpiring.

In one or more embodiments, an emitted signal can trigger an event in an event-driven process and/or method. For example, one or more portions of the method illustrated in FIG. 5L can be event-driven. For instance, an event consumer can receive the signal emitted that indicates that the amount of time has transpired and perform one or more instructions, in response to the signal that indicates that the amount of time has transpired. In one or more embodiments, an emitted signal can include information. In one example, the emitted signal can include a message. In another example, the emitted signal can include information associated with the emitted signal.

At 5040, it can be determined that the selection is occurring. In one example, determining that the selection is occurring can include determining that a mouse button is (still) down. In a second example, determining that the selection is occurring can include determining that a finger or stylus is (still) in contact with a touch screen. In one or more embodiments, determining that the selection is occurring can include determining that no state change has occurred and/or not having received a signal indicating that the selection has ceased. For example, determining that the selection is occurring can include not having received a signal indicating a mouse up event.

At 5050, another position can be determined. In one example, a coordinate associated with a mouse position can be determined. In another example, a coordinate associated with a finger or stylus can be determined. In one or more embodiments, multiple positions can be determined via multiple iterations of method elements 5030-5090. For example, positions 5524-5558, as shown in FIG. 5M, can be determined via multiple iterations of method elements 5030-5090.

At 5060, a vector can be computed, utilizing at least two positions. In one example, a vector 5561, as shown in FIG. 5N, can be determined utilizing positions 5505 and 5522. In another example, a vector such as one of vectors 5563-5597, as shown in FIG. 5N, can be computed, utilizing at least two positions, via a subsequent iteration.

In one or more embodiments, vectors 5563-5597 can be determined utilizing a current position at an end of a time interval and a previous position at a beginning of the time interval. In this fashion, path 5510 can be segmented and/or segmented into vectors 5561-5597. For example, vectors 5561-5597 can be utilized in determining a next two-dimensional image, of a three-dimensional object, to display to a user.

At 5070, a direction of a computed vector can be determined. In one or more embodiments, determining the direction of the computed vector can be utilized in determining a direction that a user is dragging a mouse, finger, stylus, etc. For example, determining the direction that the user is dragging, or has dragged, the mouse, finger, stylus, etc. can include determining multiple positions along a path (e.g., path 5510).

In one or more embodiments, one or more computed directions of corresponding computed vectors can be grouped. For example, a circle and/or disk can include a range of angles, such as 0 to 2π radians or 0 to 360 degrees, and the range of angles can be partitioned into sectors. In one instance, a first sector can include 330 to 359 degrees and 0 degrees to 29 degrees that can correspond to a north direction. In a second instance, a second sector can include 30 to 59 degrees that can correspond to a northeast direction. In a third instance, a third sector can include 60 to 120 degrees that can correspond to an east direction. Another example of sectors is shown in FIG. 5O, which illustrates exemplary sectors 5610-5624 of an exemplary circle or disk 5605.

In one or more embodiments, determining a direction of a computed vector can include determining a sector that a computed vector would or does intersect. In one example, vector 5571 can intersect sector 5610, as illustrated in FIG. 5P. For instance, sector 5610 can correspond to a north direction. In a second example, vector 5573 can intersect sector 5614, as illustrated in FIG. 5P. For instance, sector 5614 can correspond to an east direction. In a third example, vector 5589 can intersect sector 5622, as illustrated in FIG. 5P. For instance, sector 5622 can correspond to a west direction. In a fourth example, vector 5595 can intersect sector 5620, as illustrated in FIG. 5P. For instance, sector 5620 can correspond to a southwest direction. In another example, vector 5597 can intersect sector 5618, as illustrated in FIG. 5P. For instance, sector 5618 can correspond to a south direction.

In one or more embodiments, different sectors of a circle or disk can be utilized based on a type of application and/or computing device utilized by a user. For example, FIG. 5Q illustrates exemplary sectors 5630-5644 of an exemplary circle or disk 5625, according to one or more embodiments. In one instance, sectors 5610-5624 of circle or disk 5605 can be utilized with CCD 1110 in determining a direction of a computed vector, and sectors 5630-5644 of circle or disk 5625 can be utilized with CCD 1111 in determining a direction of a computed vector. For example, CCD 1110 can be a laptop computing device, and CCD 1111 can be a tablet computing device. In another instance, sectors 5610-5624 of circle or disk 5605 can be utilized with a first application in determining a direction of a computed vector, and sectors 5630-5644 of circle or disk 5625 can be utilized with a second application in determining a direction of a computed vector. For example, the first application can be or include a Firefox web browser, and the second application can be or include a Chrome web browser.

As illustrated in FIG. 5Q, vector 5571 can intersect sector 5630, in one example. For instance, sector 5630 can correspond to a north direction. In a second example, vector 5573 can intersect sector 5632, as illustrated in FIG. 5Q. For instance, sector 5632 can correspond to a northeast direction. In a third example, vector 5589 can intersect sector 5644, as illustrated in FIG. 5Q. For instance, sector 5644 can correspond to a west direction. In a fourth example, vector 5595 can intersect sector 5638, as illustrated in FIG. 5Q. For instance, sector 5638 can correspond to a south direction. In another example, vector 5597 can intersect sector 5638, as illustrated in FIG. 5Q.

Based on the determined direction, an image can be determined at 5080. For example, a first image can be displayed, and a second image (e.g., a next image) can be determined based on the determined direction. In one or more embodiments, determining a next image to be displayed can be independent of a magnitude of a vector computed during an amount of time transpiring. For example, the direction of the vector computed during the amount of time transpiring can be utilized in determining the next image to be displayed while disregarding the magnitude of the vector computed during the amount of time transpiring. For instance, the magnitude of the vector computed during the amount of time transpiring can be associated with and/or correspond to a speed of and/or a drag of a mouse movement, a stylus movement, or a finger movement, and determining the next image to be displayed can be independent of the speed of and/or the drag of the mouse movement, the stylus movement, or the finger movement.

In one or more embodiments, the images and/or an index of the images (e.g., data that can be utilized to access the images) can be stored in a data structure. For example, the data structure can be or include a matrix. For instance, the matrix can be a M×N matrix. In one or more embodiments, a current image can be based on a matrix element Eᵢⱼ, and a next image or next matrix element can be based on the determined direction and the matrix element Eᵢⱼ. In one example, the direction can be north, and the next image can be based on a next matrix element such as Eᵢ₍ⱼ₋₁₎. In a second example, the direction can be northeast, and the next image can be based on a next matrix element such as E₍ᵢ₊₁₎₍ⱼ₋₁₎. In a third example, the direction can be east, and the next image can be based on a next matrix element such as E₍ᵢ₊₁₎ⱼ. In a fourth example, the direction can be southeast, and the next image can be based on a next matrix element such as E₍ᵢ₊₁₎₍ⱼ₊₁₎. In a fifth example, the direction can be south, and the next image can be based on a next matrix element such as Eᵢ₍ⱼ₊₁₎. In a sixth example, the direction can be southwest, and the next image can be based on a next matrix element such as E₍ᵢ₋₁₎₍ⱼ₊₁₎. In a seventh example, the direction can be west, and the next image can be based on a next matrix element such as E₍ᵢ₋₁₎ⱼ. In an eighth example, the direction can be northwest, and the next image can be based on a next matrix element such as E₍ᵢ₋₁₎ⱼ.

In one or more embodiments, a mapping can be utilized to provide one more next matrix indices. In one example, a next matrix element can be determined to be Eᵢ₍ⱼ₊₁₎, where j=N, and the mapping can be utilized to determine the next matrix element to be Eᵢ₁. In a second example, a next matrix element can be determined to be E₍ᵢ₊₁₎ⱼ, where i=M, and the mapping can be utilized to determine the next matrix element to be E₁ⱼ. In a third example, a next matrix element can be determined to be E₍ᵢ₋₁₎₍ⱼ₊₁₎, where i=1 and j=N, and the mapping can be utilized to determine the next matrix element to be E_{M1}. In a fourth example, a next matrix element can be determined to be E₍ᵢ₊₁₎₍ⱼ₊₁₎, where i=M and j=N, and the mapping can be utilized to determine the next matrix element to be E₁₁. For instance, the mapping can be utilized to produce an existing matrix element when a next matrix element does not exist.

In one or more embodiments, the matrix elements can be associated with images 3200-3451 or a portion of images 3200-3451. In one example, the matrix can store indexes to images 3200-3451 or to a portion of images 3200-3451. In another example, the matrix can store images 3200-3451 or a portion of images 3200-3451.

At 5090, the determined image can be displayed. In one or more embodiments, possible images (e.g., images 3200-3451, a portion of images 3200-3451, etc.) can be stored via an application. For example, the application can store the possible images in a data structure that includes a z-index, and the application can change the z-index of the determined image to display the determined image or to permit displaying the determined image. In one or more embodiments, the method can proceed to 5030. For example, the method can proceed to 5030 for a next iteration of method elements 5030-5090.

Turning now to FIG. 5R, a method of returning to a home frame is illustrated, according to one or more embodiments. At 5210, a current frame can be determined. For example, the current frame can display image 3228, and a corresponding first index and a corresponding second index can be associated with image 3228 and can be determined. In one or more embodiments, a first index can correspond to and/or be associated with a row index of a matrix, and a second index can correspond to and/or be associated with a column index of the matrix. At 5220, a home frame can be determined. For example, the home frame can display image 3203, and corresponding first home index and a corresponding second home index can be associated with image 3228 and can be determined.

At 5230, it can be determined that the current frame is different from the home frame. In one example, it can be determined that the first index is different from the first home index. In another example, it can be determined that the second index is different from the second home index. At 5240, a first index difference between the first index and the first home index can be determined. For example, a row index difference can be determined. For instance, iₕₒₘₑ−i_{current} can be determined.

At 5250, it can be determined if the first index difference is zero. If the first index difference is zero, the method can proceed to 5310. If the first index difference is not zero, a next frame can be determined, utilizing the first index difference, at 5260. In one or more embodiments, determining the next frame can include adding or subtracting a number from the first frame index. In one example, the first index difference can be a positive number, and determining the next frame can include adding a number to the first index. For instance, adding a number to the first index can include iₙₑₓₜ=i_{current}+1. In another example, the first index difference can be a negative number, and determining the next frame can include subtracting a number from the first index. For instance, subtracting a number from the first index can include iₙₑₓₜ=i_{current}−1.

At 5270, it can be determined if the next frame is the home frame. In one example, it can be determined if a first index of the next frame is equal to the first home frame index. For instance, it can be determined if iₙₑₓₜ equal to iₕₒₘₑ. In another example, it can be determined if a second index of the next frame is equal to the second home frame index. For instance, it can be determined if jₙₑₓₜ is equal to jₕₒₘₑ. If the next frame is the home frame, the home frame can be displayed at 5280. If the next frame is not the home frame, the next frame can be displayed at 5290.

At 5300, the first index can be adjusted. For example, i_{current} can be adjusted and/or set to iₙₑₓₜ. At 5310, a second index difference between the second index and the second home index can be determined. For example, a column index difference can be determined. For instance, jₕₒₘₑ−i_{current} can be determined. At 5320, it can be determined if the second index difference is zero. If the second index difference is zero, the method can proceed to 5240. If the second index difference is not zero, a next frame can be determined, utilizing the second index difference, at 5330. In one or more embodiments, determining the next frame can include adding or subtracting a number from the second frame index. In one example, the second index difference can be a positive number, and determining the next frame can include adding a number to the second index. For instance, adding a number to the second index can include jₙₑₓₜ=i_{current}+1. In another example, the second index difference can be a negative number, and determining the next frame can include subtracting a number from the second index. For instance, subtracting a number from the second index can include jₙₑₓₜ=i_{current}−1.

At 5340, it can be determined if the next frame is the home frame. In one example, it can be determined if a second index of the next frame is equal to the second home frame index. For instance, it can be determined if jₙₑₓₜ is equal to jₕₒₘₑ. In another example, it can be determined if a first index of the next frame is equal to the second home frame index. For instance, it can be determined if iₙₑₓₜ is equal to iₕₒₘₑ. If the next frame is the home frame, the home frame can be displayed at 5280. If the next frame is not the home frame, the next frame can be displayed at 5350. At 5300, the second index can be adjusted. For example, j_{current} can be adjusted and/or set to jₙₑₓₜ. In one or more embodiments, the method can proceed to 5240.

In one or more embodiments, the method illustrated in FIG. 5R can be performed in response to user input indicating that a return to a base and/or home state is desired. For example, one or more methods, processes, and/or systems described herein can receive the user input indicating the return to the base and/or home state.

Turning now to FIGS. 5S and 5T, exemplary images associated with and/or corresponding to frames are illustrated, according to one or more embodiments. In one or more embodiments, the method illustrated in FIG. 5R can be performed with a current frame that displays image 3228. For example, the method illustrated in FIG. 5R can display images 3229, 3223, 3216, 3217, 3210, and 3203, as shown in FIG. 5S. In one or more embodiments, the method illustrated in FIG. 5R can be performed with a current frame that displays image 3233. For example, the method illustrated in FIG. 5R can display images 3232, 3225, 3224, 3217, 3210, and 3203, as shown in FIG. 5T.

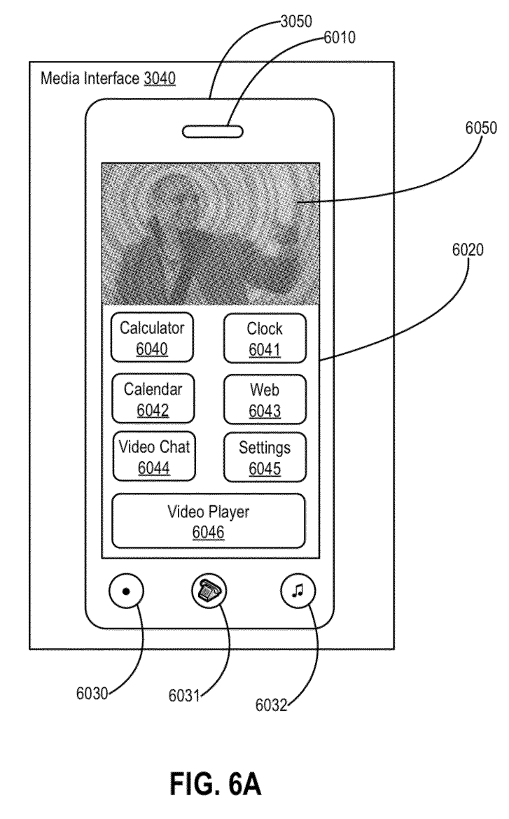

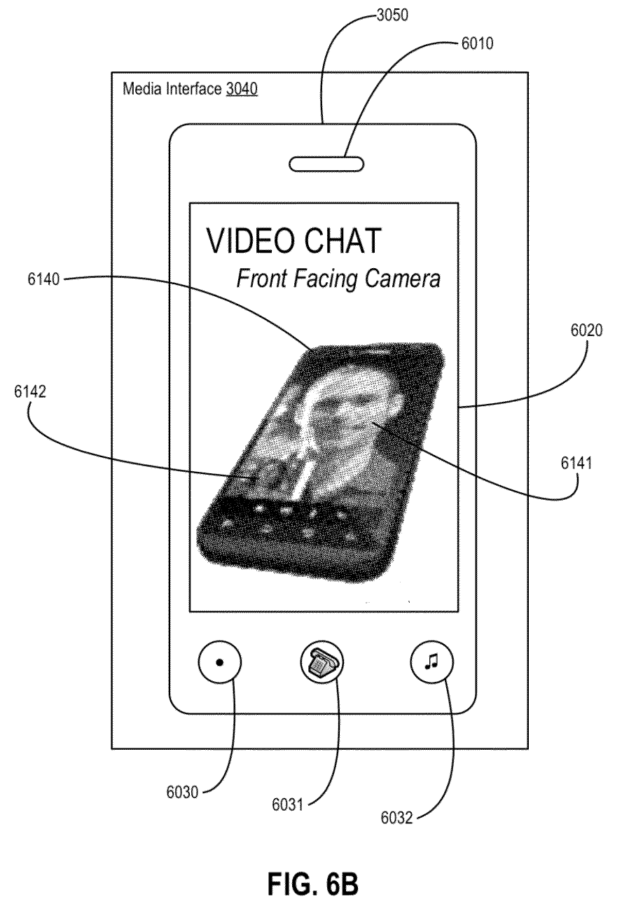

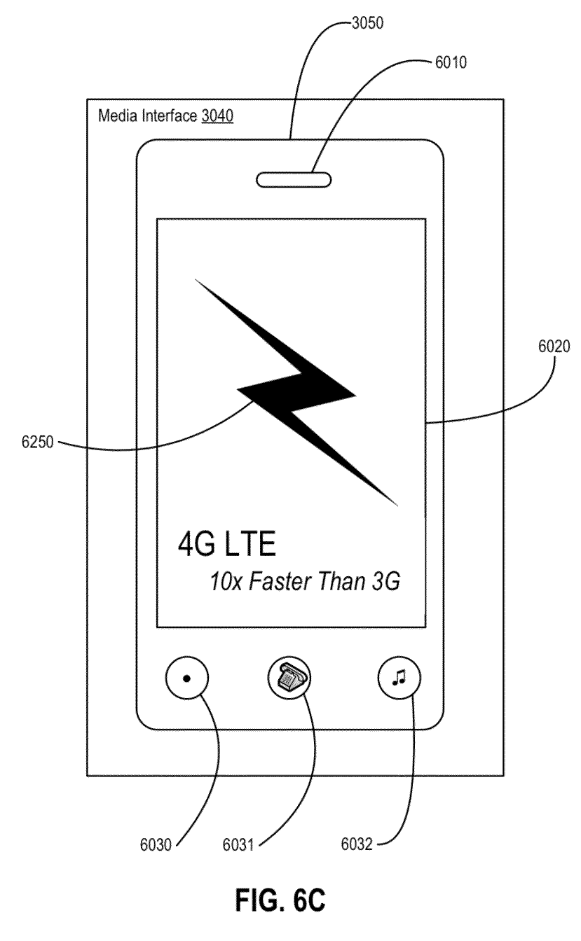

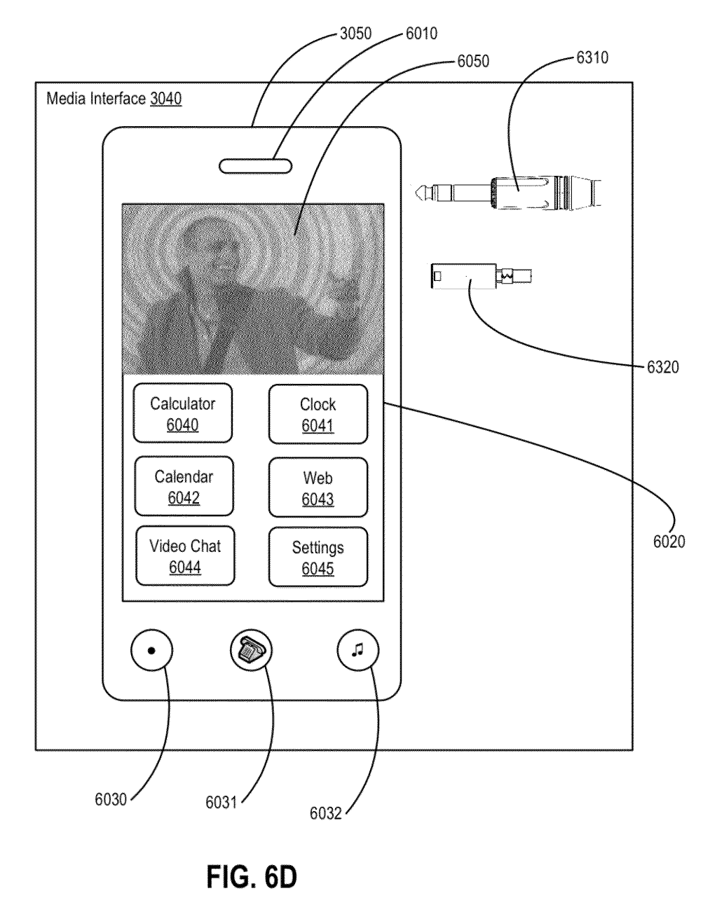

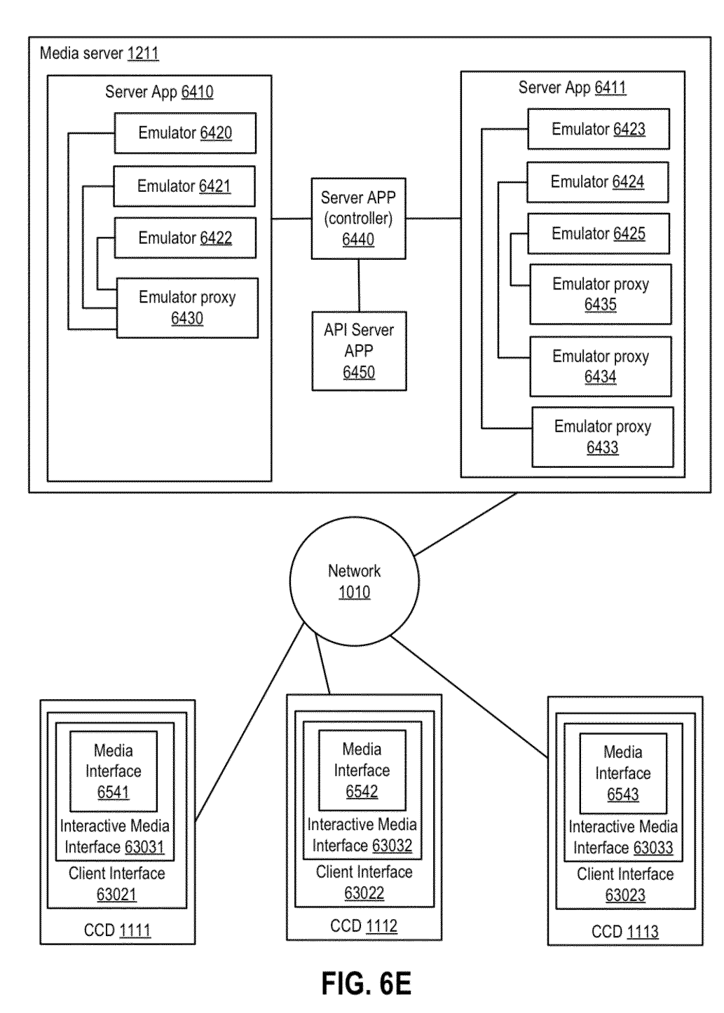

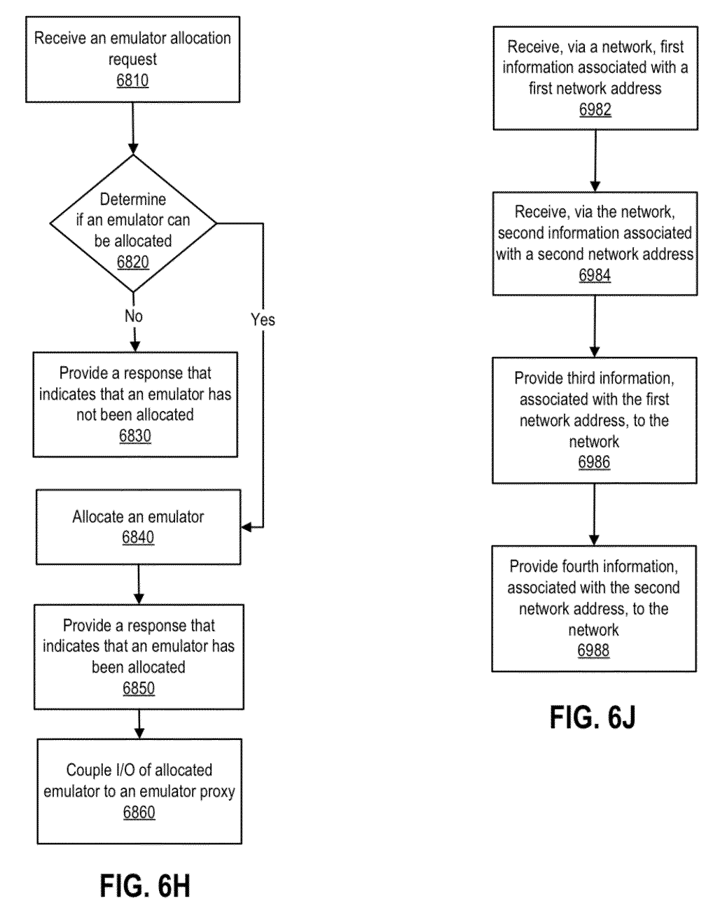

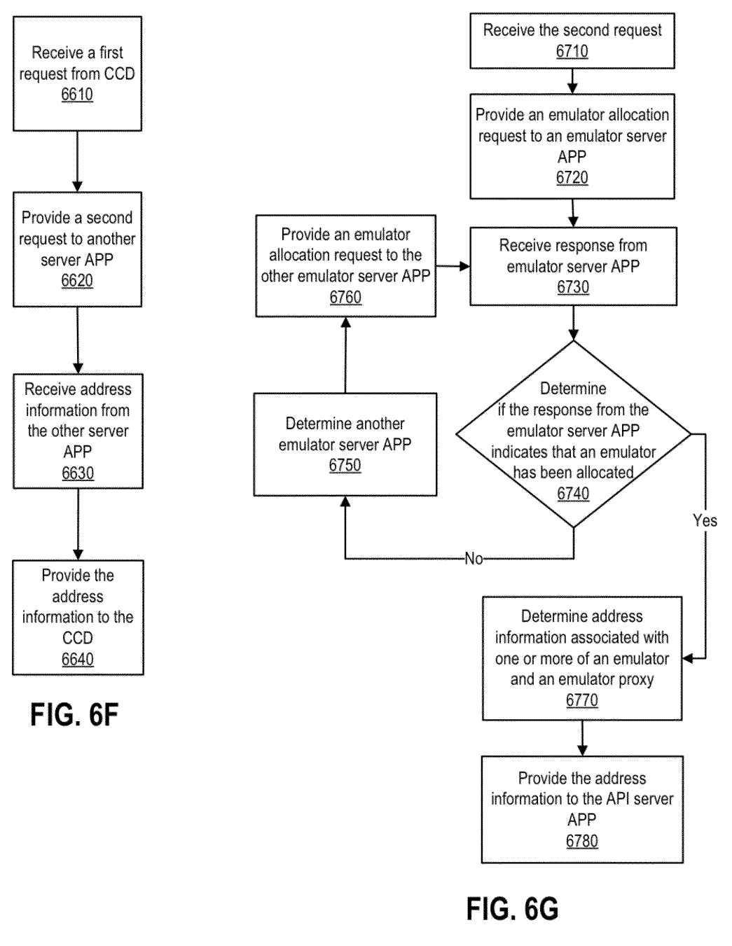

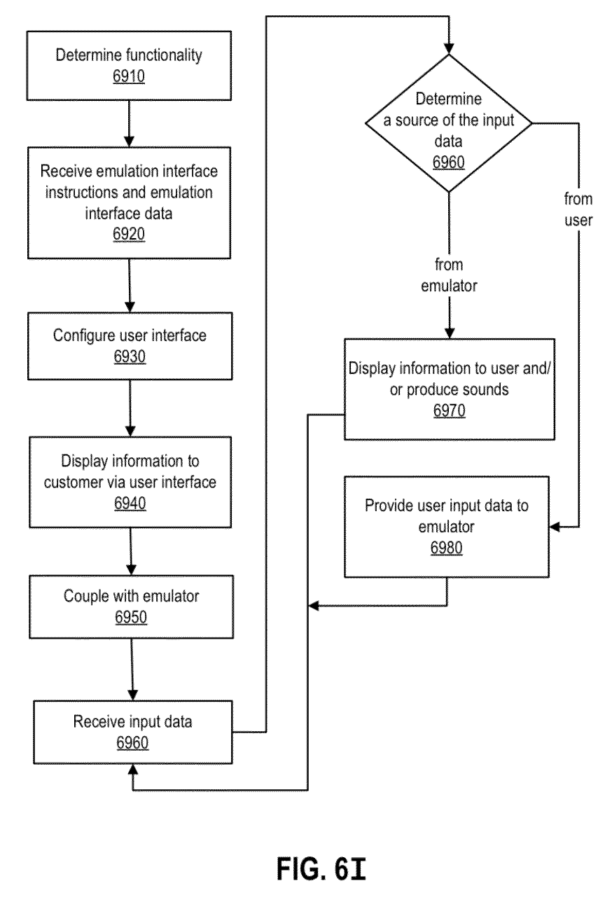

Turning now to FIGS. 6A-6C, exemplary diagrams of a simulated object are illustrated, according to one or more embodiments. As shown in FIG. 6A, simulated object 3050 can include one or more of a wireless telephone (e.g., a cellular telephone, a satellite telephone, a wireless Ethernet telephone, etc.), a digital music player, a tablet computing device, and a PDA, among others. As illustrated, object 3050 can include one or more of a simulated sound output device 6010, a simulated display 6020, and simulated buttons 6030-6032.

As shown, simulated display 6020 can display one or more of a picture or graphic 6050 and one or more buttons or icons 6040-6046. In one or more embodiments, a customer (e.g., a user of a CCD) can select and/or actuate one or more of icons 6040-6045 and buttons 6030-6032, and simulated object 3050 can perform one or more simulated functions associated with a selection or simulation of a selected icon or button of object 3050. In one example, the customer can select button 6031, and a numeric keypad can be displayed via simulated display 6020. For instance, keys of the numeric keypad can simulate a keypad of a telephone. In a second example, the customer can select button 6032, and an interface to a digital music player can be displayed via simulated display 6020. In another example, an icon of icons 6040-6046 can be selected to simulate a respective application of a calculator application, a clock application, a calendar application, a web browser application, a video chat application, a video player (e.g., a motion picture player) application, and a setting or configuration application.

In one or more embodiments, a simulation of object 3050 and/or one or more simulated features and/or functions can be performed via a CCD. In one example, a client-side script (e.g., JavaScript, EMCAScript, etc.) can be executed by a web browser of the CCD. In a second example, a compiled client-side program (e.g., Java byte code) can be executed by a web browser of the CCD. In one or more embodiments, a simulation of object 3050 and/or one or more simulated features and/or functions can be performed via a media server. In one example, the media server can receive information from a CCD that indicates a simulated button or icon has been selected and can utilize simulated display, via media interface 3040, to display functionality associated with the selected button or icon.

As shown in FIG. 6B, simulated display 6020 can display a simulation of a video chat application. In one example, a simulated picture or graphic 6141 of a person with whom the customer is chatting can be displayed via simulated display 6020. In another example, a simulated picture or graphic 6142 of the customer can be displayed via simulated display 6020. For instance, picture or graphic 6142 of the customer can demonstrate a front-facing camera of simulated object 3050. In one or more embodiments, the simulation of the video chat application can be started and/or executed in response to a selection and/or actuation of button or icon 6044 of FIG. 6A. For example, the simulation of the video chat application can be a video (e.g., a motion picture) that can be played via simulated display 6020.

In one or more embodiments, simulated display 6020 can be utilized to play one or more videos (e.g., motion pictures). In one example, simulated display 6020 can be utilized to play a clip from Youtube. In a second example, simulated display 6020 can be utilized to play a trailer to a movie. In another example, simulated display 6020 can be utilized to play videos that demonstrate one or more features of simulated object 3050. In one or more embodiments, user input can be received to pause, play, rewind, and/or fast-forward the video played via simulated display 6020.

In one or more embodiments, the customer can select button 6030 to return to a “home” state or location of simulated object 3050. For example, the “home” state or location of simulated object 3050 is illustrated in FIG. 6A. As illustrated in FIG. 6C, a picture or graphic 6250 can be displayed via simulated display 6020. For example, picture or graphic 6250 can be included in a graphical advertisement for a physical device associated with its simulated object 3050.

Turning now to FIG. 6D, an exemplary diagram of a simulated object with operational aids is illustrated, according to one or more embodiments. As shown in FIG. 6D, media interface 3040 can display where a headphone or headset connector 6310 can be plugged into a device associated with simulated object 3050 and/or can display where a USB (universal serial bus) connector 6320 can be plugged into a device associated with simulated object 3050. In one or more embodiments, a demonstration and/or simulation of coupling connectors to a device can be automated.

In one example, the customer can select “How to use headphones with your device” from a help menu. For instance, a media server can provide, to a media interface, data and/or information that includes a demonstration and/or simulation that demonstrates and/or simulates a process of coupling headphones with simulated object 3050. In another example, the customer can select “How to charge your device or connect your device to a PC or a Mac” from a help menu. For instance, a media server can provide, to a media interface, data and/or information that includes a demonstration and/or simulation that demonstrates and/or simulates a process of coupling simulated object 3050 with a computing device. For example, the demonstration and/or simulation can simulate a process of coupling simulated object 3050 with at least one of a PC, a Mac, and a charging device (e.g., a wall charger, a solar charger, etc.).

In one or more embodiments, a demonstration and/or simulation of connecting connectors to a device can instantiated and/or coordinated by a service representative via a CSD and/or a media server. For example, a service representative can be communicating with a customer, via telephone or via interactive communication interface 3060, and can provide control information, via one or more of CSD 1310, network 1010, and media server 1212, to interactive communication interface 3060 and/or an application associated with interactive communication interface 3060. For instance, the service representative can provide control information, via one or more of CSD 1310, network 1010, and media server 1212, to client interface 3020 and/or an application associated with client interface 3020, and media interface 3040 can display a demonstration of connecting headphone or headset connector 6310 and/or USB connector to a device associated with simulated object 3050.

Turning now to FIG. 6E, a network system that supports physical device emulation is illustrated, according to one or more embodiments. As shown, one or more of CCDs 1111-1113 can be coupled to media server 1211 via network 1010. In one or more embodiments, media server 1211 can include and/or execute one or more of a server app 6410, a server APP 6411, a server APP 6440, and an API (application programming interface) server APP 6450. As illustrated, API server APP 6450 can be coupled to server APP 6440, server APP 6440 can be coupled to server APP 6410, and server APP 6450 can be coupled to server APP 6411. In one or more embodiments, a first server APP can be coupled to a second server APP via one or more of a named pipe, an anonymous pipe, a pipe, a unix domain socket, a network connection (e.g., a network socket connection such as at least one of TCP, UDP, and IP, among others), a D-Bus (Desktop Bus), an IPC (interprocess communication) (e.g., inter-thread communication, inter-application communication, etc.), a shared memory interface, message passing, a file, and a file system, among others.

As illustrated, server APP 6410 can include one or more of an emulator proxy 6430 and one or more of emulators 6420-6422, and one or more of emulators 6420-6422 can be coupled to emulator proxy 6430. As shown, server APP 6411 can include one or more of one or more emulator proxies 6433-6435 and one or more of emulators 6423-6425, and one or more of emulators 6423-6425 can be coupled to respective one or more emulator proxies 6433-6435. In one or more embodiments, one or more of emulators 6423-6425 can include one or more of the same, similar or different functionalities and/or structures described with reference to one or more emulators 6420-6422, and one or more of emulator proxies 6433-6435 can include one or more of the same, similar or different functionalities and/or structures described with reference to emulator proxy 6430.

In one or more embodiments, one or more of emulator proxy 6430 and one or more of emulators 6420-6422 can include or be one or more of a process, a task, an application, and a thread, among others; and an emulator of emulators 6420-6422 can be coupled to emulator proxy 6430 via one or more of a named pipe, an anonymous pipe, a pipe, an Unix domain socket, a network connection, a D-Bus, an IPC, a shared memory interface, message passing, a file, and a file system, among others.

As shown, one or more of CCDs 1111-1113 can include and/or execute respective one or more client interfaces 63021-63023, respective one or more interactive media interfaces 63031-63033, and/or respective one or more media interfaces 6541-6543. In one or more embodiments, one or more client interfaces 63021-63023 can include same or similar one or more functionalities described with reference to client interface 3020, one or more interactive media interfaces 63031-63033 can include same or similar one or more functionalities described with reference to interactive media interface 3030, and/or one or more media interfaces 6541-6543 can include same or similar one or more functionalities described with reference to media interface 3040.

Turning now to FIG. 6F, a method of operating an API server APP is illustrated, according to one or more embodiments. At 6610, a first request from a CCD (e.g., a CCD of CCDs 1111-1113) can be received. For example, API server APP 6450 included in and/or executed by media server 1211 can receive, via network 1010, the first request from the CCD. In one instance, API server APP 6450 can receive, via network 1010, the first request from media interface 6541 included in and/or executed by CCD 1111. In a second instance, API server APP 6450 can receive, via network 1010, the first request from media interface 6542 included in and/or executed by CCD 1112. In another instance, API server APP 6450 can receive, via network 1010, the first request from an interactive media interface (e.g., an interactive media interface of interactive media interfaces 63031-63033) or a client interface (e.g., a client interface of client interfaces 63021-63023).

In one or more embodiments, the first request can include a request for connection information. For example, the first request can include a XMLHttpRequest (XHR) that includes the request for the connection information. At 6620, a second request can be provided to another server APP. For example, API server APP 6450 can provide the second request to server APP 6440.

In one or more embodiments, providing the second request to server APP 6440 can include initiating a remote procedure call (RPC) with server APP 6440. For example, providing the second request to server APP 6440 can include utilizing a RPC framework and/or a RPC functional library. For instance, providing the second request to server APP 6440 can include initiating a Thrift request with server APP 6440. In one or more embodiments, Thrift can include one or more a library (e.g., a software library) and one or more code generation tools that can be utilized to define data types and service interfaces in a language-neutral file and generate instructions (e.g., software executable by a processing system) that can be utilized in RPC clients and servers that are executable on respective computing devices.

At 6630, address information can be received. For example, API server APP 6450 can receive the address information from the other server APP (e.g., server APP 6440). In one or more embodiments, the address information from the other server can include one or more of an IP address, a port number (e.g., a TCP port number, a UDP port number, etc.), and audio proxy information, among others. In one example, one or more of the IP address and the port number can be utilized with a virtual network console (VNC) and/or a remote network console. In a second example, one or more of the IP address and the port number can be utilized with one or more of a remote desktop connection, an Apple remote desktop connection, and a remote X11 session or connection, among others. In another example, the audio proxy information can include information associated with a websocket proxy.

In one or more embodiments, a first computing device and a second computing device can communicate via a websocket API and/or protocol. In one example, the first computing device can provide, via a network, a first set of one or more TCP packets to a second computing device via the websocket API and/or protocol. For instance, providing the first set of one or more TCP packets to the second computing device can include providing, via HTTP or HTTPS, the first set of one or more TCP packets to the second computing device. In another example, the second computing device can provide, via the network, a second set of one or more TCP packets to the first computing device via the websocket API and/or protocol. For instance, providing the second set of one or more TCP packets to the second computing device can include providing, via HTTP or HTTPS, the second set of one or more TCP packets to the first computing device.

At 6640, the address information, received at 6630, can be provided to the CCD. For example, API server APP 6450 can provide the address information to the CCD. For instance, API server APP 6450 can provide a XHR object that includes the address information to the CCD. In one or more embodiments, the CCD can utilize the address information to communicate with emulator proxy 6430.

Turning now to FIG. 6G, a method for operating a server APP is illustrated, according to one or more embodiments. In one or more embodiments, the method illustrated in FIG. 6G can be utilized in operating server APP 6440 or other server APPs that include same or similar one or more functionalities of server APP 6440. At 6710, the second request (e.g., provided at 6620 can be received. For example, server APP 6440, included in and/or executed by media server 1211, can receive the second request from API server APP 6450.

At 6720, an emulator allocation request can be provided to an emulator server APP. For example, server APP 6440 can provide an emulator allocation request to an emulation server APP 6410. At 6730, a response from the emulator server APP can be received. For example, server APP 6440 can receive, from emulator server APP 6410, a response to the emulator allocation request.

At 6740, it can be determined if the response from the emulator server APP indicates that an emulator has been allocated. For example, server APP 6440 can determine if the response from the emulator server APP indicates that an emulator has been allocated. If the response from the emulator server APP indicates that an emulator has not been allocated, another emulator server APP can be determined at 6750. For example, server APP 6440 can determine another emulator server APP (e.g., different from emulator server APP 6410 such as server APP 6411). At 6760, an emulator allocation request can be provided to the other emulator server APP, and the method can proceed to 6730. For example, server APP 6440 can provide an emulator allocation request to the other emulation server APP.

If the response from the emulator server APP indicates that an emulator has been allocated, address information associated with one or more of an emulator and an emulator proxy can be determined, at 6770. In one example, server APP 6440 can determine the information associated with one or more of the emulator and the emulator proxy from the response from the emulator server APP and/or based on the response from the emulator server APP.

In another example, server APP 6440 can receive additional information from the emulator server APP and can determine the information associated with one or more of the emulator and the emulator proxy from the additional information from the emulator server APP and/or based on the additional information from the emulator server APP. At 6780, the address information can be provided to the API server APP. For example, server APP 6440 can provide the address information associated with one or more of the emulator and the emulator proxy to API server APP 6450.

Turning now to FIG. 6H, a method for operating an emulator server APP is illustrated, according to one or more embodiments. At 6810, an emulator allocation request can be received. For example, server APP 6410 can receive an emulator allocation request from server APP 6440. At 6820, it can be determined if an emulator can be allocated. For example, server APP 6410 can determine if an emulator can be allocated. In one or more embodiments, determining if an emulator can be allocated can include determining one or more of an amount of memory is available, a thread can be allocated, a process can be allocated, a task can be allocated, a processing load is below a threshold, and an amount of bandwidth is below a threshold, among others. If an emulator is not allocated, a response that indicates that an emulator has not been allocated can be provided, at 6830. For example, server APP 6410 can provide, to server APP 6440, a response that indicates that an emulator has not been allocated.

If an emulator can be allocated, an emulator can be allocated, at 6840. For example, server APP 6410 can allocate an emulator. For instance, server APP 6410 can allocate an emulator such as an emulator of emulators 6420-6422. In one or more embodiments, allocating an emulator can include marking an emulator, from a pool of available emulators, as no longer available to be allocated by an allocation request and providing the marked emulator as available to a requestor.

In one or more embodiments, an emulator can emulate a data processing system. In one example, the emulated data processing system can include an emulated memory coupled to an emulated processor that executes instructions from an ISA (instruction set architecture) that can be stored in the emulated memory. In one instance, the emulated processor can execute instructions from at least one of an ARM ISA, a MIPS ISA, an x86 ISA, a PowerPC ISA, and a DSP (digital signal processing) ISA, among others.

In a second instance, the emulated memory can include at least one of emulated DRAM (dynamic random access memory), SRAM (static random access memory), FRAM (ferroelectric random access memory), FLASH memory (e.g., NAND FLASH memory), EEPROM (electrically erasable read only memory), EPROM (erasable programmable read only memory), PROM (programmable read only memory), and ROM (read only memory), among others. In a third instance, the emulated data processing system can include at least one emulated bus, coupled to the emulated processor, such as at least one emulated bus of an I²C (inter-integrated circuit) bus, an universal serial bus (USB), a serial peripheral interconnect (SPI) bus, a peripheral component interconnect (PCI) bus, a peripheral component interconnect express (PCIe), and an advanced high-performance bus (AHB), among others.

In another instance, one or more emulated devices and/or interfaces can be coupled to the emulated processor, such as one or more of an emulated wireless Ethernet interface (e.g., a WiFi interface), an Ethernet interface, a global positioning system (GPS) receiver device, a GSM (global system for mobile communications) interface, a CDMA (code division multiple access) interface, a WiMAX interface, a proximity sensing device, a Bluetooth interface, a ZigBEE interface, a magnetometer, an accelerometer, a pressure transducer, a humidity sensing device, a capacitive sensing touch device, a resistive sensing touch device, an electronic gyroscope, a gas sensing device, an image sensing device (e.g., a digital camera), a sound sensing device (e.g., a microphone), a sound output device (e.g., a speaker), a digital compass device, a temperature sensing device, a FM radio receiving device (e.g., tunable to one or more frequencies of 87.5 MHz-108 MHz, 76 MHz-90 MHz, 162.4 MHz-162.55 MHz, etc.), a FM radio transmitting device (e.g., tunable to one or more frequencies of 87.5 MHz-108 MHz, 76 MHz-90 MHz, etc.), a light sensing device, a proximity sensing device, a radio frequency identification (RFID) sensing device, a RFID transmitting device, a near field communication (NFC) device, and a range determining device, among others.

In another example, the emulated data processing system can include a data processing emulator such as QEMU, SPIM, VMware, VirtualBox, or Bochs, among others. In one instance, SPIM can emulate a processor that can execute instructions from a MIPS ISA. In a second instance, QEMU can emulate a processor that can execute instructions from an IA-32 (e.g., x86) ISA, a MIPS ISA, a SPARC ISA, an ARM ISA, and a PowerPC ISA, among others. In another instance, QEMU, SPIM, VMware, VirtualBox, or Bochs can emulate one or more a memory system, a bus, a device, and an interface, among others, coupled to an emulated processor. In one or more embodiments, an emulator (e.g., an emulator of emulators 6420-6422) can be or include a virtual machine.

In one or more embodiments, an emulator (e.g., an emulator of emulators 6420-6422) can emulate and/or simulate one or more of a physical wireless telephone, a physical personal audio device, a physical tablet computing device, and a physical MP3 player, among others, and the emulator can execute an operating system and/or platform. In one example, the emulator can execute a Linux operating system and/or platform. In a second example, the emulator can execute an Android operating system and/or platform. In a third example, the emulator can execute an iOS operating system and/or platform. In a fourth example, the emulator can execute a BSD (Berkeley Software Distribution) operating system and/or platform. In a fifth example, the emulator can execute a Windows CE operating system and/or platform. In sixth example, the emulator can execute a Windows Mobile operating system and/or platform. In another example, the emulator can execute a VxWorks operating system and/or platform.

In one or more embodiments, the emulator can execute a data generating thread, task, and/or process that can emulate, simulate, and/or provide an operating system and/or platform with data associated with one or more functionalities of an emulated device (e.g., a physical wireless telephone, a physical personal audio device, a physical tablet computing device, a physical MP3 player, etc.). In one example, the data generating thread and/or process can provide the operating system and/or platform with data that emulates and/or simulates an incoming telephone call.

In one instance, the data generating thread and/or process can provide the operating system and/or platform with data that emulates and/or simulates GSM data. In a second instance, the data generating thread and/or process can provide the operating system and/or platform with data that emulates and/or simulates CDMA data. In a third instance, the data generating thread and/or process can provide the operating system and/or platform with data that emulates and/or simulates GPS data. In fourth instance, the data generating thread and/or process can provide the operating system and/or platform with data that emulates and/or simulates frequency modulation (FM) data (e.g., sounds and/or text data carried via a FM carrier wave). In another instance, the data generating thread and/or process can provide the operating system and/or platform with data that emulates and/or simulates amplitude modulation (AM) data (e.g., sounds and/or text data carried via a AM carrier wave).

In a second example, the data generating thread and/or process can provide the operating system and/or platform with data that emulates and/or simulates short messaging system (SMS) data. For instance, the data generating thread and/or process can provide the operating system and/or platform with data that emulates and/or simulates a SMS text message. In a third example, the data generating thread and/or process can provide the operating system and/or platform with data that emulates and/or simulates user input data. In one instance, the data that emulates and/or simulates user input data can be generated in response to user input data from a service representative. In another instance, the data that emulates and/or simulates user input data can be generated in response to user input data from a customer via a CCD utilized by the customer.

At 6850, a response that indicates that an emulator has been allocated can be provided. For example, server APP 6410 can provide, to server APP 6440, a response that indicates that an emulator has been allocated. At 6860, input/output (I/O) of the allocated emulator can be coupled to an emulator proxy. For example, server APP 6410 can couple I/O of the allocated emulator to emulator proxy 6430. For instance, server APP 6410 can couple I/O of an emulator of emulators 6420-6422 to emulator proxy 6430.

In one or more embodiments, utilizing emulator proxy 6430 can prohibit direct access of one or more clients (e.g., one or more of CCDs 1111-1113) to one or more emulators (e.g., one or more of emulators 6420-6422). For example, prohibiting direct access of one or more clients to one or more emulators can include providing and/or implementing access control. In one instance, providing and/or implementing access control can include limiting a number of ports (e.g., TCP ports, UDP ports, etc.) of one or more emulators that one or more clients can access. In another instance, providing and/or implementing access control can include limiting an amount of time that one or more clients can access one or more emulators and/or can include timing out one or more communication couplings after an amount of time transpires without communication activity and/or data.

In one or more embodiments, utilizing emulator proxy 6430 can bridge access of one or more clients (e.g., one or more of CCDs 1111-1113) utilizing a first communication protocol to one or more emulators (e.g., one or more of emulators 6420-6422) utilizing a second communication protocol. For example, the first communication protocol (e.g., a websocket protocol) can be different from the second communication protocol (e.g., a transmission control protocol). For instance, bridging access of one or more clients utilizing the first communication protocol to one or more emulators utilizing the second communication protocol can include translating and/or transforming data of the first communication protocol into data of the second communication protocol and/or can include translating and/or transforming data of the second communication protocol into data of the first communication protocol.

In one or more embodiments, I/O of an emulator can include video output. For example, the video output can include output that would be displayed on a screen of a device (e.g., a wireless telephone, a personal audio device, a tablet computing device, a MP3 player, etc.), and the video output can be provided to a client (e.g., a CCD of CCDs 1111-1113). For instance, providing the video output to the client can include providing the video output to the client via emulator proxy 6430 and/or network 1010. In an example, the I/O of an emulator can be implemented via a virtual network console (VNC) protocol and/or interface. In one instance, the emulator can provide video output to the client via the VNC protocol and/or interface. In another instance, an operating system and/or kernel executing on the emulator can provide video output to the client via the VNC protocol and/or interface.

In one or more embodiments, I/O of an emulator can include audio output. For example, the audio output can include sounds that would be produced and/or reproduced via a device (e.g., a wireless telephone, a personal audio device, a tablet computing device, a MP3 player, etc.), and the audio output can be provided to a client (e.g., a CCD of CCDs 1111-1113). For instance, providing the audio output to the client can include providing the audio output to the client via emulator proxy 6430 and/or network 1010. In an example, the I/O of an emulator can be implemented via a websocket protocol and/or interface.

In one or more embodiments, the audio output can include one or more of pulse width modulation data, pulse code modulation data, raw audio data, WAV audio data, AIFF audio data, AAC audio data, MPEG audio data, OGG audio data, Real Audio audio data, and WMA audio data, among others. In one example, the emulator can provide audio output to the client via the websocket protocol and/or interface. In another example, an operating system and/or kernel executing on the emulator can provide audio output to the client via the websocket protocol and/or interface.

In one or more embodiments, the method illustrated in FIG. 6H can be utilized by multiple emulators. In one example, two or more different emulators can emulate a same physical mobile device. In another example, two or more different emulators can emulate different respective physical mobile devices, and the two or more emulators emulating different respective physical mobile devices can perform differently in accordance with functionalities, devices, and/or structures associated with the different respective physical mobile devices.

In one or more embodiments, a first emulator can emulate a first physical device, and a second, different, emulator can emulate a second, different, physical device. For example, a first emulated mobile device, emulated via the first emulator, that corresponds to a first physical mobile device that can include a first physical processor, a first physical memory, and a first physical integrated circuit can be different from a second emulated mobile device, emulated via the second emulator, that corresponds to a second physical mobile device that can include a second physical processor, a second physical memory and a second physical integrated circuit, where at least one of the first physical processor, the first physical memory, and the first physical integrated circuit is different from a corresponding one of the second physical processor, the second physical memory and the second physical integrated circuit.

In one instance, the first physical integrated circuit can include one or more of a WiFi device (e.g., a WiFi interface), WiMAX device (e.g., a WiMAX interface), a GPS device, a GSM device (e.g., a GSM interface), a CDMA device (e.g., a CDMA interface), a satellite telephone network interface, a Bluetooth device (e.g., a Bluetooth interface), a ZigBEE device (e.g., a ZigBEE interface), a GPS device, an Ethernet device (e.g., an Ethernet interface), a proximity sensing device, a magnetometer, an accelerometer, a pressure transducer, a humidity sensing device, a capacitive sensing touch device, a resistive sensing touch device, an electronic gyroscope, a gas sensing device, an image sensing device (e.g., a digital camera), a sound output device, a sound sensing device (e.g., a microphone), a digital compass device, a temperature sensing device, a FM radio receiving device, a FM radio transmitting device, a light sensing device, a RFID sensing device, a RFID transmitting device, a NFC device, and a range determining device, among others. In a second instance, the first emulator can emulate an iPhone 4 that includes an Apple A4 processor, and the second emulator can emulate an iPhone 4S that includes an Apple A5 processor.

In third instance, the first emulator can emulate a first wireless telephone that includes a CDMA wireless telephone network interface, and the second emulator can emulate a wireless telephone that includes a GSM wireless telephone network interface. In fourth instance, the first emulator can emulate a first wireless telephone that includes a cellular wireless telephone network interface, and the second emulator can emulate a second wireless telephone that includes a satellite wireless telephone network interface. In a fifth instance, the first emulator can emulate a first wireless telephone that includes a first integrated circuit, and the second emulator can emulate a second wireless telephone that includes a second integrated circuit that is different from the first integrated circuit. In a sixth instance, the first emulator can emulate a first wireless telephone that includes a Trimble GPS device, and the second emulator can emulate a wireless telephone that includes a ublox GPS device. In another instance, the first emulator can emulate a first physical device that includes an integrated circuit (e.g., an audio integrated circuit, a graphics processing unit, a GPS integrated circuit, etc.), and the second emulator can emulate a second physical device that does not includes the integrated circuit.

Turning now to FIG. 6I, a method of operating a client that can interact with an emulator is illustrated, according to one or more embodiments. At 6910, functionality can be determined. For example, functionality of a client device for providing the GUI can be determined. For instance, functionality of a client interface can be determined via a scripting functionality. In one or more embodiments, the client interface can implement a media interface (e.g., a media interface of media interfaces 6540-6542). For example, the client interface can include a web browser, and functionality of the web browser can be determined. For instance, functionality of the web browser can include one or more of a scripting functionality, a plug-in functionality, a virtual machine functionality, and a markup language functionality, among others. In one or more embodiments, determining functionality can include determining a version of a functionality.

At 6920, emulation interface instructions and data can be received. For example, the client interface and/or a media interface can receive the emulation interface instructions and the emulation interface data from a media server via network 1010. For example, the client interface can include a web browser, and the web browser can receive the emulation interface instructions and the emulation interface data.

In one or more embodiments, the emulation interface instructions can include one or more of a script, executable byte code, and executable code for a plugin, among others. In one example, the emulation interface instructions can include the script that can be in accordance with a scripting language such as JavaScript, EMCAScript, Ruby, Python, or Lua, among others. In a second example, the executable byte code can be in accordance with one or more of Ruby byte code, Python byte code, Lua byte code, Ruby byte code, and Java byte code, among others. For instance, the byte code can be executed by a virtual machine. In another example, the executable code for a plugin can include Adobe Flash executable code, Java executable code, Ruby executable code, and Lua executable code, among others. In one or more embodiments, the emulation interface data can include one or more of a graphic and data of a markup language. For example, the markup language can include one or more of HTML and XML, among others.

At 6930, a user interface can be configured. For example, a media interface (e.g., a media interface of media interfaces 6540-6542) can be configured based on the emulation interface instructions (e.g., instructions associated with a scripting language such as JavaScript, EMCAScript, Ruby, Python, Lua, etc. and/or instructions associated with Ruby byte code, Python byte code, Lua byte code, Java byte code, etc.) and/or the emulation interface data (e.g., HTML data, XML data, etc.).

At 6940, information can be displayed to the customer via the user interface. For example, a media interface (e.g., a media interface of media interfaces 6540-6542) can display the information to the customer based on the emulation interface instructions and/or the emulation interface data. At 6950, the user interface (e.g., a media interface) can couple with an emulator (e.g., an emulator of emulators 6420-6422). For example, a media interface can couple with an emulator via network 1010 and/or emulator proxy 6430.

At 6960, input data can be received. In one example, a media interface can receive the input data from an emulator. For instance, the media interface can receive the input data from the emulator via network 1010 and/or emulator proxy 6430. In another example, the media interface can receive the input data from a customer (e.g., user input data). In one or more embodiments, input from the customer can include one or more of a selection of a graphic, a selection of an icon, a selection of a key (e.g., a key from a keypad, a key from a keyboard, etc.), visual input (e.g., one or more images from a camera coupled to a CCD), and sound input (e.g., one or more sounds from a microphone coupled to a CCD), among others.

At 6960, a source of the input data can be determined. If the source of the data is determined to be from the emulator, information can be displayed and/or sounds can be produced for the user (e.g., customer) via the media interface and/or a sound output device of a CCD, at 6970. In one or more embodiments, the method can proceed to 6960, where further information can be received. If the source of the data is determined to be from the user, the user input data can be provided to the emulator, at 6980. For example, the user input data can be provided to the emulator via network 1010 and/or emulator proxy 6430. In one or more embodiments, the method can proceed to 6960, where further information can be received.

Turning now to FIG. 6J, a method of providing multiple simulated objects to multiple CCDs is illustrated, according to one or more embodiments. At 6982, first information, associated with a first network address, can be received via a network. For example, the first information can be received from a first CCD (e.g., CCD 1110). At 6984, second information, associated with a second network address, can be received via the network. For example, the second information can be received from a second CCD (e.g., CCD 1111). In one or more embodiments, at least one of the first information and the second information can include a request for a simulated object and/or a request to interact with a simulated object.

At 6986, third information, associated with the first network address, can be provided to the network. For example, the third information can be addressed to the first network address (e.g., associated with the first CCD). In one or more embodiments, the third information can include first data utilizable, by a first client interface associated with the first CCD, to display a three-dimensional simulation of a first simulated object and/or to change a viewing angle of the first simulated object.

At 6988, fourth information, associated with the second network address, can be provided to the network. For example, the fourth information can be addressed to the second network address (e.g., associated with the second CCD). In one or more embodiments, the fourth information can include second data utilizable, by a second client interface associated with the second CCD, to display a three-dimensional simulation of a first simulated object and/or to change a viewing angle of the first simulated object.

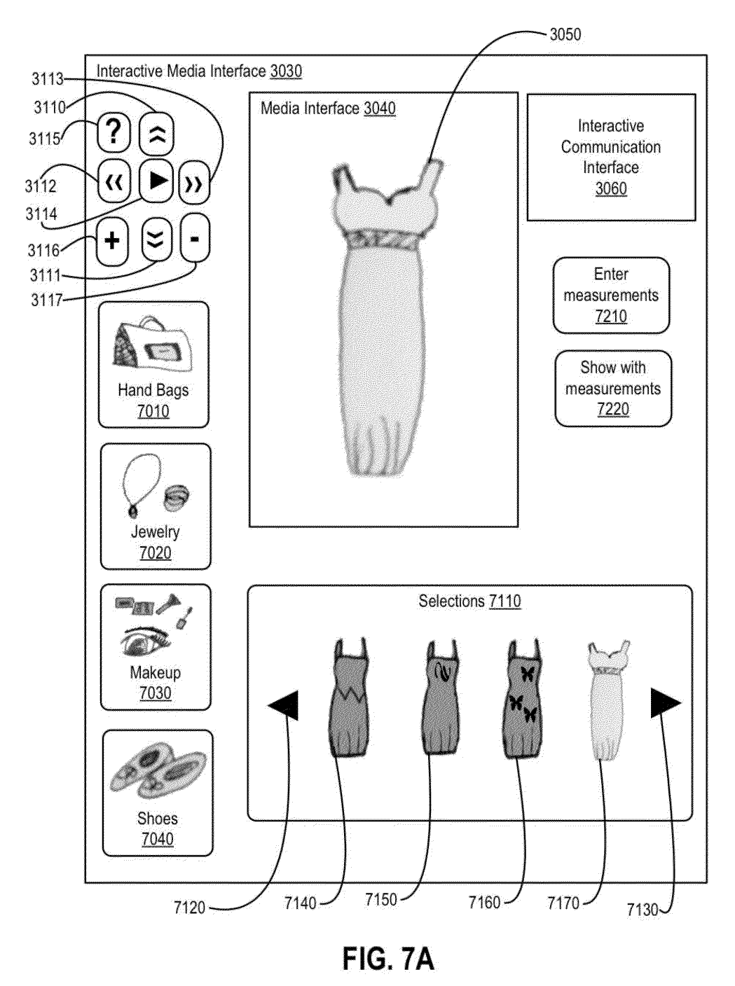

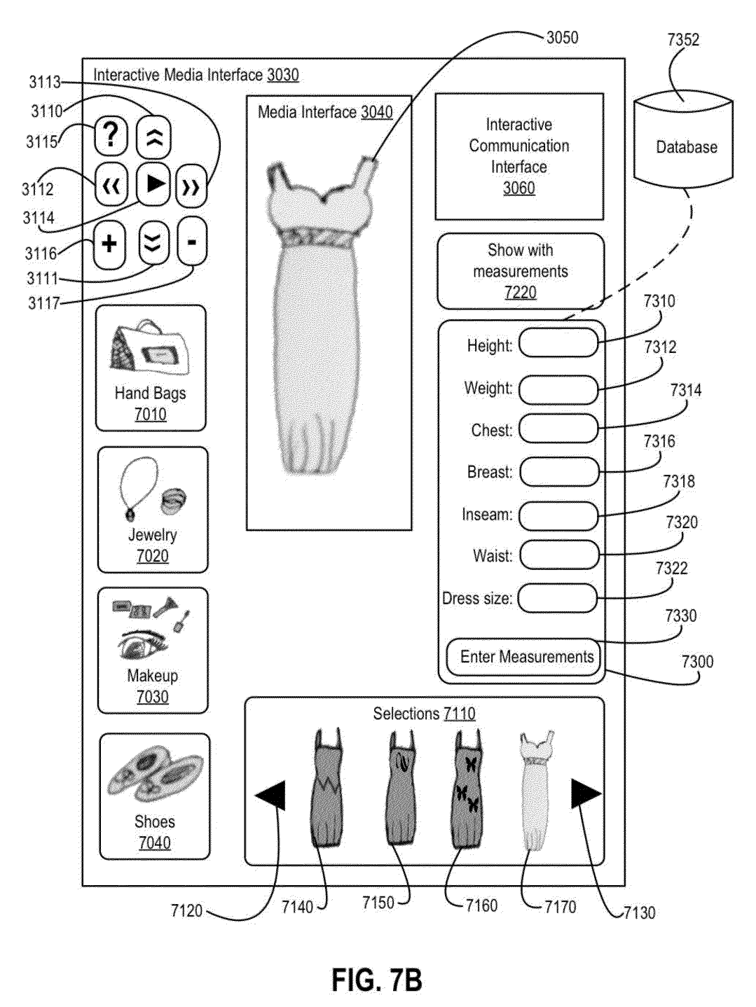

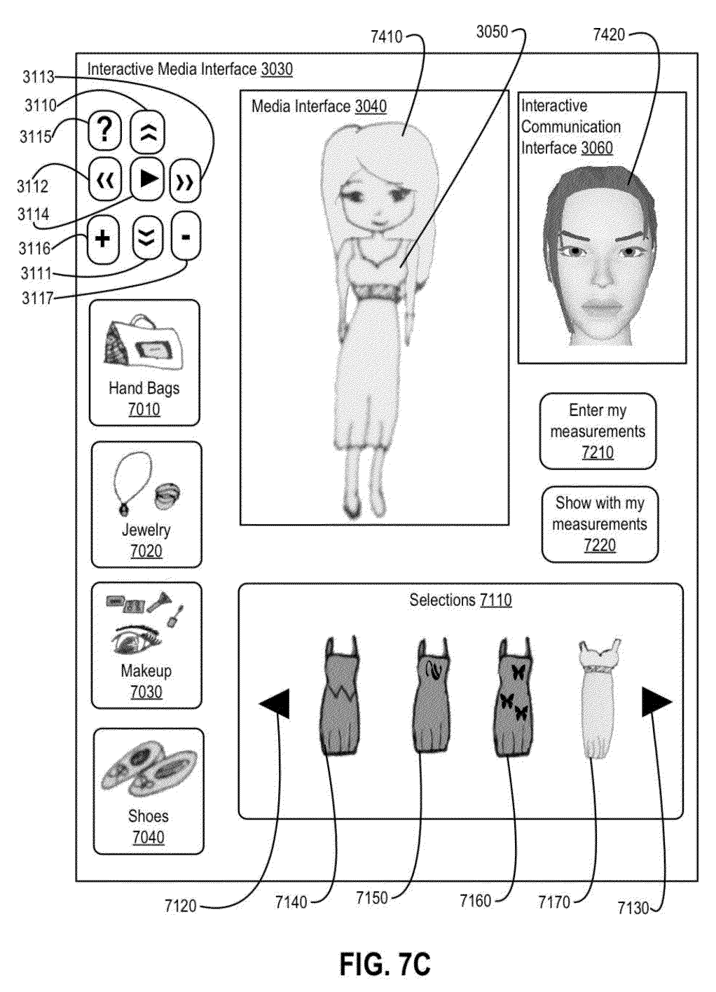

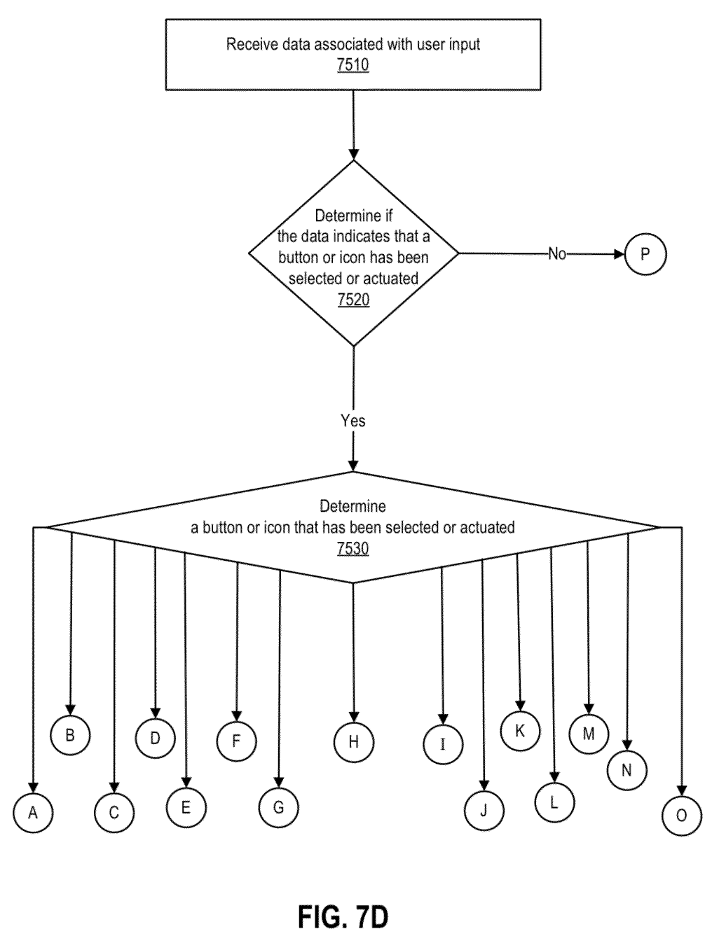

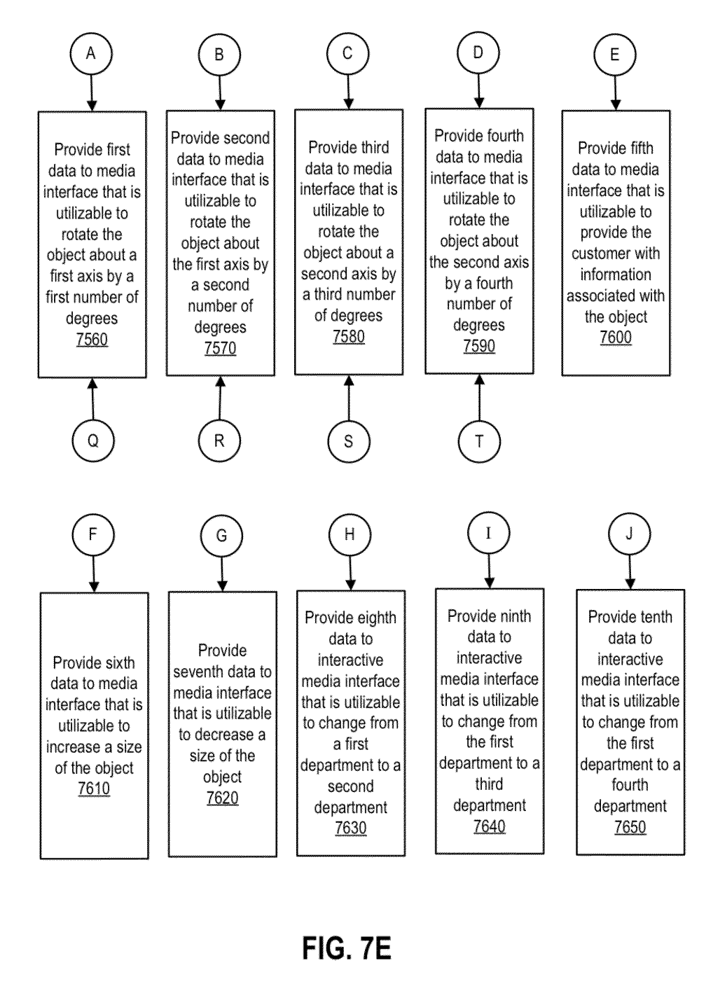

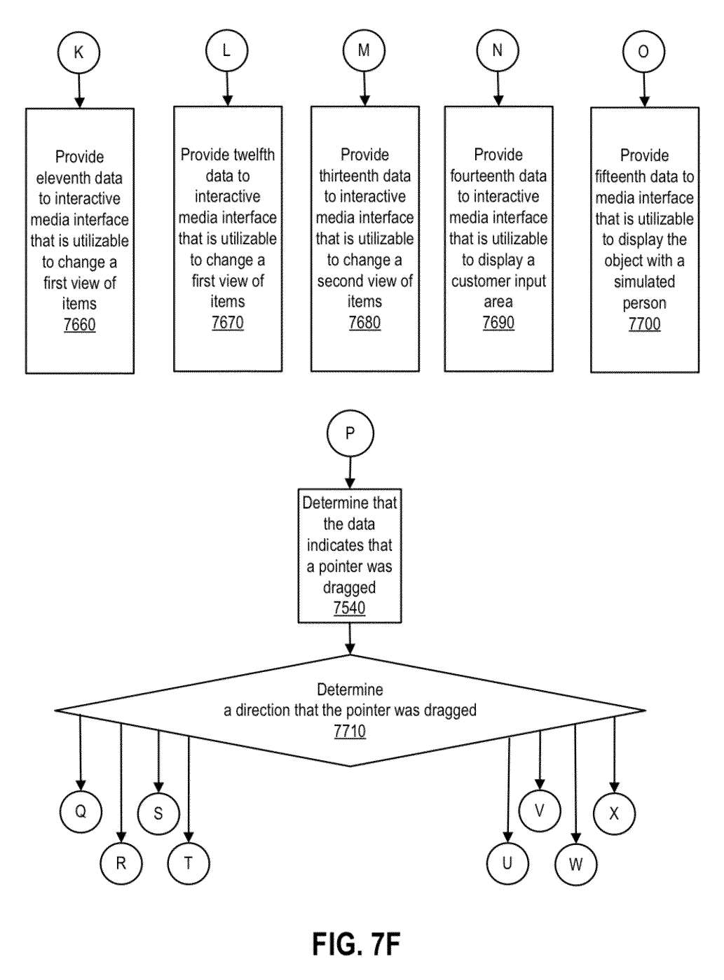

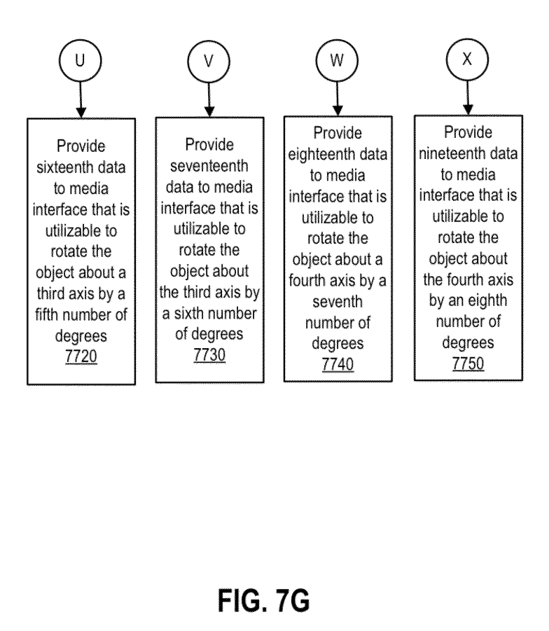

Turning now to FIGS. 7A-7C, exemplary diagrams of an interactive media interface are illustrated, according to one or more embodiments. As shown in FIG. 7A, media interface 3040 can display object 3050. For example, object 3050 can be a simulation of a dress, and a customer can utilize one or more controls such as one or more buttons or icons 3110-3117 to interact with and/or control simulated object 3050. As illustrated, interactive media interface 3030 can include buttons or icons 7010-7040 that can be selected and/or actuated by a customer (e.g., a user of a CCD) to access another department or group of items. For example, the customer can select and/or actuate one or more of buttons or icons 7010-7040 to access respective one or more of hand bags, jewelry, makeup, and shoes.

As illustrated, interactive media interface 3030 can include selections 7110, and selections 7110 can include one or more selection items 7140-7170. In one example, the customer can choose selection item 7170, and media interface 3040 can display selection item 7170 as simulated object 3050, as illustrated. In one or more embodiments, buttons or icons 7120 and 7130 can be selected and/or actuated to view one or more additional or other items that are not currently shown via interactive media interface 3030.

In one or more embodiments, the customer can actuate or select button or icon 7210 to enter one or more measurements associated with the customer or another person (e.g., a recipient of a potential or possible gift from the customer). If measurements have already been entered, the customer can actuate or select button or icon 7220 to show simulated object 3050 in accordance with the one or more measurements associated with the customer or the other person, as illustrated in FIG. 7C and described further below.

In one or more embodiments, customer input area 7300, as illustrated in FIG. 7B, can be displayed when button or icon 7210 is actuated and/or selected. As shown, one or more measurements of height, weight, chest size, breast size, inseam, waist, and dress size can be entered via respective one or more text entry boxes 7310-7322. Button or icon 7330 can be actuated and/or selected by the customer to indicate that one or more measurements can be received by media interface 3030 and/or a media server. As an alternative, or in conjunction one or more of these customer parameters may be read from a database 7352 (add 7352 database to read/write to 3030/7300 in FIG. 7B). New values or edited values may be written from the interface 7300 to the database 7352 to be retrieved for future use.

As shown in FIG. 7C, media interface 3040 can display object 3050 on a simulated person 7410 with the measurements acquired via customer input area 7300. In one or more embodiments, the customer can actuate or select one or more of buttons or icons 3110-3114, 3116, and 3117 to have media interface 3040 display object 3050 as described above and to have media interface 3040 display object 3050 on simulated person 7410.

In one or more embodiments, the customer can actuate or select button or icon 3115, and interactive communication interface 3060 can provide the customer with information. In one example, an avatar (e.g., a graphical approximation and/or rendering of an actual person or a simulated person) can be displayed via interactive communication interface 3060. In another example, interactive communication interface 3060 can provide the customer with a video of a service representative. As illustrated, graphic 7420 can represent an avatar or video of a service representative.

In one or more embodiments, a customer service representative can interact with the customer directly via text chat and/or video chat via interactive communication interface 3060, and the customer service representative can control and/or direct media interface 3040 to change how media interface displays object 3050. For example, the customer service representative can control and/or direct media interface 3040 to change how media interface 3040 displays object 3050 as though one or more of buttons and/or icons 3110-3114, 3116, and 3117 were actuated or selected.

Turning now to FIGS. 7D-7G, a method of operating a media server interface is illustrated, according to one or more embodiments. At 7510, data associated with user input can be received. In one example, the data associated with user input can indicate that a button or icon of buttons or icons 3110-3117, 7010-7040, 7120, 7130, 7210, and 7220 has been actuated or selected. In a second example, the data associated with user input can indicate that a selection item of selection items 7140-7170 has been actuated or selected. In another example, the data associated with user input can indicate that a pointer was dragged across media interface 3040 to rotate object 3050 in a direction about an axis.

At 7520, it can be determined if the data associated with user input indicates that a button or icon of buttons or icons 3110-3117, 7010-7040, 7120, 7130, 7210, and 7220 has been actuated or selected. If the data associated with user input indicates that a button or icon of buttons or icons 3110-3117, 7010-7040, 7120, 7130, 7210, and 7220 has been actuated or selected, it can be determined which button or icon of buttons or icons 3110-3117, 7010-7040, 7120, 7130, 7210, and 7220 has been actuated or selected at 7530. If the data associated with user input does not indicate that a button or icon of buttons or icons 3110-3117, 7010-7040, 7120, 7130, 7210, and 7220 has been actuated or selected, it can be determined that a pointer was dragged across media interface 3040 to rotate object 3050, at 7540.

If button or icon 3110 has been selected or actuated, first data can be provided to media interface 3040 that is utilizable to rotate object 3050 about a first axis (e.g., a horizontal axis) by a first number of degrees at 7560. For example, object 3050 can rotate about the first axis by the first number of degrees in the direction shown in FIG. 4D. If button or icon 3111 has been selected or actuated, second data can be provided to media interface that is utilizable to rotate object 3050 about the first axis by a second number of degrees at 7570. For example, object 3050 can rotate about the first axis by the second number of degrees in the direction shown in FIG. 4E.

If button or icon 3112 has been selected or actuated, third data can be provided to media interface 3040 that is utilizable to rotate object 3050 about a second axis (e.g., a vertical axis) by a third number of degrees at 7580. For example, object 3050 can rotate about the second axis by the third number of degrees in the direction shown in FIG. 4B. If button or icon 3113 has been selected or actuated, fourth data can be provided to media interface that is utilizable to rotate object 3050 about the second axis by a fourth number of degrees at 7590. For example, object 3050 can rotate about the second axis by the fourth number of degrees in the direction shown in FIG. 4C. In one or more embodiments, one or more of buttons or icons 3110-3113 can be selected to manipulate simulated object 3050.

If button or icon 3114 has been selected or actuated, fifth data can be provided to media interface 3040 that is utilizable to display a video that includes and/or is associated with object 3050 at 7600. For example, the video can be or include an interactive video that includes and/or is associated with object 3050. For instance, the interactive video can be or include a simulation that includes and/or is associated with object 3050. In one example, an avatar (e.g., a graphical approximation and/or rendering of an actual person or a simulated person) can be displayed via interactive communication interface 3060, that can provide the customer with information. In another example, interactive communication interface 3060 can provide the customer with a video of a service representative. For instance, a customer service representative can interact with the customer directly via text chat and/or video chat via interactive communication interface 3060.

If button or icon 3115 has been selected or actuated, sixth data can be provided to media interface 3040 that is utilizable to increase a size of object 3050 at 7610. For example, increasing a size of object 3050 can include zooming in-on object 3050 and/or magnifying at least a portion of object 3050. If button or icon 3117 has been select or actuated, seventh data can be provided to media interface 3040 that is utilizable to increase a size of object 3050 at 7620. For instance, decreasing a size of object 3050 can include zooming out-from object 3050.

If button or icon 7010 has been selected or actuated, eighth data can be provided to interactive media interface 3030 that is utilizable to change from a first shopping department to a second shopping department at 7630. For example, the second shopping department can include handbags. If button or icon 7020 has been selected or actuated, ninth data can be provided to interactive media interface 3030 that is utilizable to change from the first shopping department to a third shopping department at 7640. For example, the third shopping department can include jewelry.

If button or icon 7030 has been selected or actuated, tenth data can be provided to interactive media interface 3030 that is utilizable to change from the first shopping department to a fourth shopping department at 7650. For example, the fourth shopping department can include makeup. If button or icon 7040 has been selected or actuated, eleventh data can be provided to interactive media interface 3030 that is utilizable to change from the first shopping department to a fifth shopping department at 7660. For example, the fifth shopping department can include shoes.

If button or icon 7120 has been selected or actuated, twelfth data can be provided to interactive media interface 3030, at 7670, that is utilizable to change a first view of items such that at least a first item that is not currently shown via interactive media interface 3030 can be displayed. If button or icon 7130 has been selected or actuated, thirteenth data can be provided to interactive media interface 3030, at 7680, that is utilizable to change a second view of items such that at least a second item that is not currently shown via interactive media interface 3030 can be displayed.

If button or icon 7210 has been selected or actuated, fourteenth data can be provided to interactive media interface 3030 that is utilizable to display customer input area 7300 at 7690. If button or icon 7220 has been selected or actuated, fifteenth data can be provided to media interface 3040, at 7700, that is utilizable to display object 3050 with a simulated person. For example, the fifteenth data can be provided to media interface 3040 that is utilizable to display object 3050 on simulated person 7410 with the measurements acquired via customer input area 7300.

As described above, it can be determined, at 7540, that the data associated with user input indicates that a pointer was dragged across media interface 3040 to rotate object 3050 in a direction about an axis. At 7710, a direction that the pointer was dragged can be determined. In one example, the data associated with user input can indicate that the pointer was dragged across media interface 3040 in a direction north, a direction south, a direction east, or a direction west. In another example, the data associated with user input can indicate that the pointer was dragged across media interface 3040 in a direction north-east, a direction north-west, a direction south-east, or a direction south-west. If the direction that the pointer was dragged is determined to be north, the method can proceed to 7560. If the direction that the pointer was dragged is determined to be south, the method can proceed to 7570. If the direction that the pointer was dragged is determined to be west, the method can proceed to 7580. If the direction that the pointer was dragged is determined to be east, the method can proceed to 7590.

If the direction that the pointer was dragged is determined to be north-east, sixteenth data can be provided to media interface 3040 that is utilizable to rotate object 3050 about a third axis (e.g., a first diagonal axis, such as an axis from the south and west to the north and east) by a fifth number of degrees at 7720. If the direction that the pointer was dragged is determined to be south-west, seventeenth data can be provided to media interface 3040 that is utilizable to rotate object 3050 about the third axis by a sixth number of degrees at 7730. If the direction that the pointer was dragged is determined to be north-west, eighteenth data can be provided to media interface 3040 that is utilizable to rotate object 3050 about a fourth axis (e.g., a second diagonal axis, such as an axis from the south and east to the north and west) by a seventh number of degrees at 7740. If the direction that the pointer was dragged is determined to be south-east, nineteenth data can be provided to media interface 3040 that is utilizable to rotate object 3050 about the fourth axis by an eighth number of degrees at 7750.

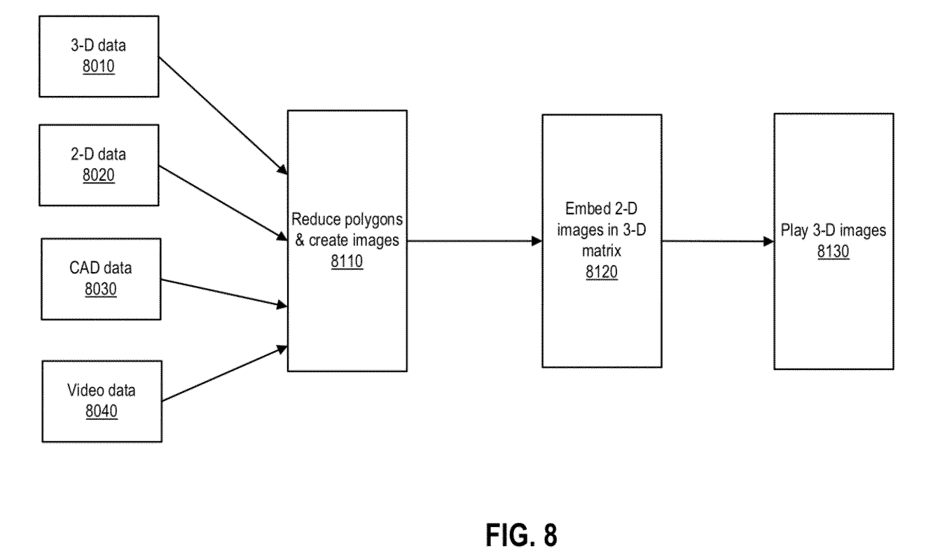

Turning now to FIG. 8, a block diagram of an exemplary process of transforming image data associated with an object into data that can be utilized by a media interface is illustrated, according to one or more embodiments. As shown, polygons (e.g., polygons associated with input data from one or more of 3-D data 8010, two-dimensional (2-D) data 8020, computer aided drawing (CAD) data 8030, and video data 8040) can be reduced and images can be created at 8110. In one example, three-dimensional (3-D) data 8010 can include one or more Cinema 4D files associated with a physical object (Cinema 4D Studio is available from Maxon Computer, Inc.). In a second example, 2-D data 8020 can include one or more pictures or digital photography associated with a physical object. In a third example, CAD data 8030 can include one or more CAD files.

In one instance, the one or more CAD files can include one or more AutoCAD files (AutoCAD is available from Autodesk, Inc.). In a second instance, the one or more CAD files can include one or more TurboCAD files (TurboCAD is available from IMSI/Design, LLC). In another instance, the one or more CAD files can include one or more of a drawing interchange format, a drawing exchange format, a DWG format, a Windows metafile format, a Hewlett-Packard graphics language format, a RenderMan format, a RenderMan interface bytestream format, and a virtual reality modeling language format, among others.

In one or more embodiments, one or more of data 8010-8040 can be or include meta data associated with a physical object. For example, one or more of data 8010-8040 can be or include a function that is utilizable to map the meta data associated with the physical object to a coordinate system (e.g., a Cartesian coordinate system, a spherical coordinate system, etc.). For instance, CAD data 8030 can include meta data associated with a physical object that characterizes a space, in a three-dimensional coordinate system, occupied by the physical object.

In one or more embodiments, one or more 2-D images can be created from one or more 3-D coordinate data that can describe an object. For example, creating one or more 2-D images from the one or more 3-D coordinate data that can describe the object can include computing one or more projections. In one or more embodiments, a 2-D graphical representation of the object can be computed via projecting a description of the object (e.g., described via 3-D coordinate data) onto a 2-D plane to create the 2-D graphical representation of the object.

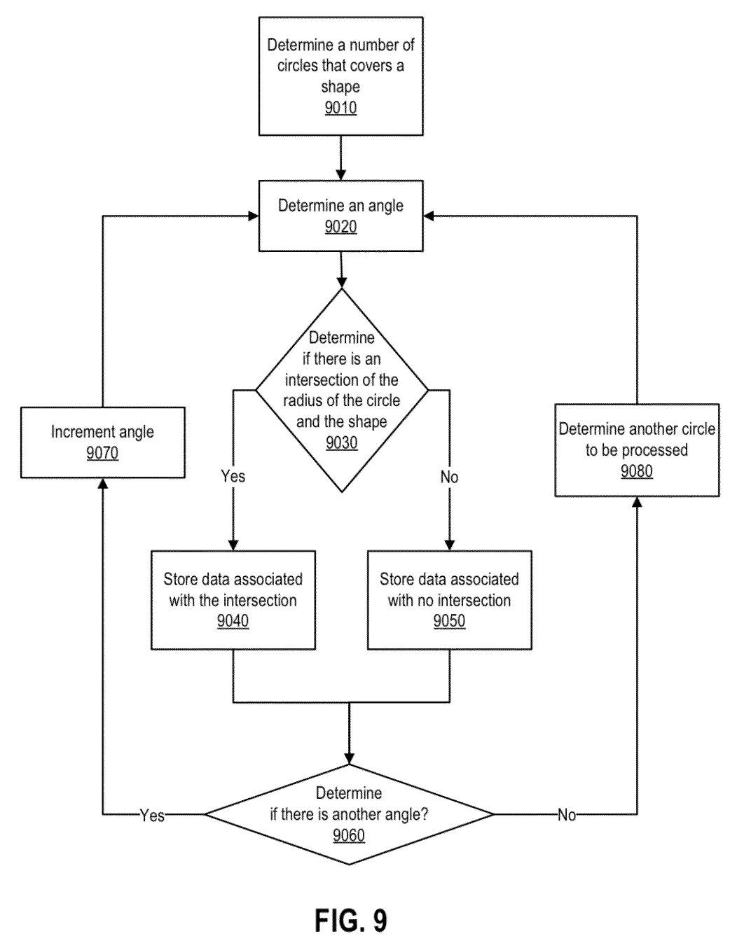

At 8120, 2-D images can be embedded in a 3-D matrix. For example, 2-D images 3200-3451 of FIGS. 5B-5I can be embedded in a 3-D matrix. In one or more embodiments, 2-D images (e.g., 2-D images 3200-3451 of FIGS. 5B-5I) can be computed via projecting a description of the object (e.g., described via 3-D coordinate data) onto a 2-D plane to create the 2-D images of object 3050 illustrated in FIG. 5. At 8130, 2-D images can be played from the 3-D matrix. In one or more embodiments, functional block 8110 can include one or more same or similar structures and/or functionalities as described with reference to one or more of FIGS. 9, 10, 11A-11C, 12, 13A-13C, 14A-14C, 15, 16A-16H, and 17. In one or more embodiments, functional block 8130 can include one or more same or similar structures and/or functionalities as described with reference to one or more of FIGS. 3, 4A-4E, 5, 6A-6D, and 7A-7G.

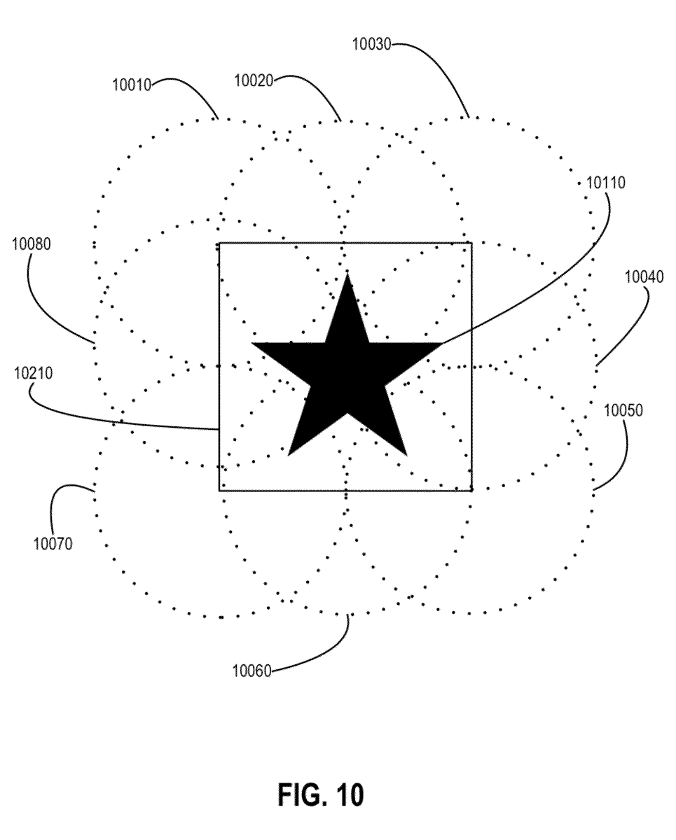

Turning now to FIG. 9, a method of transforming image data of a two-dimensional shape into meta data of the shape is illustrated, according to one or more embodiments. At 9010, a number of circles that covers a shape can be determined. For example, circles 10010-10080 can be determined to cover shape 10110, as illustrated in FIG. 10. As shown in FIG. 10, centers of circles 10010-10080 can lie on edges of a polygon 10210. At 9020, an angle can be determined. In one or more embodiments, angles of a radius of a circle can be iterated from a first edge of a polygon to a second edge of a polygon.

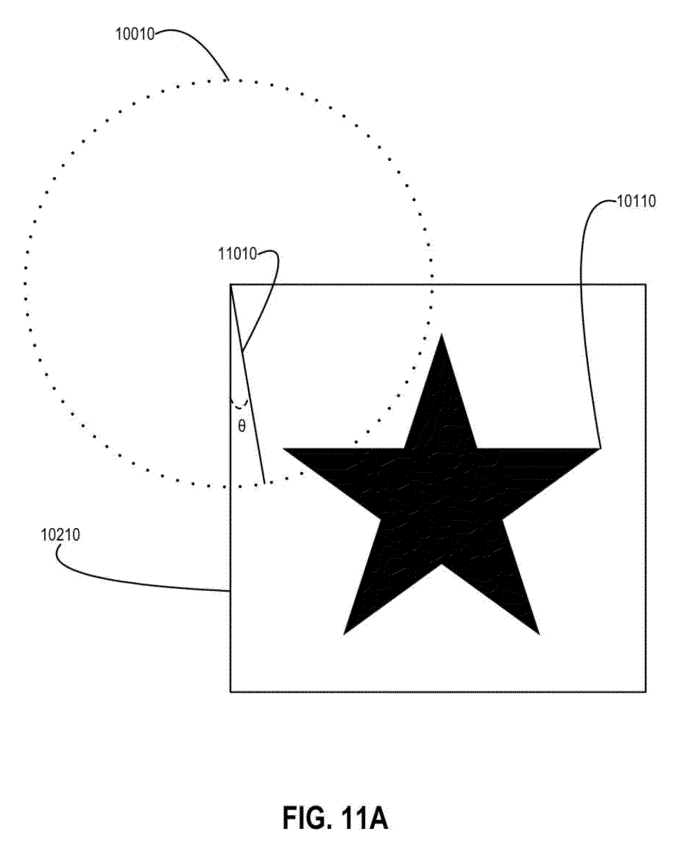

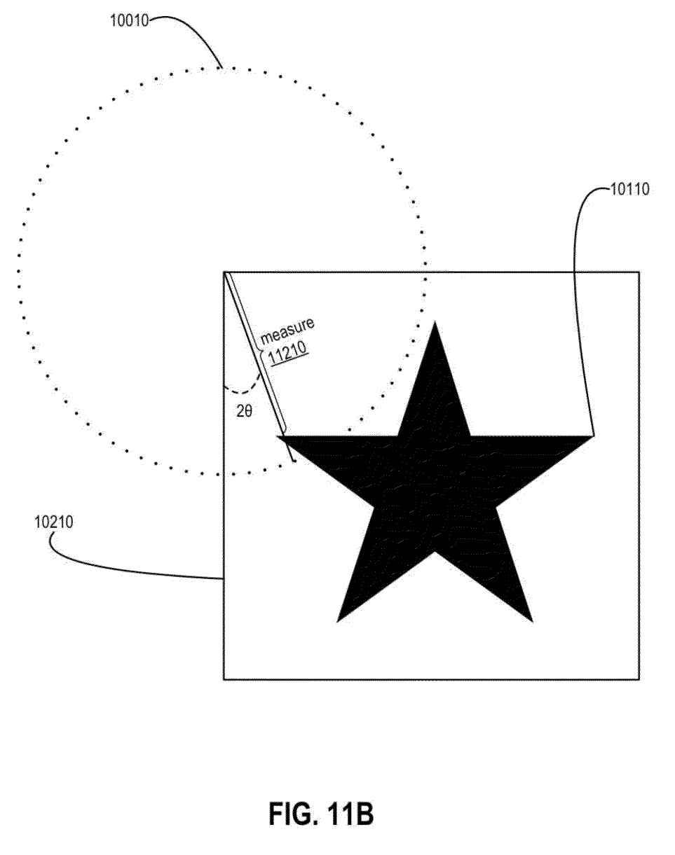

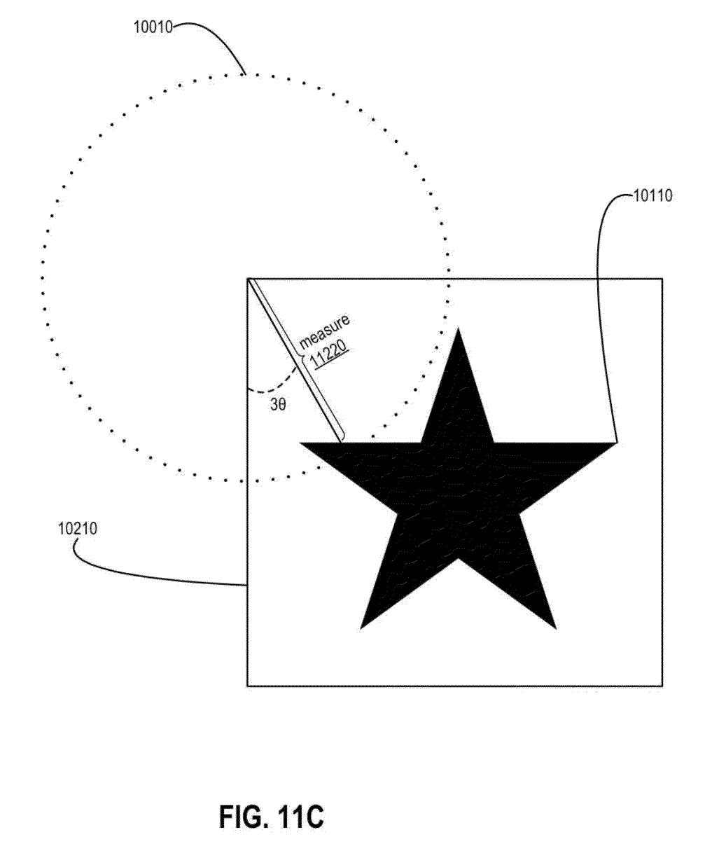

In one example, processing a first iteration for a circle, an angle can be determined to be theta, where theta is a number of degrees or radians. An exemplary radius 11010 at an angle theta is illustrated in FIG. 11A. In another example, processing a next iteration for a circle, an angle can be determined to be a previous angle plus theta, where theta is a number of degrees or radians. For instance, radius 11010 at a next angle (e.g., 20) is illustrated in FIG. 11B.

At 9030, it can be determined if there is an intersection of the radius of the circle and the shape. If there is not an intersection of the radius of the circle and the shape, data associated with no intersection can be stored at 9050. For example, there is not intersection of radius 11010 of circle 10010 and shape 10110 as illustrated in FIG. 11A. For instance, a number zero can be stored to indicate that there is no intersection of the radius of the circle and the shape.

If there is an intersection of the radius of the circle and the shape, data associated with the intersection can be stored at 9040. For example, there is an intersection of radius 11010 of circle 10010 and shape 10110 as illustrated in FIG. 11B (which illustrates an exemplary second iteration). In one or more embodiments, the data associated with the intersection can include a measure, according to some metric, from a center of the circle to the intersection of the radius of the circle and the shape. In one example, the measure can include a floating-point number. In a second example, the measure can include an integral number. In one instance, a measure 11210, as shown in FIG. 11B, can be stored. In another instance, a measure 11220, as shown in FIG. 11C (which illustrates an exemplary third iteration), can be stored. In one or more embodiments, shape 10110 can be considered a solid object, where an intersection of a radius of a circle and the solid object, determined with reference to the method of FIG. 9, is a minimum measure of any intersection of the radius of the circle and the solid object for the angle (e.g., 20).

At 9060, it can be determined if there is another angle to process. If there is another angle to process, an angle can be incremented at 9070. In one example, the angle that was previously processed can be incremented theta degrees or radians. In another example, the angle that was previously processed can be incremented an integral number of theta degrees or radians. If there is not another angle to process, another circle to process can be determined at 9080. In one example, the other circle or a next circle can include circle 10020. In another example, the other circle or a next circle can include a circle from circles 10030-10080.

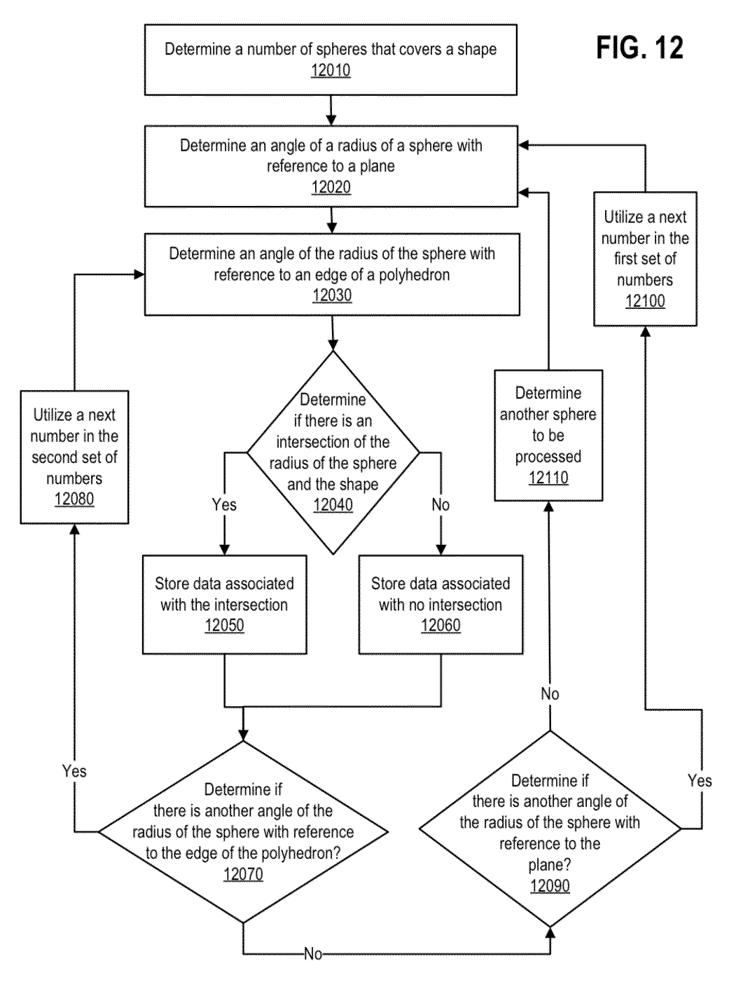

Turning now to FIG. 12, a method of transforming image data of a three-dimensional shape into meta data of the shape is illustrated, according to one or more embodiments. At 12010, a number of spheres that covers a shape can be determined. For example, spheres 13310-1334 can be determined to cover shape 13010, as illustrated in FIGS. 13B and 13C. In one or more embodiments, centers of the determined spheres can lie on edges of a polyhedron (e.g., a cuboid). For example, centers of spheres 13310-13316 can lie on edge 13224 of a polyhedron 13110, centers of spheres 13320-13326 can lie on edge 13214 of polyhedron 13110, centers of spheres 13330-13336 can lie on edge 13230 of polyhedron 13110, and centers of spheres 1338-13344 can lie on edge 13210 of polyhedron 13110. In one or more embodiments, polyhedron 13110 can include other edges, such as edges 13210, 13216, 13218, 13220, 13228, and 13232.

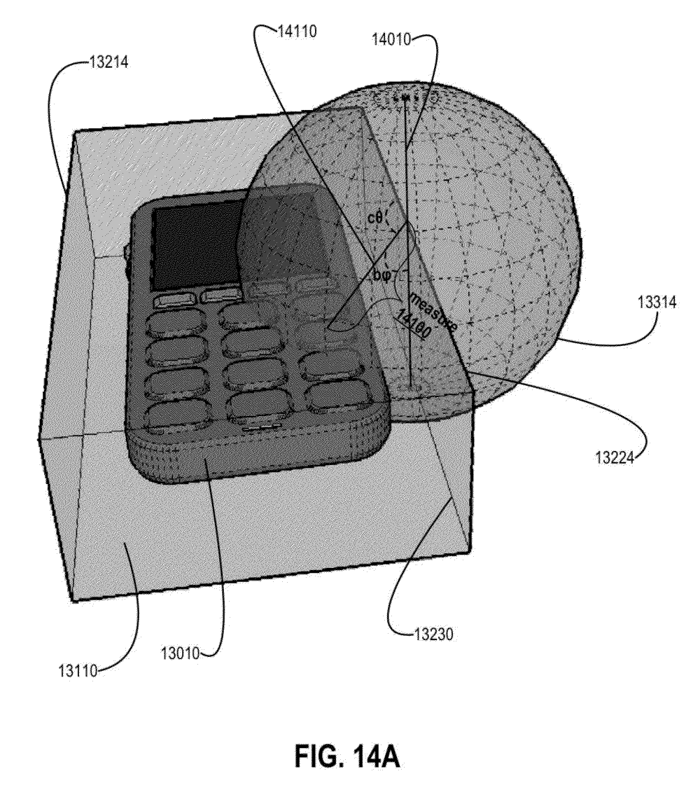

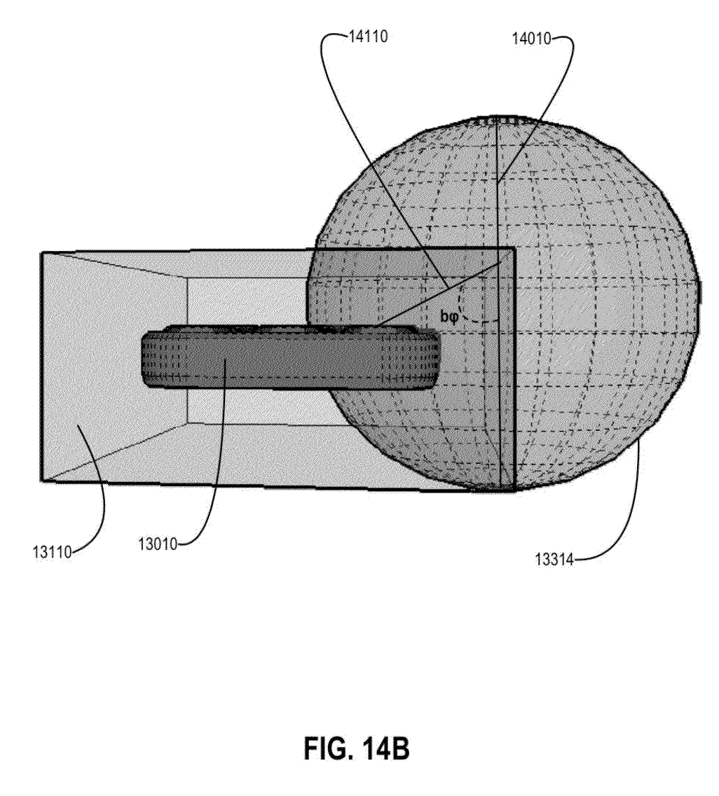

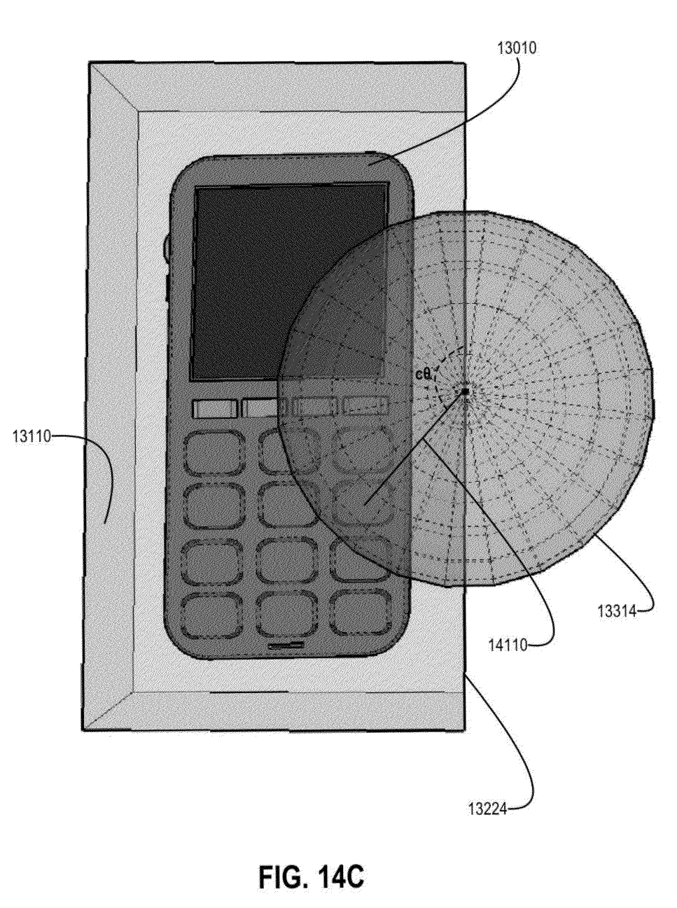

At 12020, an angle of a radius of a sphere with reference to a plane can be determined. In one or more embodiments, the angle of the radius of the sphere with reference to the plane can include an integral number multiplied by a number phi. As illustrated in FIG. 14A, for example, the plane can include polyhedron edges 13224 and 13230, and the angle of the radius of the sphere with reference to the plane can include an integer “b” multiplied by phi or bφ. In one or more embodiments, b can be variable over a first set of numbers such that 0≦bφ≦90 degrees (or π/2 radians). As illustrated, the angle of the radius of the sphere with reference to the plane can be an angle between a radius 14110 of sphere 13312 and an axis 14010 of sphere 13314. FIG. 14B illustrates the angle of the radius of the sphere with reference to the plane, from a different perspective.

At 12030, an angle of the radius of the sphere with reference to an edge of a polyhedron can be determined. In one or more embodiments, the angle of the radius of the sphere with reference to the edge of the polyhedron can include an integral number multiplied by a number theta. As illustrated in FIG. 14A, for example, the edge of the polyhedron can include edge 13224, and the angle of the radius of the sphere with reference to the edge of the polyhedron can include an integer “c” multiplied by theta or cθ. In one or more embodiments, c can be variable over a second set of numbers such that 0≦cθ≦180 degrees (or π radians). FIG. 14C illustrates the angle of the radius of the sphere with reference to the edge of the polyhedron, from a different perspective.

In one or more embodiments, c can be variable over a set of numbers such that 0≦cθ≦90 degrees (or π/2 radians) when an axis of a sphere intersects two different edges of a polyhedron. For example, c can be variable over a set of numbers such that 0≦cθ≦90 degrees (or π/2 radians) for sphere 13310.

At 12040, it can be determined if there is an intersection of the radius of the sphere and the shape. For example, it can be determined if there is an intersection of radius 14110 of sphere 13314 and shape 13010. If there is not an intersection of the radius of the sphere and the shape, data associated with no intersection can be stored at 12060. For example, a number zero can be stored to indicate that there is no intersection of the radius of the sphere and the shape. If there is an intersection of the radius of the sphere and the shape, data associated with the intersection can be stored at 12050. For example, there is an intersection of radius 14110 of sphere 13314 and shape 13010 as illustrated in FIG. 14A.

In one or more embodiments, the data associated with the intersection can include a measure, according to some metric, from a center of the sphere to the intersection of the radius of the sphere and the shape. In one example, the measure can include a floating-point number. In a second example, the measure can include an integral number. For instance, a measure 14100, as shown in FIG. 14A, can be stored. In one or more embodiments, shape 13010 can be considered a solid object, where an intersection of the radius of the sphere and the solid object, determined with reference to the method of FIG. 12, is a minimum measure of any intersection of the radius (of the sphere), at the angle with reference to the plane (e.g., at a first angle) and at the angle with reference to the edge of the polyhedron (e.g., at a second angle), and the solid object.

At 12070, it can be determined if there is another angle of the radius of the sphere, with reference to the edge of the polyhedron, to process. If there is another angle of the radius of the sphere, with reference to the edge of the polyhedron, to process, a next number in the second set of numbers can be utilized at 12080. If there is not another angle of the radius of the sphere, with reference to the edge of the polyhedron, to process, it can be determined if there is another angle of the radius of the sphere with reference the plane to process at 12090. If there is another angle of the radius of the sphere, with reference to the plane, to process, a next number in the first set of numbers can be utilized at 12100. If there is not another angle of the radius of the sphere, with reference to the plane, to process, another sphere to be processed can be determined at 12110.

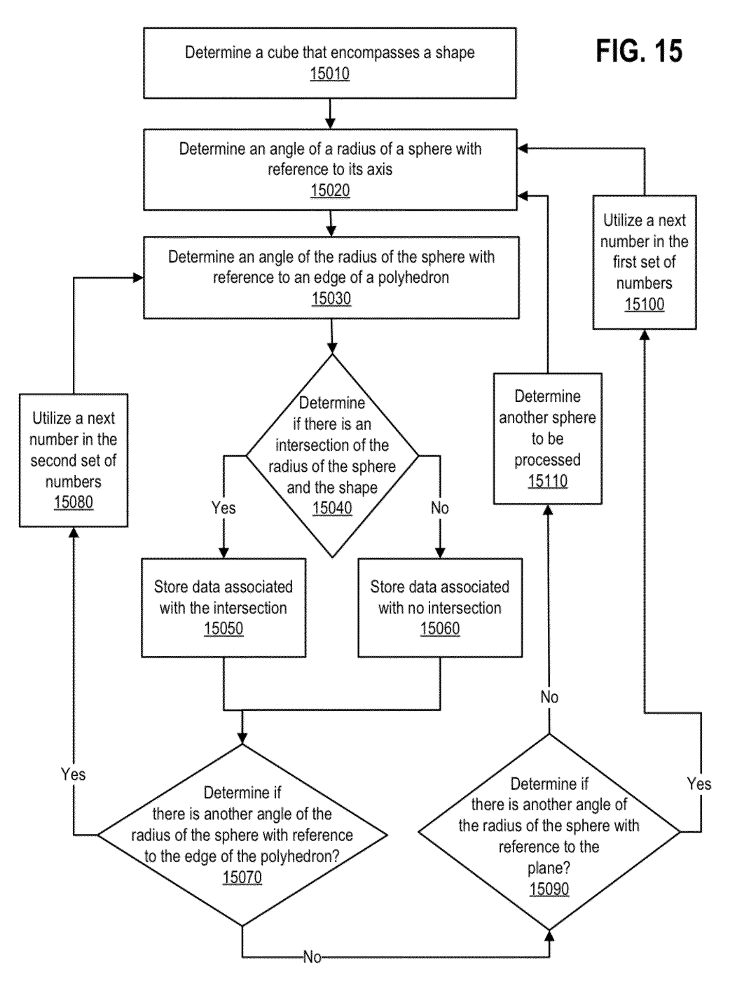

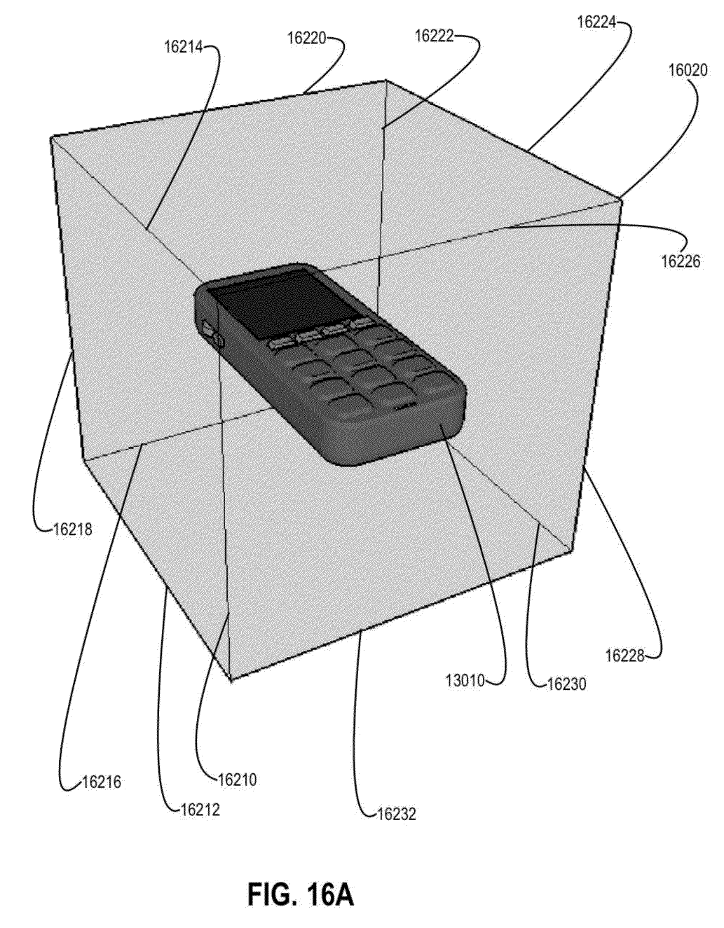

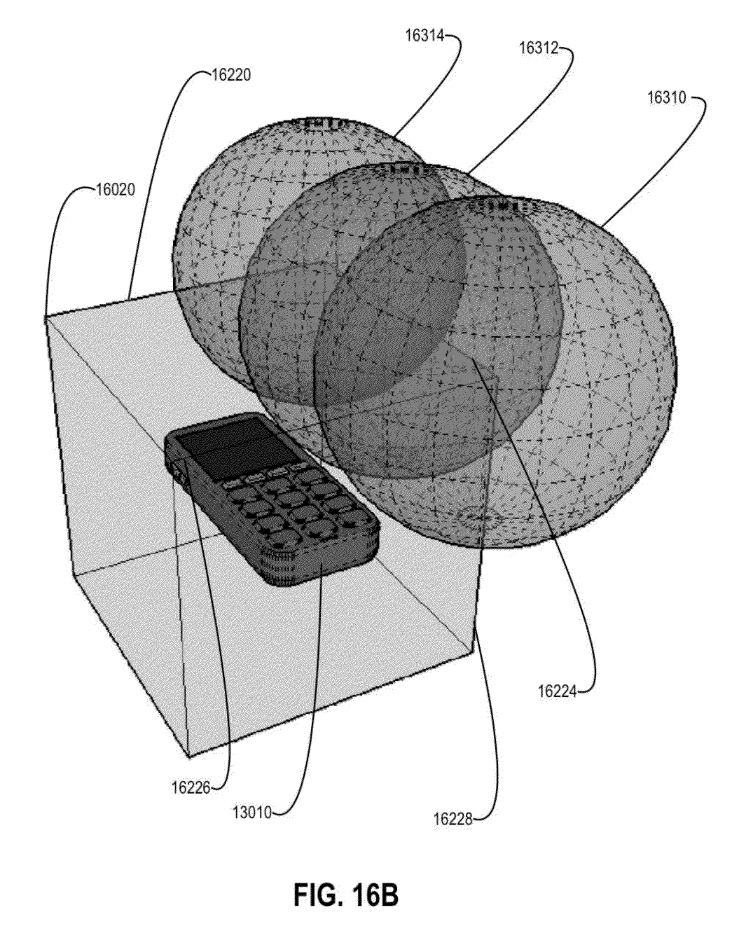

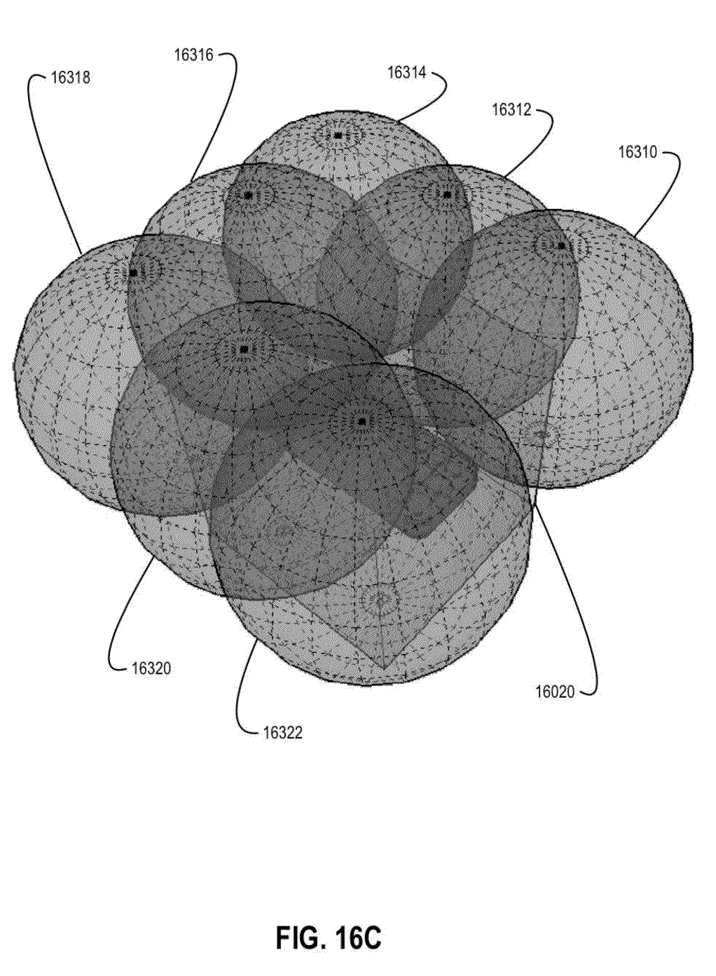

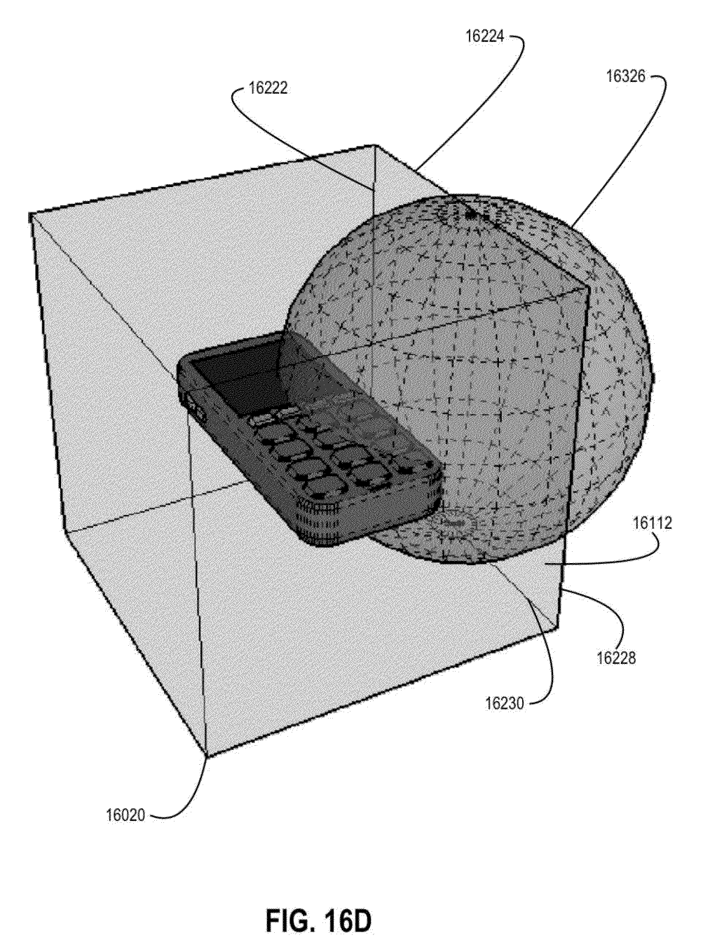

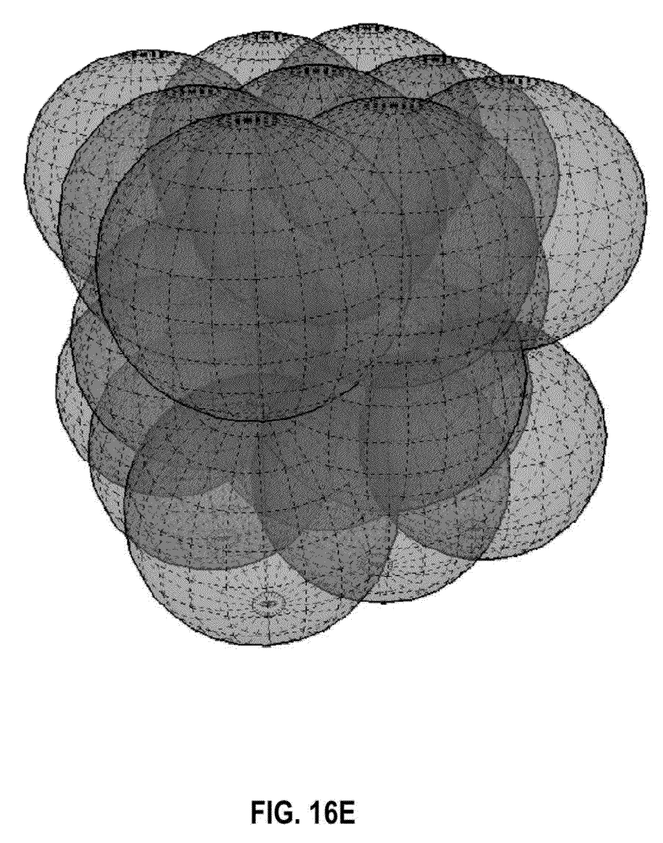

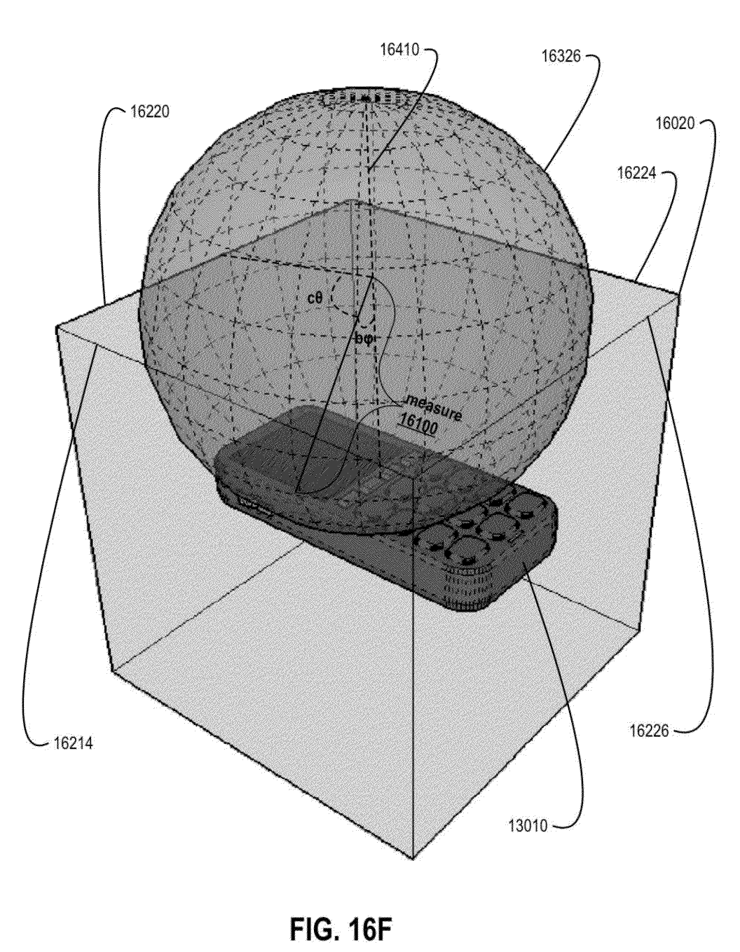

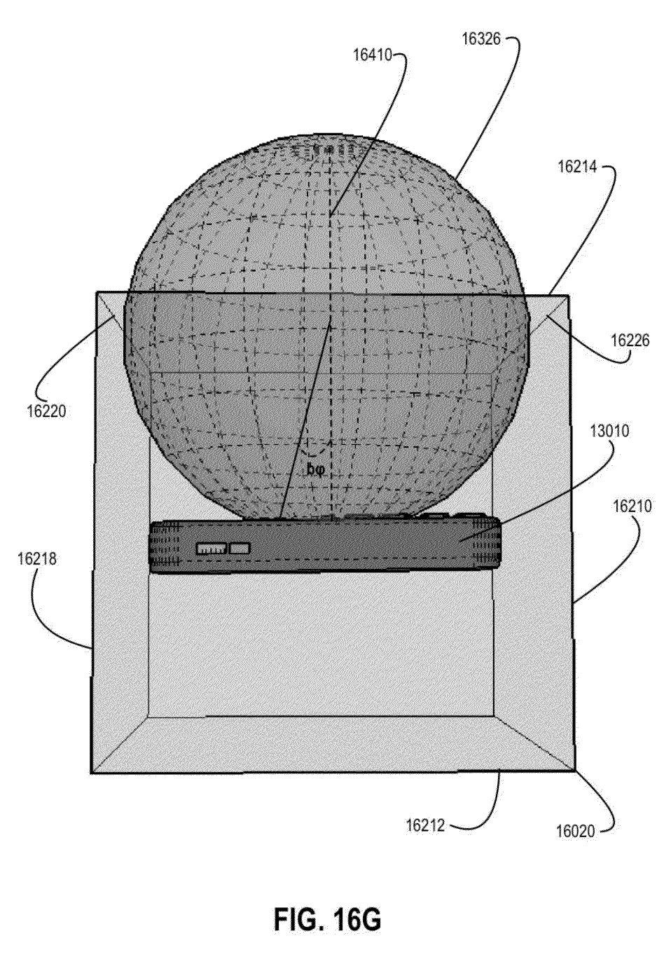

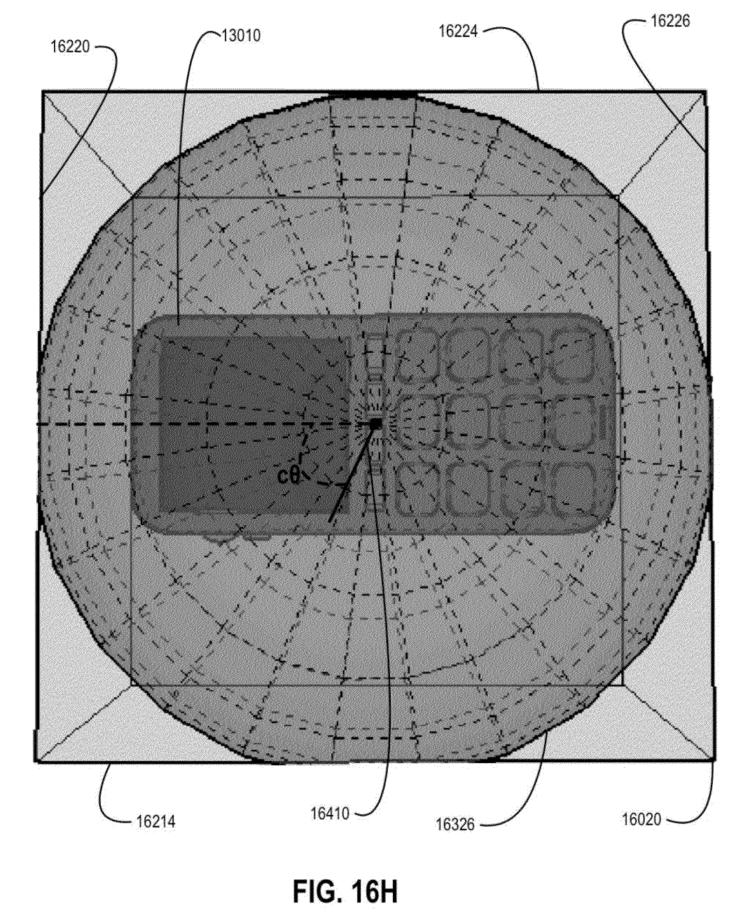

Turning now to FIG. 15, another method of transforming image data of a three-dimensional shape into meta data of the shape is illustrated, according to one or more embodiments. At 15010, a cube that encompasses a shape can be determined. For example, a cube 16020 can be determined to encompass shape 13010, as illustrated in FIG. 16A. In one or more embodiments, three centers of three spheres can lie on each of cube edges 16210-16232, and a diameter of the three spheres lying on an edge of cube 16020 can be equal to a size of an edge.

For example, centers of spheres 16310-16314 can lie on edge 16224, as illustrated in FIG. 16B. As shown, center of sphere 16312 can lie on edge 16224, and sphere 16312 can be tangent to edges 16228 and 16222. As illustrated, center of sphere 16310 can lie at an intersection of edges 16224-13228, and center of sphere 16314 can lie at an intersection of edges 16220-13224. In this fashion, three spheres, with a diameter of an edge of cube 16020, can lie on an edge of cube 16020.

As illustrated in FIG. 16C, spheres 16310-16314 can lie on edge 16224, spheres 16314-16318 can lie on edge 16220, and spheres 16318-16322 can lie on edge 16214. In one or more embodiments, a center of a sphere can lie on a face of cube 16020, and the sphere can be tangent to edges of cube 16020 that bound the face of cube 16020. For example, a center of a sphere 16326 can lie on a face 16112 of cube 16020, and sphere 16326 can be tangent to edges 16222, 16224, 16228, and 16230, as illustrated in FIG. 16D. In one or more embodiments, centers of respective spheres can lie on respective faces of cube 16020, where each sphere can be tangent to edges of cube 16020 that bound the respective face of cube 16020, and centers of three spheres can lie on each edge of cube 16020. For example, this is illustrated in FIG. 16E.

Referring again to FIG. 15, an angle of a radius of a sphere, with reference to an axis of the sphere, can be determined at 15020. In one or more embodiments, the angle of the radius of the sphere with reference to its axis can include a number (e.g., an integral number, a floating point number, etc.) multiplied by a number phi. As illustrated in FIG. 16F, for example, the angle of the radius of the sphere with reference to its axis 16410 can include a number “b” multiplied by phi or bφ. In one or more embodiments, b can be variable over a first set of numbers such that 0≦bφ≦90 degrees (or π/2 radians). In one example, the first set of numbers can include {1, 2, 3, . . . , m}, where m can be an integer. In another example, the first set of numbers can include {1.0, 1.1, 1.2, 1.3, . . . , 2.0, 2.1, . . . , m}, where m can be a floating point number. FIG. 16G illustrates the angle of the radius of the sphere with reference its axis 16410, from a different perspective.

At 15030, an angle of the radius of the sphere with reference to an edge of cube 16020 can be determined. In one or more embodiments, an angle of a radius of a sphere with reference to a tangent edge of a cube can include a number multiplied by a number theta. As illustrated in FIG. 16F, for example, sphere 16326 can be tangent to edge 16220 of cube 16020, and the angle of the radius of the sphere with reference to edge 16220 can include a number “c” multiplied by theta or cθ. For instance, cθ is in a plane that includes and/or is formed by at least two of edges 16214, 16220, 16224, and 16226.

FIG. 16H illustrates the angle of the radius of the sphere with reference to tangent edge 16220, from a different perspective. In one or more embodiments, c can be variable over a second set of numbers such that 0≦cθ≦360 degrees (or 2π radians). In one example, the second set of numbers can include {1, 2, 3, . . . , n}, where n can be an integer. In another example, the second set of numbers can include {1.0, 1.1, 1.2, 1.3, . . . , 2.0, 2.1, . . . , n}, where n can be a floating point number.

In one or more embodiments, a sphere can lie on an edge of a cube. In one example, a sphere can lie on an edge of the cube and be tangent to four edges of the cube. For instance, c can be variable over a second set of numbers such that 0≦cθ≦180 degrees (or π radians). In another example, a sphere can lie on three edges of the cube. For instance, c can be variable over a second set of numbers such that 0≦cθ≦90 degrees (or π/2 radians).

At 15040, it can be determined if there is an intersection of the radius of the sphere and the shape. For example, it can be determined if there is an intersection of radius 16410 of sphere 16326 and shape 13010. If there is not an intersection of the radius of the sphere and the shape, data associated with no intersection can be stored at 15060. For example, a number zero can be stored to indicate that there is no intersection of the radius of the sphere and the shape. If there is an intersection of the radius of the sphere and the shape, data associated with the intersection can be stored at 15050. For example, there is an intersection of radius 16410 of sphere 16326 and shape 13010 is illustrated in FIG. 16F.

In one or more embodiments, the data associated with the intersection can include a measure, according to some metric, from a center of the sphere to the intersection of the radius of the sphere and the shape. In one example, the measure can include a floating-point number. In a second example, the measure can include an integral number. For instance, a measure 16100, as shown in FIG. 16F, can be stored. In one or more embodiments, shape 13010 can be considered a solid object, where an intersection of the radius of the sphere and the solid object, determined with reference to the method of FIG. 15, is a minimum measure of any intersection of the radius (of the sphere), at the angle with reference to the axis of the sphere (e.g., at a first angle) and at the angle with reference to the tangent edge of the cube (e.g., at a second angle), and the solid object.

At 15070, it can be determined if there is another angle of the radius of the sphere, with reference to the tangent edge of the cube, to process. If there is another angle of the radius of the sphere, with reference to the tangent edge of the cube, to process, a next number in the second set of numbers can be utilized at 15080. If there is not another angle of the radius of the sphere, with reference to the tangent edge of the cube, to process, it can be determined if there is another angle of the radius of the sphere with reference the its axis to process at 15090. If there is another angle of the radius of the sphere, with reference to its axis, to process, a next number in the first set of numbers can be utilized at 15100. If there is not another angle of the radius of the sphere, with reference to its axis, to process, another sphere to be processed can be determined at 15110. In one or more embodiments, the method can proceed to 15020.

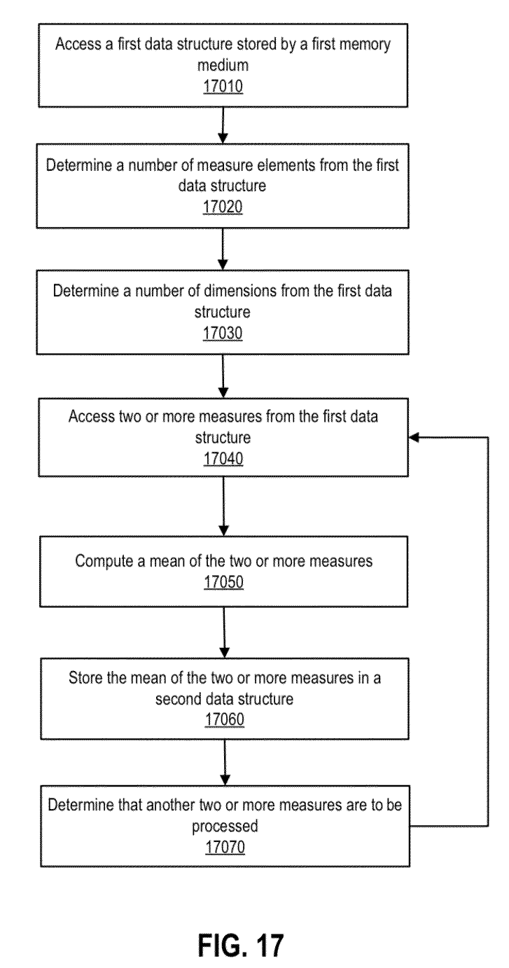

Turning now to FIG. 17, a method of reducing data associated with a shape is illustrated, according to one or more embodiments. At 17010, a first data structure that is stored by a first memory medium can be accessed. At 17020, a number of measure elements can be determined from the first data structure. In one example, a measure element can include measure 11210. In second example, a measure element can include measure 11220. In a third example, a measure element can include measure 14100. In another example, a measure element can include measure 16100.

At 17030, a number of dimensions can be determined from the first data structure. In one example, the number of dimensions can be one. For instance, the measure elements can be measure elements from circle 10010, where each measure element corresponds to an angle b0, where b can be an element of a set of numbers. In another example, the number of dimensions can be two. For instance, the measure elements can be measure elements from sphere 16326, where each measure element corresponds to a first angle by) and a second angle cθ, where b can be an element of a first set of numbers and c can be an element of a second set of numbers.

At 17040, two or more measure elements, from the first data structure, can be accessed. In one or more embodiments, accessing the two or more measure elements can include accessing the first memory medium via the data structure. For example, the data structure can provide an addressing scheme, method, and/or process to retrieve data from the first memory medium.

In one or more embodiments, the data structure can store vectors associated with respective circles or matrices associated with respective spheres that cover a shape. In one example, the data structure can store vectors associated with respective circles 10010-10080 that cover shape 10110. In another example, the data structure can store matrices associated with respective spheres 13310-13344 that cover shape 13010.

In one or more embodiments, the two or more measure elements can be adjacent elements. In one example, the measure elements can include (a₁, a₂, a₃, . . . , aₘ) for some integer m, where aᵢ includes a measure associated with circle 10010. In one instance, measure elements a₁ and a₂ can be adjacent. In a second instance, measure elements a₂ and a₃ can be adjacent. In a third instance, measure elements aₘ₋₁ and aₘ can be adjacent. In fourth instance, measure elements a₁, a₂, and a₃ can be adjacent. In a fifth instance, measure elements a₂, a₃, and a₄ can be adjacent. In another instance, measure elements aₘ₋₂, aₘ₋₁, aₘ can be adjacent.

In another example, the measure elements can include

$$( \begin{matrix}{d}_{11} & K & {d}_{1 n} \\ M & O & M \\ {d}_{m 1} & L & {d}_{mn}\end{matrix} )$$

for some integers m and n, where dᵢⱼ includes a measure associated with sphere 16326. In one instance, measure elements d₁₁ and d₂₁ can be adjacent. In a second instance, measure elements d₁₁ and d₁₂ can be adjacent. In a third instance, measure elements d₁₁ and d₂₂ can be adjacent. In a fourth instance, measure elements d₁₁, d₂₁, and d₃₁ can be adjacent. In a fifth instance, measure elements d₁₁, d₁₂, and d₁₃ can be adjacent. In a sixth instance, measure elements d₁₁, d₂₂, and d₃₃ can be adjacent.

At 17050, a mean of the two or more measures can be computed. In one or more embodiments, the mean can include at least one of an arithmetic mean, a geometric mean, a harmonic mean, a quadratic mean (or a root-mean square mean), and a generalized mean, among others. At 17060, the mean of the two or more measures can be stored in a second data structure. In one example, the second data structure can be stored in the first memory medium. In another example, the second data structure can be stored in a second memory medium. In one or more embodiments, it can be determined that another two or more measures, from the first data structure, are to be processed at 17070. The method can proceed to 17040, according to one or more embodiments.

In one or more embodiments, the method illustrated in FIG. 17 can be applied to each circle or sphere that is utilized to cover a shape. In one example, the method illustrated in FIG. 17 can be applied to each of circles 10010-10080. In a second example, the method illustrated in FIG. 17 can be applied to each of the spheres illustrated in FIG. 16E.

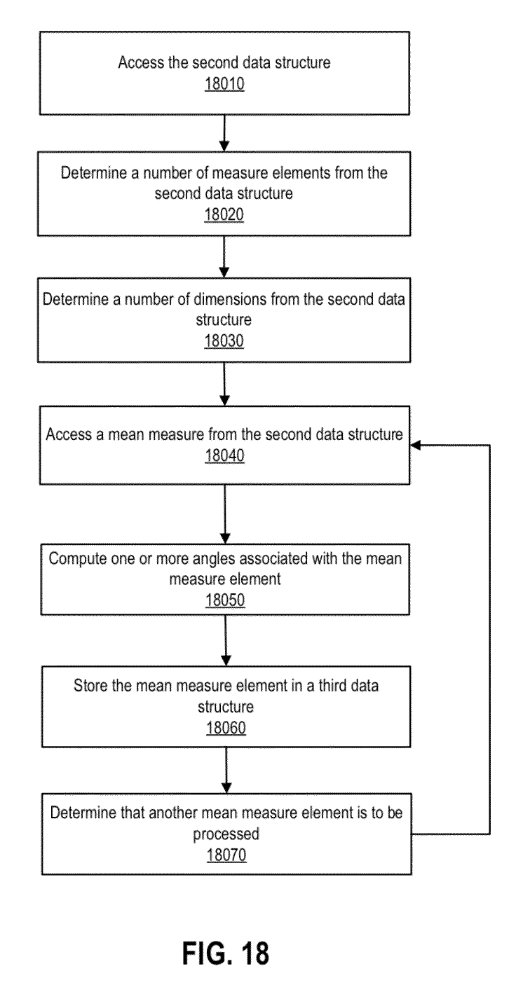

Turning now to FIG. 18, a method of producing a shape from reduced data associated with the shape is illustrated, according to one or more embodiments. At 18010, the second data structure can be accessed. For instance, the second data structure is associated with the method illustrated in FIG. 17. At 18020, a number of measure elements can be determined from the second data structure. At 18030, a number of dimensions can be determined from the second data structure. At 18040, a mean measure element of the second data structure can be accessed.

At 18050, one or more angles associated with the mean measure element can be computed. In one example, an angle bθ/2 can be computed for a mean measure associated with adjacent measure elements a₁ and a₂. In a second example, an angle cθ/2 can be computed for a mean measure associated with adjacent measure elements d₁₁ and d₁₂. In another example, an angle bφ/2 can be computed for a mean measure associated with adjacent measure elements d₁₁ and d₂₁.

At 18060, the mean measure element can be stored with coordinates associated with the one or more angles can be stored in a third data structure. In one or more embodiments, the third data structure can include a graphics file. In one example, the graphics file can include one or more of a joint photographic experts group (JPEG) format, a portable network graphics (PNG) format, a tagged image file format (TIFF), an exchangeable image file format (EXIF), a RAW format, a bitmap (BMP) format, a graphic interchange format (GIF), and a vector file format, among others. In another example, the graphics file can include one or more of a drawing interchange format, a drawing exchange format, a DWG format, a Windows metafile format, a Hewlett-Packard graphics language format, a RenderMan format, a RenderMan interface bytestream format, and a virtual reality modeling language format, among others.

In one or more embodiments, it can be determined that another measure, from the second data structure, is to be processed at 18070. The method can proceed to 18040, according to one or more embodiments.

In one or more embodiments, the methods illustrated in FIGS. 17 and 18 can be applied to each circle or sphere that is utilized to cover a shape. In one example, the methods illustrated in FIGS. 17 and 18 can be applied to each of circles 10010-10080. In a second example, the methods illustrated in FIGS. 17 and 18 can be applied to each of the spheres illustrated in FIG. 16E.

In one or more embodiments, a metric can include units of a coordinate system. In one example, the coordinate system can include a Cartesian coordinate system. For instance, units of the Cartesian coordinate system can include inches, feet, meters, centimeters, millimeters, etc. In one example, the coordinate system can include a spherical coordinate system. For instance, first units of the coordinate system can include radians for measures of phi and theta, and second units of the coordinate system can include inches, feet, meters, centimeters, millimeters, etc. for rho.

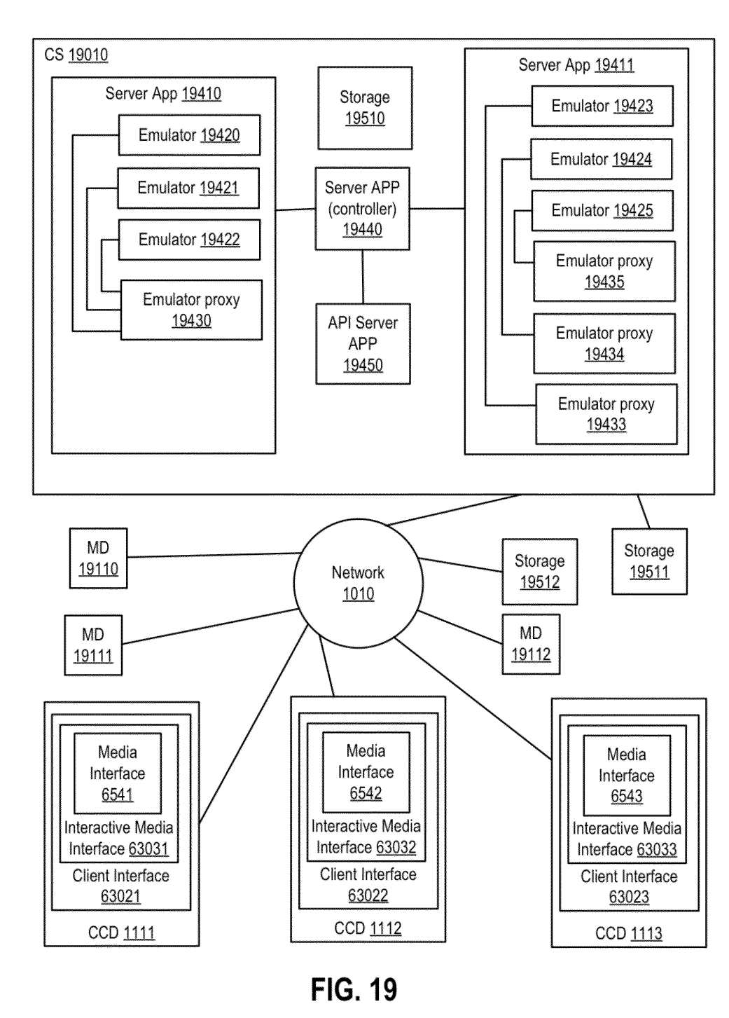

Turning now to FIG. 19, a network system that supports storage of data and configurations of physical devices and emulation of the physical devices is illustrated, according to one or more embodiments. As shown, one or more of CCDs 1111-1113 and/or mobile devices (MDs) 19110-19112 can be coupled to computer system (CS) 19010 via network 1010. In one or more embodiments, CS 19010 can include one or more structures and/or functionalities described with reference to media server 1211, and server app 19410, server APP 19411, server APP 19440, and API server APP 19450 can include one or more structures and/or functionalities described with reference to server app 6410, server APP 6411, server APP 6440, and API server APP 6450, respectively.

As illustrated, CS 19010 can include a storage 19610, can be coupled to a storage 19611, and/or can be coupled to a storage 19612 via network 1010. In one or more embodiments, one or more of storages 19610-19622 can include non-volatile storage and/or memory that can store configurations and/or data of one or more of MDs 19110-19112. In one or more embodiments, CS 19010 and/or storages 19610-19622 can provide and/or implement one or more system for synchronizing and/or storing preferences, configuration(s), installed applications of a physical mobile device (MD) in a system independent format (e.g., the system can be used for multiple OS types and/or multiple platform types).

In one example, one or more granular levels (e.g., storing and/or retrieving data for recovery may not require that a recovered system synchronize its data, information, and/or configuration with CS 19010 and/or storages 19610-19622) of data (e.g. data such as applications, contact list(s), photos, videos, ring tone(s), sound preference(s), etc.) can be stored and/or retrieved. For instance, an API can be provided and/or made available that can be utilized in storing and retrieving associated information and/or data of and/or associated with one or more physical mobile devices. In another example, multiple devices can be configured and/or recovered from CS 19010 and/or storages 19610-19622. In one instance, each of the multiple devices can be configured and/or recovered with respective associated data and/or configuration(s).

In another instance, multiple devices can be configured and/or recovered from CS 19010 and/or storages 19610-19622. For example, each of the multiple devices can be configured and/or recovered with same data and/or configuration(s). For instance, a company can issue multiple wireless telephones to a sales group, and each of the multiple wireless telephones can be configured with one or more of a contact list, sales presentations, and smart phone applications, among others, for the sales group.

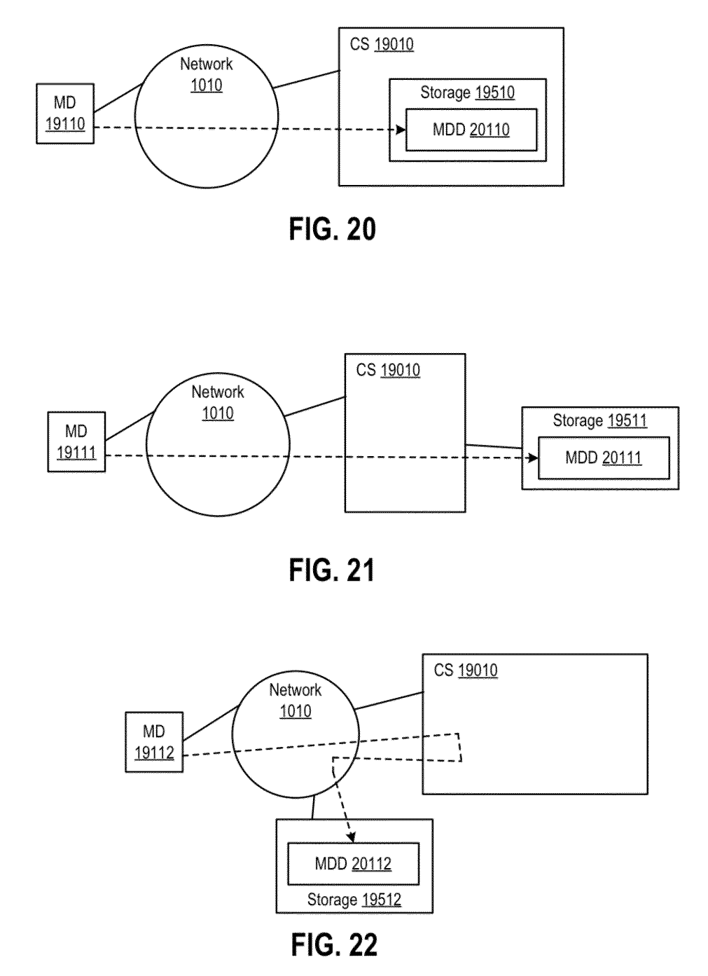

Turning now to FIGS. 20-22, network systems that supports storage of data and configurations of physical mobile devices are illustrated, according to one or more embodiments. As shown in FIG. 20, mobile device data (MDD) 20110 associated with MD 19110 can be stored via storage 19510 that can be included in CS 19010. In one or more embodiments, MDD can include data and/or configuration data associated with a MD. In one example, the MDD can include one or more sound recordings (e.g., MP3 songs, musical pieces, voice memos, conversations, lectures, etc.), one or more contacts (e.g., contact information associated with people, places, companies, etc.), one or more bookmarks (e.g., web browser book marks), one or more ebooks, one or more social networking sites' respective information (e.g., Facebook information, Twitter information, MySpace information, Foursquare information, Last.fm information, Google+ information, etc.) associated with a user of the MD, one or more mobile device apps (e.g., smart phone apps, tablet computer apps, music player apps, etc.), and/or one or more configurations of the MD associated with the MDD, among others. As illustrated, in FIG. 21, MDD 20111 associated with MD 19111 can be stored via storage 19511 that can be coupled to CS 19010. As shown in FIG. 22, MDD 20111 associated with MD 19112 can be stored via storage 19512 that can be coupled to network 1010.

In one or more embodiments, a MD can include executable instructions (e.g., an application, a utility, an operating system, a portion of an operating system, etc.) that, when the executable instructions are executed by a processor of the MD, the MD can synchronize, backup, restore, and/or initialize MDD associated with the MD. In one example, the MD can synchronize and/or backup MDD associated with the MD via a wired or wireless coupling to a local system (e.g., a local computer system, a personal computer, a laptop computer system, a local office computer system, etc.) and/or via network 1010 to a remote system such as CS 19010 and/or storages 19510-19512, a distributed computer system, and/or a cloud-based system. In one example, the MD can incrementally synchronize changes in the MDD. For instance, one or more synchronization updates can utilize one or more portions of the MDD and/or may not require a full and/or complete duplication of the MDD.

In one or more embodiments, the MDD can include information associated with one or more states of the MD associated with the MD. In one example, the MD can receive the MDD from CS 19010 and restore the MD to one or more states, based on the MDD. In another example, the MD can receive the MDD from CS 19010 and can perform a “fresh” install, even if the MDD indicates a particular state or if the MD is in a particular state. In one or more embodiments, the MD can receive user input that indicates one or more selected items to restore which can be in addition to what is present and/or to overwrite existing properties/data.

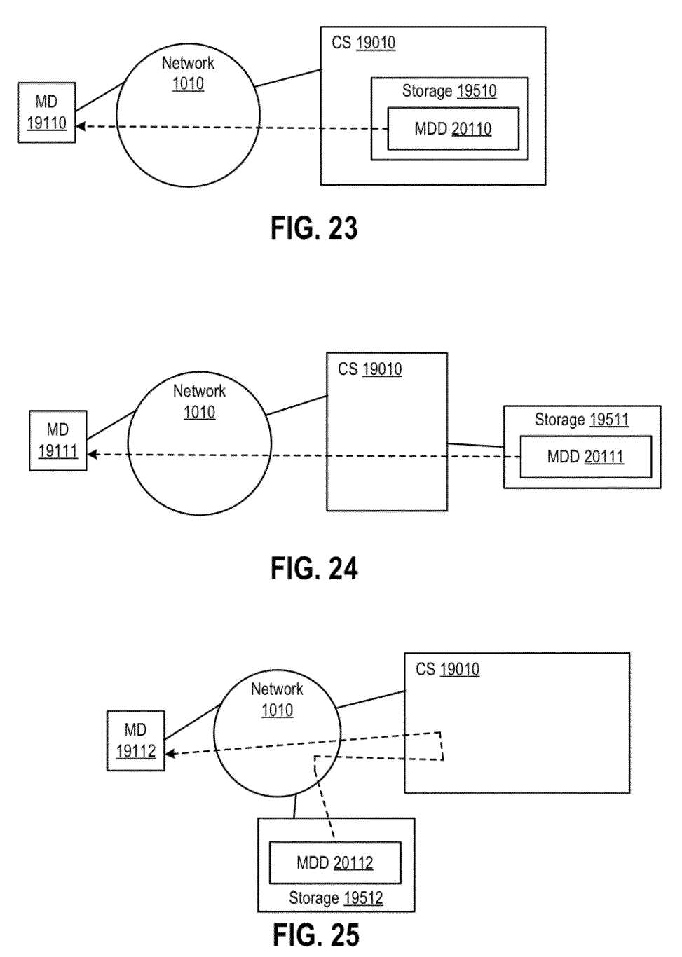

Turning now to FIGS. 23-25, network systems that supports recovery and/or restoration of data and configurations of physical mobile devices are illustrated, according to one or more embodiments. As shown in FIG. 23, MDD 20110 can be restored to MD 19110. As illustrated in FIG. 24, MDD 20111 can be restored to MD 19111. As shown in FIG. 25, MDD 20112 can be restored to MD 19112.

In one or more embodiments, recovery and/or restoration of MDD associated with a first MD or recovery and/or restoration of one or more portions of the MDD associated with the first MD can be utilized with the first MD or can be utilized with a second MD, different from the first MD. In one example, the first MD can be physically different from the second MD. For instance, the first MD can include a first processor, a first memory, and a first integrated circuit; the second MD a second processor, a second memory, and a second integrated circuit; and at least one of the first processor, the first memory, and the first integrated circuit can be different from a respective one of the second processor, the second memory, and the second integrated circuit.

In another example, the first MD can execute an operating system and/or platform different from the second MD. For instance, the first MD can execute a first operating system and/or a first platform, and the second MD can execute a second operating system and/or a second platform, where at least one of the first operating system and the first platform can be different from a respective one of the second operating system and the second platform. In one or more embodiments, this can allow recovery and/or restoration of MDD onto the second MD that did not perform backup and/or synchronization methods and/or processes.

In one or more embodiments, one or more portions of the MDD may not be applicable to the second MD. For example, the first MD can execute an Android operating system and/or platform, the second MD can execute Windows Mobile operating system and/or platform, and one or more applications (e.g., smart phone apps) may not be applicable to the second MD.

In one or more embodiments, one or more portions of the MDD (synchronized and/or backed up via the first MD) can be transformed, altered, converted, translated, adapted, adjusted, changed, modified, and/or adapted, among others, such that the one or more portions of the MDD can be utilized by the second MD. For example, a contact list can be included in the MDD, the contact list can be stored and/or indexed in a format that is associated with an Android operating system and/or platform, and the contact list can be transformed, altered, converted, translated, adapted, adjusted, changed, modified, and/or adapted, among others, such that the Windows Mobile operating system and/or platform of the second MD can utilize information from the contact list.

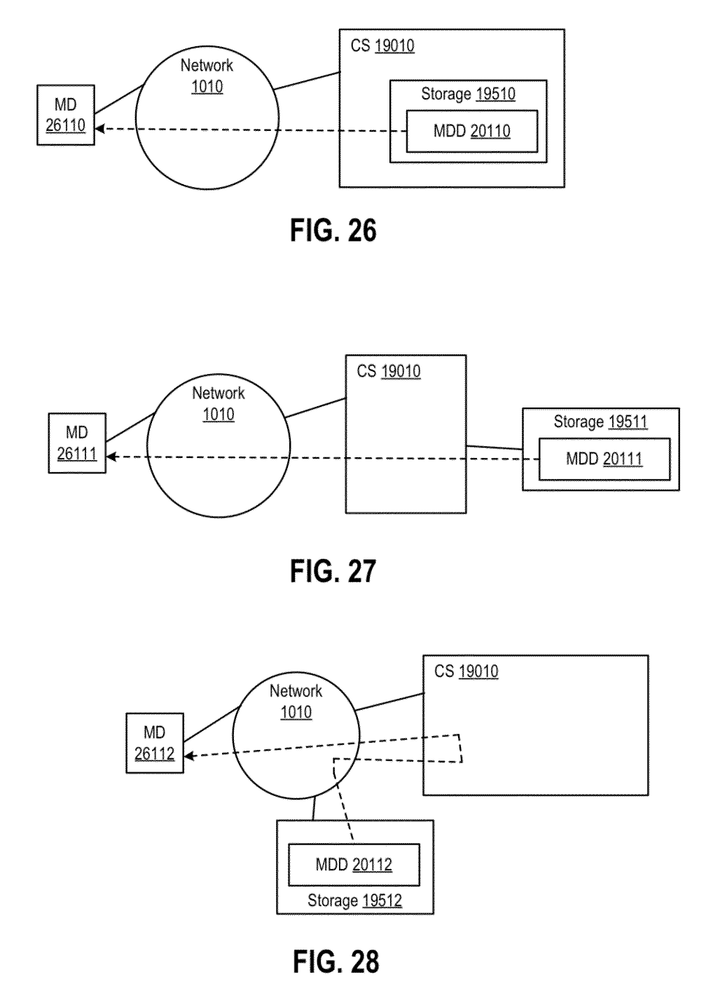

Turning now to FIGS. 26-28, network systems that supports recovery and/or restoration of data and configurations of physical mobile devices are illustrated, according to one or more embodiments. As shown in FIG. 26, MDD 20110 or one or more portions of MDD 20110 can be restored to a MD 26110. As illustrated in FIG. 27, MDD 20111 or one or more portions of MDD 20111 can be restored to a MD 26111. As shown in FIG. 28, MDD 20112 or one or more portions of MDD 20112 can be restored to MD 26112.

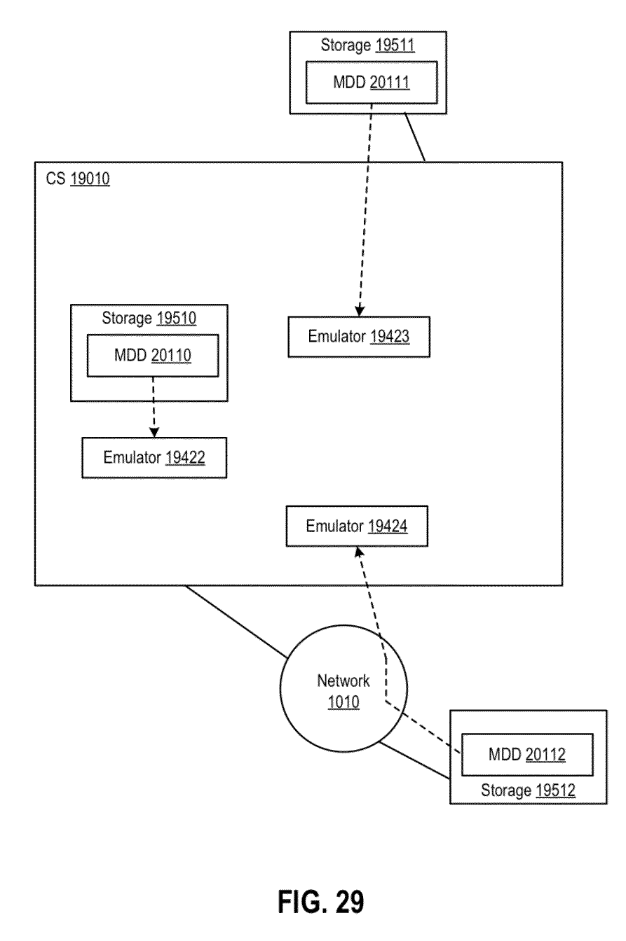

Turning now to FIG. 29, a network system that supports installation of data and configurations of one or more physical mobile devices to one or more respective emulators is illustrated, according to one or more embodiments. In one or more embodiments, one or more emulators can emulate one or more physical mobile devices. In one example, emulator 19422 can emulate MD 19110, emulator 19423 can emulate MD 19111, and/or emulator 19424 can emulate MD 19112. As shown, MDD 20110 can be copied and/or transferred to emulator 19422. In another example, emulator 19422 can emulate MD 26110, emulator 19423 can emulate MD 26111, and/or emulator 19424 can emulate MD 26112. As shown, MDD 20110 or one or more portions of MD 20110 can be copied and/or transferred to emulator 19422; MDD 20111 or one or more portions of MD 20111 can be copied and/or transferred to emulator 19423; and MDD 20112 or one or more portions of MD 20112 can be copied and/or transferred to emulator 19424.

In one or more embodiments, one or more portions of MDD can be copied and/or transferred to an emulator when a method and/or process of and/or associated with the emulator requests the one or more portions of the MDD. In one example, one or more portions of MDD 20110 can be copied and/or transferred to emulator 19422 when a method and/or process of and/or associated with emulator 19422 requests the one or more portions of MDD 20110. In a second example, one or more portions of MDD 20111 can be copied and/or transferred to emulator 19423 when a method and/or process of and/or associated with emulator 19423 requests the one or more portions of MDD 20111. In another example, one or more portions of MDD 20112 can be copied and/or transferred to emulator 19424 when a method and/or process of and/or associated with emulator 19424 requests the one or more portions of MDD 20112.

In one or more embodiments, the MDD or one or more portions of MDD can be transformed, altered, converted, translated, adapted, adjusted, changed, modified, and/or adapted, among others, and transferred to an emulator when a method and/or process of and/or associated with the emulator requests the MDD or the one or more portions of the MDD. In one example, MDD 20110 or one or more portions of MDD 20110 can be transformed, altered, converted, translated, adapted, adjusted, changed, modified, and/or adapted, among others, and transferred to emulator 19422 when a method and/or process of and/or associated with emulator 19422 requests the one or more portions of MDD 20110. In a second example, MDD 20111 or one or more portions of MDD 20111 can be transformed, altered, converted, translated, adapted, adjusted, changed, modified, and/or adapted, among others, and transferred to emulator 19423 when a method and/or process of and/or associated with emulator 19423 requests the one or more portions of MDD 20111. In another example, MDD 20112 or one or more portions of MDD 20112 can be transformed, altered, converted, translated, adapted, adjusted, changed, modified, and/or adapted, among others, and transferred to emulator 19424 when a method and/or process of and/or associated with emulator 19424 requests the one or more portions of MDD 20112. In one or more embodiments, transferring data to an emulator (e.g., an emulator of emulators 19422-19423) can include providing availability of and/or access to the data by the emulator.

In one or more embodiments, an emulator can include executable instructions (e.g., an application, a utility, an operating system, a portion of an operating system, etc.), that when the executable instructions are executed by an emulated processor of the emulator, the emulator can synchronize, backup, restore, and/or initialize MDD associated with an associated MD. In one example, the emulator can initiate synchronization of one or more settings, one or more configurations, and/or information from the MDD. In a second example, the emulator can initiate synchronization of one or more settings, one or more configurations, and/or information from the MDD, where the MDD is associated with a MD that includes and/or executes a first operating and/or a first platform than a second, different, operating system and/or a second, different, platform. For instance, one or more portions of the MDD can be transformed, altered, converted, translated, adapted, adjusted, changed, modified, and/or adapted, among others, and transferred to the emulator when a method and/or process of and/or associated with the emulator requests the one or more portions of the MDD associated with the MD. In one or more embodiments, one or more modifications to the MDD and/or a base image of the emulator can be stored. For example, the one or more modifications can be stored temporarily and erased and/or discarded after the emulator is terminated and/or concludes operations.

In one or more embodiments, a determination of what information associated with the MDD to restore and/or to initialize the emulator can be made. In one example, the determination can include a full restoration of the MDD to the emulator. In another example, the determination can include a restoration of one or more portions of the MDD to the emulator. In one or more embodiments, the determination can be based on user input and/or one or more user preferences and/or configurations.

In one or more embodiments, the determination can be based on one or more attributes associated with the emulator and/or one or more attributes associated with the MD. In one example, the determination can be based on one or more similarities between or among the one or more attributes associated with the emulator and the one or more attributes associated with the MD. In another example, the determination can be based on one or more differences between or among the one or more attributes associated with the emulator and the one or more attributes associated with the MD.

In one or more embodiments, the one or attributes associated with the emulator can include one or more of an operating system, a platform, an emulated processor, an emulated memory, an emulated integrated circuit, an emulated GPU, an emulated WiFi device (e.g., an emulated WiFi interface), an emulated WiMAX device (e.g., an emulated WiMAX interface), an emulated GPS device, an emulated GSM device (e.g., an emulated GSM interface), an emulated CDMA device (e.g., an emulated CDMA interface), an emulated satellite telephone network interface, an emulated Bluetooth device (e.g., an emulated Bluetooth interface), an emulated ZigBEE device (e.g., an emulated ZigBEE interface), an emulated GPS device, an emulated Ethernet device (e.g., an emulated Ethernet interface), an emulated proximity sensing device, an emulated magnetometer, an emulated accelerometer, an emulated pressure transducer, an emulated humidity sensing device, an emulated capacitive sensing touch device, an emulated resistive sensing touch device, an emulated electronic gyroscope, an emulated gas sensing device, an emulated image sensing device (e.g., an emulated digital camera), an emulated sound output device, an emulated sound sensing device (e.g., an emulated microphone), an emulated digital compass device, an emulated temperature sensing device, an emulated FM radio receiving device, an emulated FM radio transmitting device, an emulated light sensing device, an emulated RFID sensing device, an emulated RFID transmitting device, an emulated NFC device, and an emulated range determining device, among others.

In one or more embodiments, the one or attributes associated with the MD can include one or more of an operating system, a platform, a processor, a memory, an integrated circuit, a GPU, a WiFi device (e.g., a WiFi interface), WiMAX device (e.g., a WiMAX interface), a GPS device, a GSM device (e.g., a GSM interface), a CDMA device (e.g., a CDMA interface), a satellite telephone network interface, a Bluetooth device (e.g., a Bluetooth interface), a ZigBEE device (e.g., a ZigBEE interface), a GPS device, an Ethernet device (e.g., an Ethernet interface), a proximity sensing device, a magnetometer, an accelerometer, a pressure transducer, a humidity sensing device, a capacitive sensing touch device, a resistive sensing touch device, an electronic gyroscope, a gas sensing device, an image sensing device (e.g., a digital camera), a sound output device, a sound sensing device (e.g., a microphone), a digital compass device, a temperature sensing device, a FM radio receiving device, a FM radio transmitting device, a light sensing device, a RFID sensing device, a RFID transmitting device, a NFC device, and a range determining device, among others.

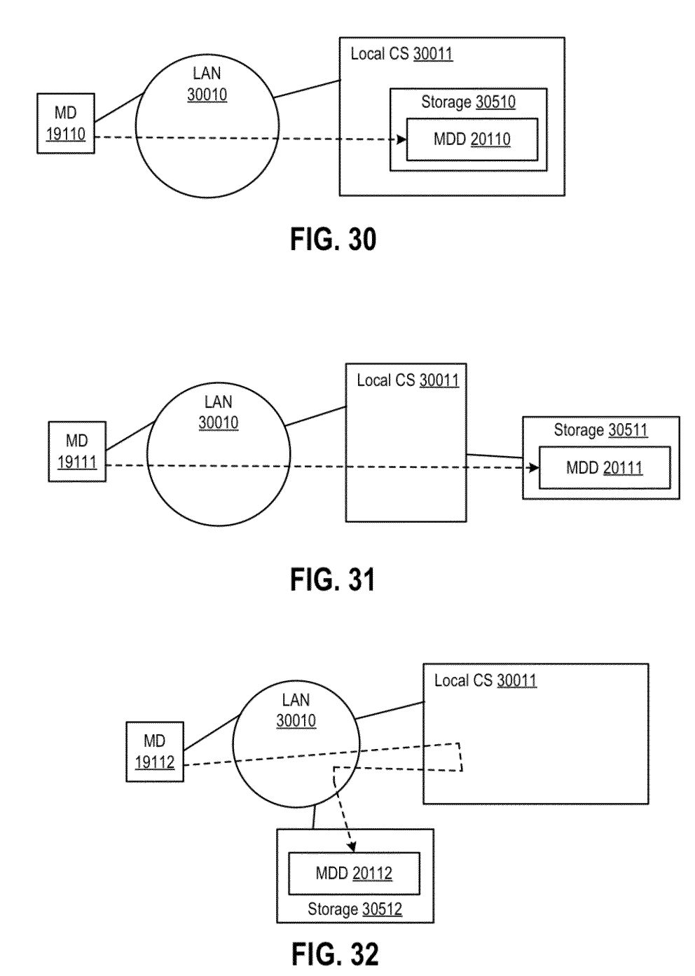

Turning now to FIGS. 30-32, local area network systems that supports storage of data and configurations of physical mobile devices are illustrated, according to one or more embodiments. As shown in FIG. 30, MDD 20110 associated with MD 19110 can be stored via storage 30510 that can be included in a local CS 30011. As illustrated, MD 19110 and local CS 30011 can be coupled to a local area network (LAN) 30010. In one or more embodiments, local CS 30011 can include one or more of a computer system, a server computer system, a laptop computer system, a notebook computing device, a portable computer, a network appliance, a television device, a DVD (digital video disc player) device, a Blu-Ray disc player device, a DVR (digital video recorder) device, or other wireless or wired device that includes a processor that executes instructions from a memory medium.

In one or more embodiments, LAN 30010 can include a wired network. In one example, LAN 30010 can include a wired network based on wired Ethernet. In another example, LAN 30010 can include a wired network based on wired Ethernet over one or more power lines. For instance, LAN 30010 can include a wired network based on one or more of IEEE 1901, IEEE1675, HomePNA, and HomePlug, among others. In one or more embodiments, LAN 30010 can include a wireless network. In one example, LAN 30010 can include a wireless network based on wireless Ethernet (e.g., based on IEEE 802.11). In a second example, LAN 30010 can include a wireless network based on Bluetooth (e.g., based on IEEE 802.15). In a third example, LAN 30010 can include a wireless network based on wireless USB. In another example, LAN 30010 can include a wireless network based on one or more of IEEE 802.15.4 and ZigBEE, among others.

As shown in FIG. 31, MDD 20111 associated with MD 19111 can be stored via storage 30511 that can be coupled to local CS 30011. As illustrated FIG. 32, MDD 20112 associated with MD 19112 can be stored via storage 30512 that can be coupled to LAN 30010.

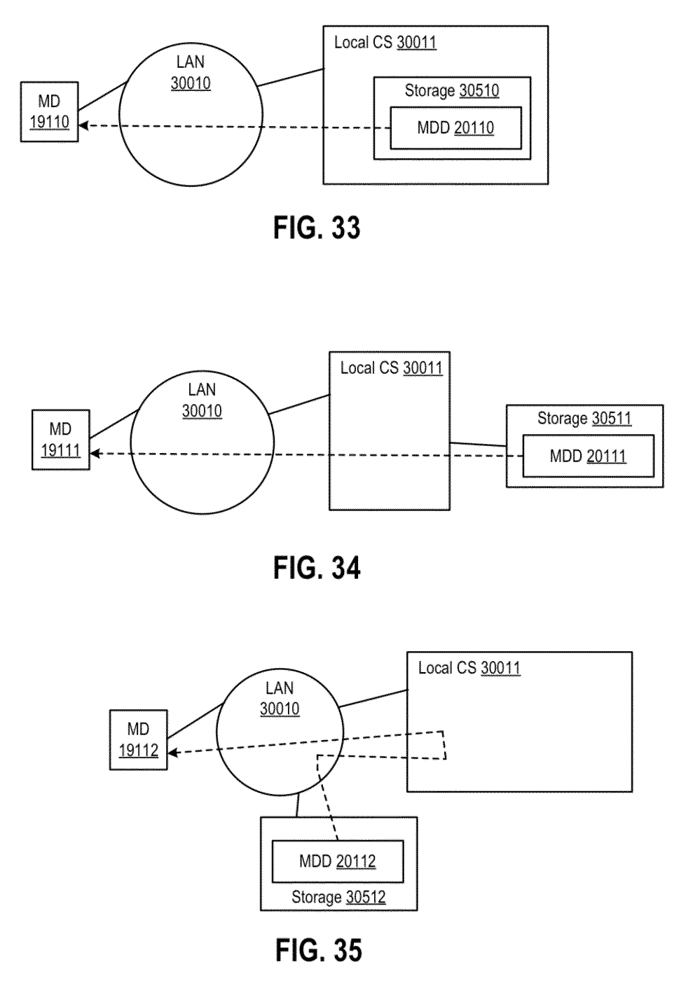

Turning now to FIGS. 33-35, local network systems that supports recovery and/or restoration of data and configurations of physical mobile devices are illustrated, according to one or more embodiments. As shown in FIG. 33, MDD 20110 can be restored to MD 19110. As illustrated in FIG. 34, MDD 20111 can be restored to MD 19111. As shown in FIG. 35, MDD 20112 can be restored to MD 19112.

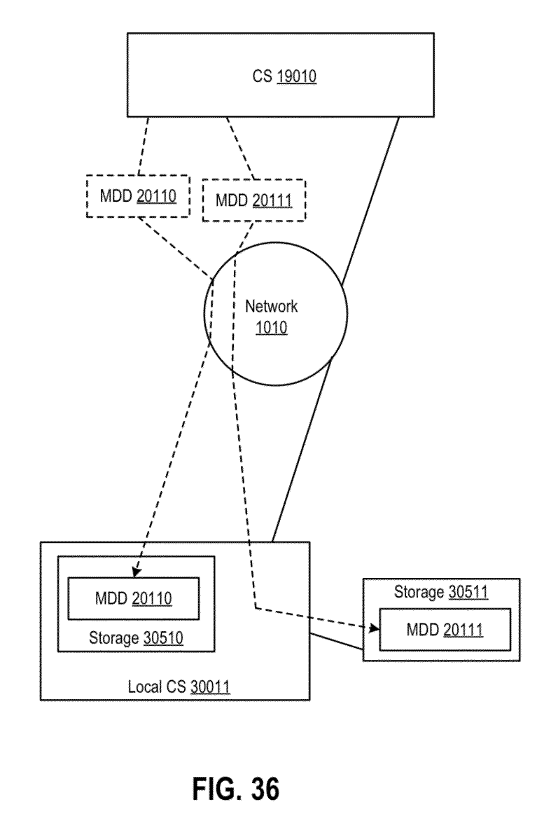

Turning now to FIG. 36, a network system that supports storage of data and configurations of physical mobile devices is illustrated, according to one or more embodiments. In one or more embodiments, MDD can be transferred, via a network, from a first computer system to a second computer system. As shown, local CS 30011 can be coupled to network 1010. As illustrated, MDD 20110 can be transferred, via network 1010, from CS 19010 to local CS 30011. As shown, MDD 20111 can be transferred, via network 1010, from CS 19010 to local CS 30011.

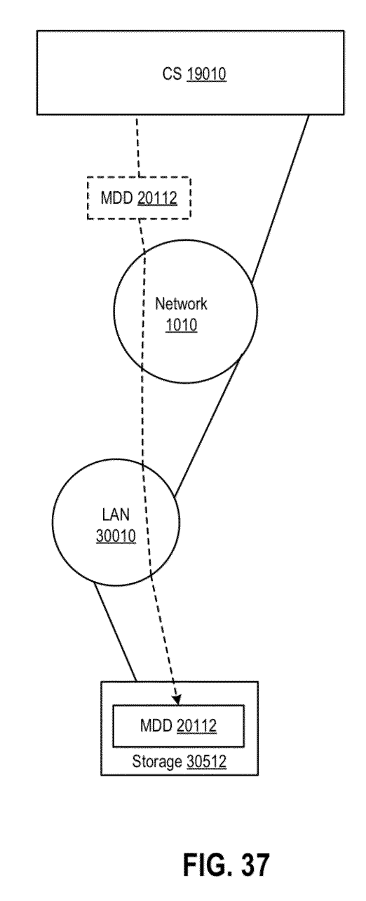

Turning now to FIG. 37, a network system that supports network storage of data and configurations of physical mobile devices is illustrated, according to one or more embodiments. As shown, LAN 30010 can be coupled to network 1010. In one or more embodiments, MDD can be transferred, via a first network, from a first computer system to storage coupled to a second network. As illustrated, MDD 20112 can be transferred, via network 1010 and LAN 30010, from CS 19010 to storage 30512.

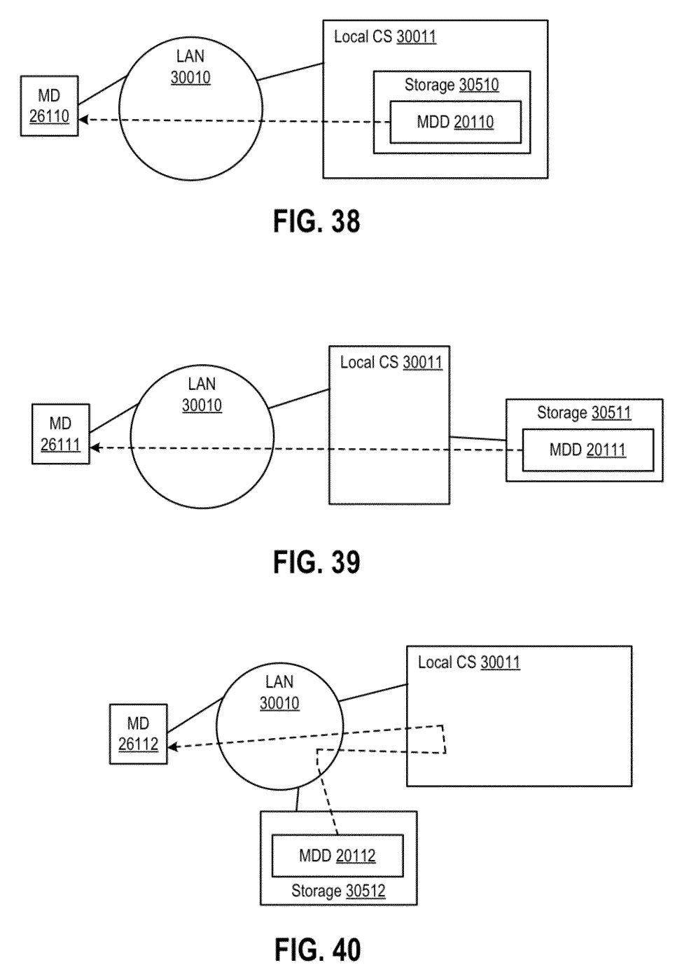

Turning now to FIGS. 38-40, local network systems that supports recovery and/or restoration of data and configurations of physical mobile devices are illustrated, according to one or more embodiments. As shown in FIG. 38, MDD 20110 or one or more portions of MDD 20110 can be restored to MD 26110. As illustrated in FIG. 39, MDD 20111 or one or more portions of MDD 20111 can be restored to MD 26111. As shown in FIG. 40, MDD 20112 or one or more portions of MDD 20112 can be restored to MD 26112.

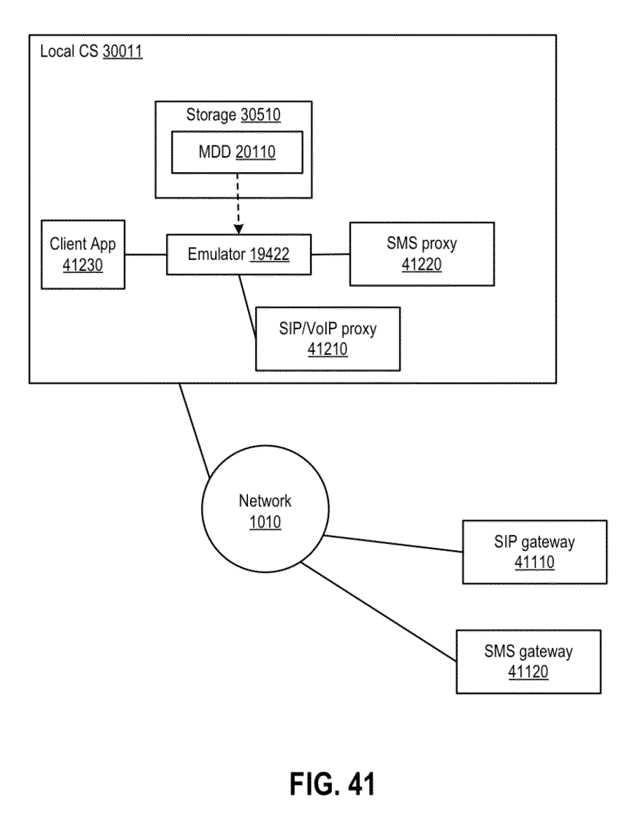

Turning now to FIG. 41, a local network system that supports installation of data and configurations and utilization of an emulator is illustrated, according to one or more embodiments. As illustrated, a session initiation protocol (SIP) gateway 41110 can be coupled to network 1010. In one or more embodiments, SIP can be utilized in controlling one or more communications sessions. For example, SIP can be utilized in controlling voice and/or video calls via a network protocol (e.g., an Internet protocol). For instance, SIP can be utilized in creating, modifying two or more party communication sessions. In one or more embodiments, the communications sessions can include one or more media streams.

As shown, a SMS gateway 41120 can be coupled to network 1010. In one or more embodiments, SMS gateway 41120 can include a telecommunications device and/or facility for sending and/or receiving SMS transmissions to and/or from a telecommunications network. As illustrated, local CS 30011 can include a SIP/VoIP proxy 41210 coupled to emulator 19422. In one or more embodiments, SIP/VoIP proxy 41210 and emulator 19422 can communicate via one or more processes and/or methods described herein. In one or more embodiments, VoIP and/or IP encapsulated SMS and/or multimedia messaging service (MMS) termination can be implemented and/or provided within emulator 19422. As shown, local CS 30011 can include a SMS proxy 41220 coupled to emulator 19422. In one or more embodiments, SIP/VoIP proxy 41210 and emulator 19422 can communicate via one or more processes and/or methods described herein.

In one or more embodiments, SIP gateway 41110 and SIP/VoIP proxy 41210 can communicate via network 1010. For example, SIP gateway 41110 can route telephone calls and/or video calls to and/or from SIP/VoIP proxy 41210. In one instance, SIP/VoIP proxy 41210 can receive can emulate one or more GSM and/or CDMA signals that can carry the telephone calls and/or video calls and can provide the signals that can carry the telephone calls and/or video calls to emulator 19422. In another instance, SIP/VoIP proxy 41210 can receive one or more GSM and/or CDMA emulated signals that can carry the telephone calls and/or video calls from emulator 19422 and can provide the telephone calls and/or video calls to SIP gateway 41110.

As illustrated, local CS 30011 can include a client app 41230 coupled to emulator 19422. For example, client app 41230 and emulator 19422 can communicate via one or more processes and/or methods described herein. In one or more embodiments, local CS 30011 can be or include CCD 1111, and client app 41230 can be or include client interface 63021. For example, a user of local CS 30011 can control and/or utilize emulator as a telephone via one or more of client interface 63021, interactive media interface, and media interface 6541. In one or more embodiments, one or more interactions with emulator 19422 can be conducted via a web browser interfacing with a web server of emulator 19422.

In one or more embodiments, if an incoming call or an incoming message occurs when the web browser that would interface with the web server of emulator 19422 is not executing or is not directed to the web server of emulator 19422, an alert can be provided to the user of local CS 30011. In one example, the alert can include a display notification that can open a window displayed via a display associated with local CS 30011. In another example, the alert can include one or more sounds. In one instance, the one or more sounds can include one or more sounds of a telephone ringing. In another instance, the one or more sounds can include one or more sounds of a message arriving.

In one or more embodiments, when emulator 19422 is not running or not executing, a telephone system associated with emulator 19422 and/or a physical MD associated with emulator 19422 can function as if the physical MD is turned off, is not functioning, and/or is not in communication with a Node B, a base transceiver station, or a satellite. For example, a VoIP, a SMS, and/or a MMS termination point for emulator 19422 can be terminated.

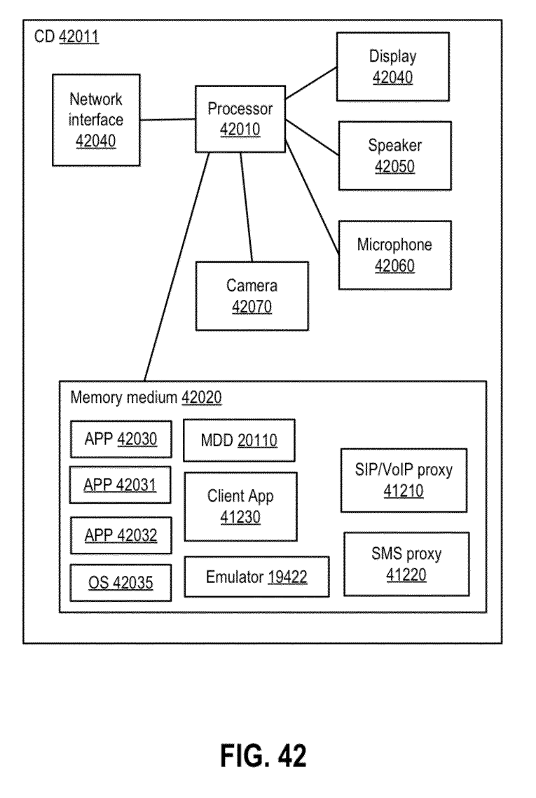

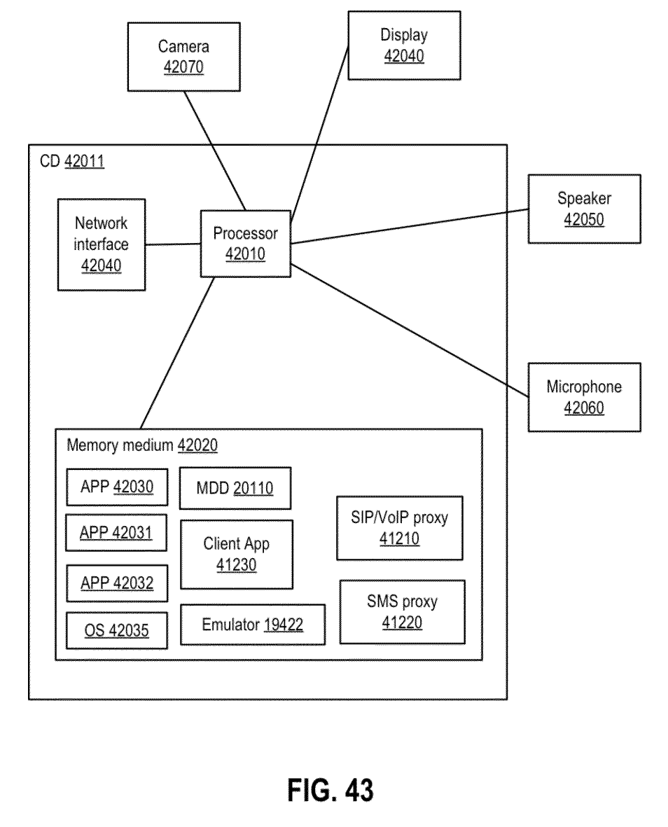

In one or more embodiments, local CS 30011 can include or be coupled to one or more of a camera, a display, a microphone, and a speaker. In one example, the microphone and the speaker associated with local CS 30011 can be utilized in one or more telephonic communications. In another example, the camera and the display associated with local CS 30011 can be utilized in one or more video communications. In one or more embodiments, local CS 30011 can include one or more structures and/or functionalities described with reference to computing device 420011 of FIG. 42 and/or of FIG. 43.

Turning now to FIG. 42, an exemplary computing device is illustrated, according to one or more embodiments. As shown, CD 42011 can include a processor 42010 coupled to a memory medium 42020. In one or more embodiments, memory medium 42020 can store data and/or instructions that can be executed by processor 42010. For example, memory medium 42020 can store one or more APPs 42030-42032, an OS 42035, MDD 20110, client app 41230, emulator 19422, SIP/VoIP proxy 41210, and/or SMS proxy 41220. For instance, one or more of APPs 42030-42032, OS 42035, client app 41230, emulator 19422, SIP/VoIP proxy 41210, and SMS proxy 41220 can include instructions of an ISA associated with processor 42010. In one or more embodiments, one or more of the processes and/or methods described here can be implemented when processor 42010 executes one or more of APPs 42030-42032, OS 42035, client app 41230, emulator 19422, SIP/VoIP proxy 41210, and SMS proxy 41220.

As illustrated, CD 42011 can include a display 42020 coupled to processor 42010. In one or more embodiments, display 42020 can be utilized to display one or more of graphics and/or videos to a user. As shown, CD 42011 can include a network interface 42040. In one example, network interface 2040 can interface with a wired network coupling, such as a wired Ethernet, a T-1, a DSL modem, a PSTN, or a cable modem, among others. In another example, network interface 42040 can interface with a wireless network coupling, such as a satellite telephone system, a cellular telephone system, WiMax, or wireless Ethernet, among others.

As shown, CD 42011 can include a speaker 42050 coupled to processor 42010. In one or more embodiments, speaker 42050 can output one or more sounds that can be received, aurally, by a user of CD 42011. In one or more embodiments, speaker 42050 can be coupled to processor 42010 via a digital to analog converter (DAC). For example, the DAC can receive digital signals from processor 42050 and transform the digital signals to analog signals.

As illustrated, CD 42011 can include a microphone 42060 coupled to processor 42010. In one or more embodiments, microphone 42060 can receive audio signals and can transform the audio signals into one or more voltage signals, one or more current signal, and/or one or more digital signals that can be utilized by processor 42010. For example, an analog to digital converter (ADC) can be utilized to transform the one or more voltage signals and/or the one or more current signal into the one or more digital signals that can be utilized by processor 42010. In one or more embodiments, the ADC can interpose processor 42010 and microphone 42060 such that microphone 42060 is coupled to processor 42010 via the ADC.

As shown, CD 42011 can include a camera 42070 coupled to processor 42010. In one or more embodiments, camera 42070 can include one or more image and/or light sensors that can transform received light signals into one or more digital signals that can be utilized by processor 42010. In one or more embodiments, CD 42011 can be coupled to and/or include one or more of a keyboard and a pointing device (e.g., a mouse, a track ball, a track pad, a stylus, etc.). In one or more embodiments, a touch screen can function as a pointing device. In one example, the touch screen can determine a position via one or more pressure sensors. In another example, the touch screen can determine a position via one or more capacitive sensors.

Turning now to FIG. 43, an exemplary computing device is illustrated, according to one or more embodiments. As illustrated, one or more of display 42040, speaker 42050, microphone 42060, and camera 42070 can be coupled to CD 42011.

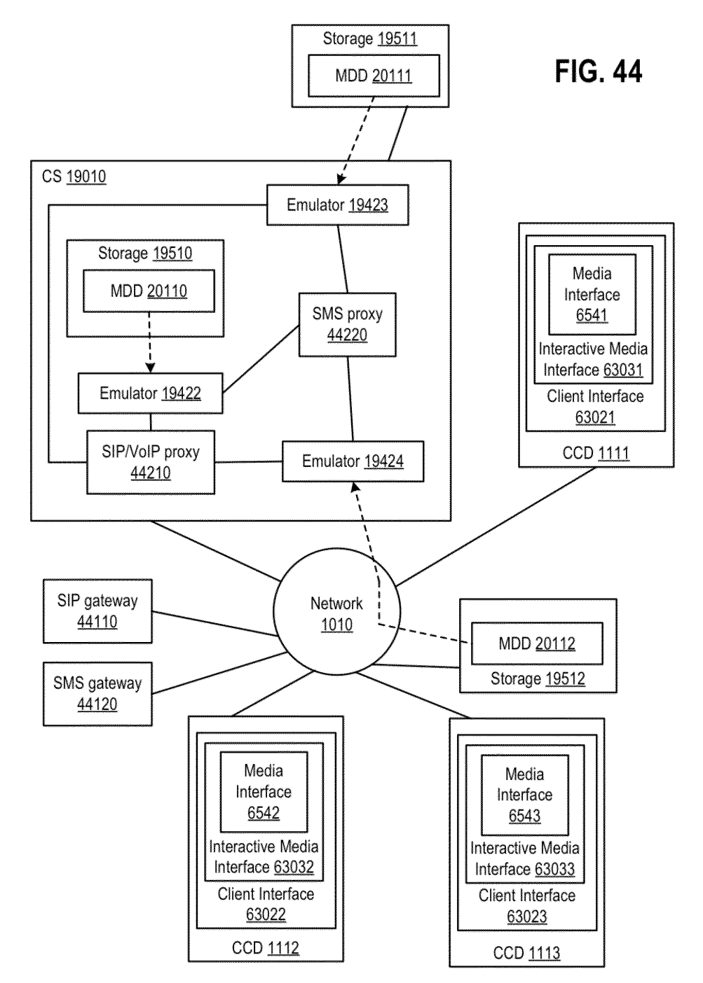

Turning now to FIG. 44, a network system that supports installation of data and configurations and utilization of multiple emulators is illustrated, according to one or more embodiments. As illustrated, a SIP gateway 44110 can be coupled to network 1010. In one or more embodiments, SIP gateway 44110 can include one or more same or similar structures and/or functionalities as described with reference to SIP gateway 41110. As shown, a SMS gateway 44120 can be coupled to network 1010. In one or more embodiments SMS gateway 44120 can include one or more same or similar structures and/or functionalities as described with reference to SMS gateway 41120.

As illustrated, CS 19010 can include a SIP/VoIP proxy 44210 coupled to emulators 19422-19424. In one or more embodiments, SIP/VoIP proxy 44210 and emulators 19422-19424 can communicate via one or more processes and/or methods described herein. As shown, CS 19010 can include a SMS proxy 44220 coupled to emulators 19422-19424. In one or more embodiments, SMS proxy 44220 and emulators 19422-19424 can communicate via one or more processes and/or methods described herein. In one or more embodiments, VoIP and/or IP encapsulated SMS and/or MMS termination can be implemented and/or provided within one or more emulators 19422-19424.

In one or more embodiments, SIP gateway 44110 and SIP/VoIP proxy 44210 can communicate via network 1010. For example, SIP gateway 44110 can route telephone calls and/or video calls to and/or from SIP/VoIP proxy 44210. In one instance, SIP/VoIP proxy 44210 can receive can emulate one or more signals (e.g., GSM signals, CDMA signals, etc.) that can carry the telephone calls and/or video calls and can provide signals that can carry the telephone calls and/or video calls to one or more of emulators 19422-19424. In another instance, SIP/VoIP proxy 44210 can receive one or more emulated signals (e.g., emulated GSM signals, emulated CDMA signals, etc.) that can carry the telephone calls and/or video calls from one or more emulators 19422-19424 and can provide the telephone calls and/or video calls to SIP gateway 44110.

In one or more embodiments, emulators 19422-19424 can be operated and/or controlled by respective CCDs 1111-1113. For example, emulators 19422-19424 can be operated and/or controlled by respective client interfaces 63021-63023. For instance, each of client interfaces 63021-63023 can include a web browser that operates and/or controls a respective emulator.

In one or more embodiments, each emulator of emulators 19422-19424 can provide and/or implement authentication, authorization, and/or access control to determine that a user can interact with, utilize, and/or operate the emulator. For example, an emulator of emulators 19422-19424 can receive identification information associated with a user and/or a user account and/or can receive a password associated with the user and/or the user account to determine that the user can interact with, utilize, and/or operate the emulator. In one instance, the emulator can authenticate and/or authorize the identification information and/or the password with a database. In a second instance, the emulator can authenticate and/or authorize the identification information and/or the password with at least one of a home location register (HLR) and a visiting location register (VLR), among others. In another instance, the emulator can authenticate and/or authorize the identification information and/or the password with an authentication, authorization, and accounting (AAA) server and/or service.

In one or more embodiments, if an incoming call or an incoming message occurs when a web browser that would interface with a web server of an emulator of emulators 19422-19424 is not executing or is not directed to the web server of the emulator, an alert can be provided to a user via a CCD (e.g., a CCD of CCDs 1111-1113) utilized by the user. In one example, the alert can include a display notification that can open a window displayed via a display associated with the CCD. In another example, the alert can include one or more sounds. In one instance, the one or more sounds can include one or more sounds of a telephone ringing. In another instance, the one or more sounds can include one or more sounds of a message arriving.

In one or more embodiments, if the emulator is not running or not executing, a telephone system associated with the emulator and/or a physical MD associated with the emulator can function as if the physical MD is turned off, is not functioning, and/or is not in communication with a Node B, a base transceiver station, or a satellite. For example, a VoIP, a SMS, and/or a MMS termination point for the emulator can be terminated. In one or more embodiments, an alternate notification process, method, and/or path can be utilized if the emulator is not running or not executing. In one example, a push notification can be provided to the CDD of the user. In another example, a text message (e.g., a SMS message, an email message, etc.) indicating that an incoming telephone call, voice message, and/or other message (e.g., a text message) can be provided to another device associated with the user. For instance, a SMS message can be provided to the other device (e.g., a wireless telephone, a pager, etc.) associated with the user and/or the identification information associated with the user.

In one or more embodiments, providing the text message (e.g., a SMS message, an email message, etc.) that indicates an incoming telephone call, voice message, and/or other message (e.g., a text message) can be based on a profile and/or a configuration associated with the user. For example, the profile and/or a configuration associated with the user can include a policy that can direct providing the text message (e.g., a SMS message, an email message, etc.) that indicates an incoming telephone call, voice message, and/or other message (e.g., a text message) to the other device associated with the user and/or the identification information associated with the user.

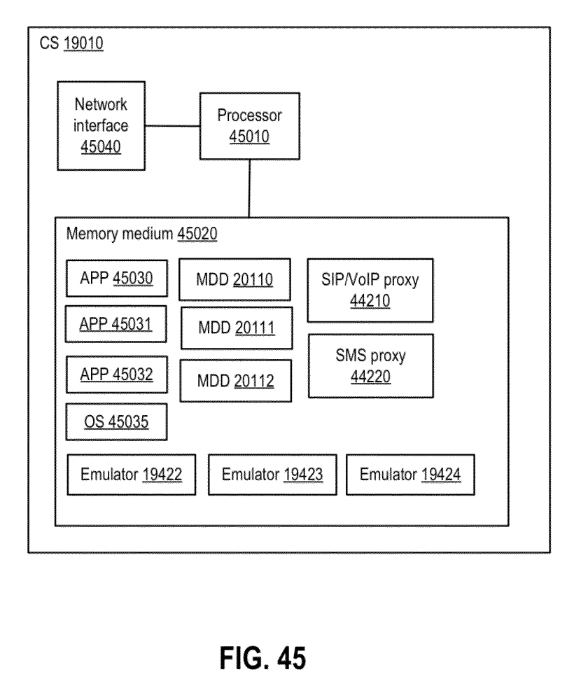

Turning now to FIG. 45, an exemplary computing system is illustrated, according to one or more embodiments. As shown, CS 19010 can include a processor 45010 coupled to a memory medium 45020. In one or more embodiments, memory medium 45020 can store data and/or instructions that can be executed by processor 45010. For example, memory medium 45020 can store one or more APPs 45030-45032, an OS 45035, MDDs 20110-20112, emulators 19422-19424, SIP/VoIP proxy 44210, and/or SMS proxy 44220. For instance, one or more of APPs 45030-45032, OS 45035, emulators 19422-19424, SIP/VoIP proxy 44210, and SMS proxy 44220 can include instructions of an ISA associated with processor 45010. In one or more embodiments, one or more of the processes and/or methods described here can be implemented when processor 45010 executes one or more of APPs 45030-45032, OS 45035, emulators 19422-19424, SIP/VoIP proxy 44210, and SMS proxy 44220.

As illustrated, CS 19010 can include a network interface 45040. In one example, network interface 2040 can interface with a wired network coupling, such as a wired Ethernet, a T-1, a T-3, an OC-12, a DSL modem, a PSTN, or a cable modem, among others. In another example, network interface 45040 can interface with a wireless network coupling, such as a satellite telephone system, a cellular telephone system, WiMax, or wireless Ethernet, among others.

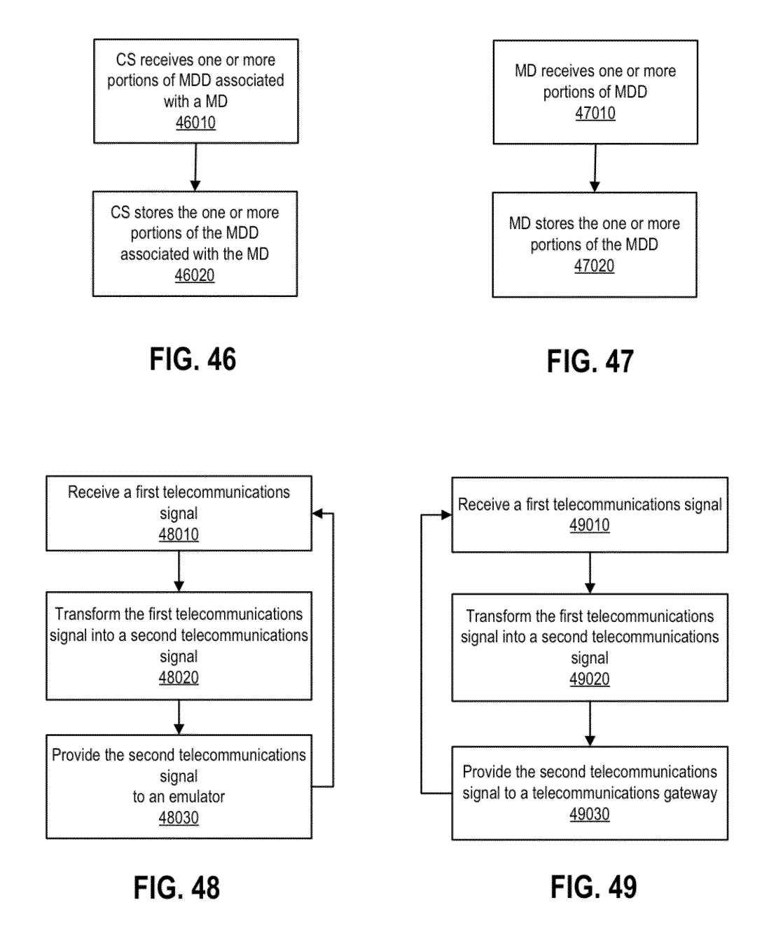

Turning now to FIG. 46, a method of a computer system receiving and storing mobile device data is illustrated, according to one or more embodiments. At 46010, a computer system can receive one or more portions of MDD associated with a MD. In one example, CS 19010 can receive, via network 1010, the one or more portions of MDD associated with the MD. In a second example, local CS 30011 can receive, via LAN 30010, the one or more portions of MDD associated with the MD. In another example, local CS can receive, via LAN 30010, the one or more portions of MDD associated with the MD.

In one or more embodiments, the MDD can be associated with one of MDs 19110-19112. In one example, the one or more portions of MDD associated with the MD can be or include an incremental backup and/or synchronization. In another example, the one or more portions of MDD associated with the MD can be or include all portions of the MDD. For instance, all portions of the MDD can be or include a “full” backup of the MD.

At 46020, the computer system can store the one or more portions of the MDD. In one example, the one or more portions of the MDD can be stored in non-volatile storage. In another example, the one or more portions of the MDD can be stored in a random access memory that can provide an emulator access to the one or more portions of the MDD in a fashion that can be faster than access to the one or more portions of the MDD via non-volatile storage.

Turning now to FIG. 47, a method of a mobile device receiving and storing mobile device data is illustrated, according to one or more embodiments. In one or more embodiments, a MD can receive can receive one or more portions of MDD associated with the MD, at 47010. In one example, the MD can receive, via network 1010, the one or more portions of MDD associated with the MD. In a second example, the MD can receive, via LAN 30010, the one or more portions of MDD associated with the MD.

In one or more embodiments, the one or more portions of MDD associated with the MD can be or include one or more incremental synchronizations and/or backups. In one or more embodiments, the one or more portions of MDD associated with the MD can be or include one or more changes of the MDD, after the MDD has been utilized by an emulator. In one example, a user can utilize the MDD via the MD, utilize the MDD via an emulator associated with the MD, and receive the one or more changes of the MDD, after the MDD has been utilized by an emulator.

In another example, a user can utilize the MDD via the MD, an emulator associated with the MD can utilize the MDD via the user and/or another user (e.g., a sales representative, a service representing, a representative of a retail establishment, a representative of a service provider, an artificial intelligence system, a neural network system, etc.), and receive the one or more changes of the MDD, after the MDD has been utilized by the emulator via the user and/or the other user. For instance, the other user (e.g., a service representative) can assist the user to configure his or her MD via providing the MDD to an emulator and can change one or more portions of the MDD (e.g., one or more configurations of the MD associated with the MDD), and the one or more portions of the MDD can be received by the MD after the other user assists the user to configure his or her MD via the emulator.

In one or more embodiments, the MD can store the one or more portions of the MDD, at 47020. In one example, the MD can store the one or more portions of MDD that include the one or more incremental synchronizations and/or backups. In a second example, the MD can store the one or more portions of MDD that include the one or more changes of the MDD, after the MDD has been utilized by an emulator. In another example, the MD can store the one or more portions of MDD that include the one or more changes of the MDD after the MDD has been utilized by an emulator that was utilized by another user (e.g., a sales representative, a service representing, a representative of a retail establishment, a representative of a service provider, etc.) or an assistance system (e.g., an artificial intelligence system, a neural network system, etc.).

In one or more embodiments, the one or more portions of MDD can be associated with a first MD, and a second MD, different from the first MD, can receive the one or more portions of MDD associated with the first MD, at 47010. In one example, the MDD can be a base or a template for multiple MDs. For instance, MDD that can be a base or a template can be a base or a template for multiple MDs of a sales group of a company. In a second example, the second MD can be a replacement for the first MD. In another example, the second MD can augment and/or be an addition to the first MD. In one instance, the first MD can be or include a mobile wireless telephone, and the second MD can be or include a tablet computing device. In a second instance, the first MD can be or include a first mobile wireless telephone associated with a first MIN, and the second MD can be or include a second wireless telephone associated with a second MIN, different from the first MIN. In another instance, the first MD can be or include a first mobile wireless telephone, and the second MD can be or include an emulation of the first mobile wireless telephone.

In one or more embodiments, the second MD can store the one or more portions of the MDD, at 47020. For example, the second MD can store the one or more portions of MDD associated with the first MD.

Turning now to FIG. 48, a method of transforming telecommunications signals is illustrated, according to one or more embodiments. At 48010, a first telecommunications signal can be received. In one example, the first telecommunications signal can be received from SIP gateway 44110. In a second example, the first telecommunications signal can be received from SMS gateway 44120.

In a third example, the first telecommunications signal can include a SIP telecommunications signal. For instance, SIP/VoIP proxy 44210 can receive the SIP telecommunications signal. In a fourth example, the first telecommunication signal can include a VoIP telecommunications signal. For instance, SIP/VoIP proxy 44210 can receive the VoIP telecommunications signal. In another example, the first telecommunication signal can include a SMS or MMS telecommunications signal. For instance, SMS proxy 44220 can receive the SMS or MMS telecommunications signal.

At 48020, the first telecommunication signal can be transformed into a second telecommunications signal. In one example, the first telecommunications signal can be transformed into a CDMA telecommunications signal. In one instance, SIP/VoIP proxy 44210 can transform the first telecommunications signal into the CDMA telecommunications signal. In another instance, SMS proxy 44220 can transform the first telecommunications signal into the CDMA telecommunications signal. In another example, the first telecommunications signal can be transformed into a GSM telecommunications signal. In one instance, SIP/VoIP proxy 44210 can transform the first telecommunications signal into the GSM telecommunications signal. In another instance, SMS proxy 44220 can transform the first telecommunications signal into the GSM telecommunications signal.

At 48030, the second communications signal can be provided to an emulator. In one example, SIP/VoIP proxy 44210 can provide the second telecommunications to the emulator (e.g., an emulator of emulators 19422-19424). In another example, SMS proxy 44220 can provide the second telecommunications to the emulator (e.g., an emulator of emulators 19422-19424).

In one or more embodiments, the method illustrated in FIG. 48 can be repeated to transform additional telecommunications signals and provide the transformed telecommunications signals to one or more emulators. In one or more embodiments, the second telecommunications signals can be routed to different emulators based on different network identifications associated with the first telecommunications signals. For example, the different network identifications associated with the first telecommunications signals can include different IP addresses (e.g., different IP version 4 addresses, different IP version 6 addresses, etc.), different MAC addresses, different electronic serial numbers (ESNs), different mobile information numbers (MINs), and different mobile directory numbers (MDNs), among others.

Turning now to FIG. 49, a method of transforming telecommunications signals is illustrated, according to one or more embodiments. At 49010, a first telecommunication signal can be received. In one or more embodiments, the telecommunication signal can be received from an emulator (e.g., an emulator of emulators 19422-19424. In one example, the first telecommunications signal can include a CDMA telecommunications signal. In one instance, SIP/VoIP proxy 44210 can receive the CDMA telecommunications signal. In another instance, SIP/VoIP proxy 44210 can receive the CDMA telecommunications signal. In another example, the first telecommunication signal can include a GSM telecommunications signal. In one instance, SIP/VoIP proxy 44210 can receive the GSM telecommunications signal. In another instance, SMS proxy 44220 can receive the GSM telecommunications signal.

At 49020, the first telecommunications signal can be transformed into a second telecommunications signal. In one example, the first telecommunications signal can be transformed into a SIP telecommunications signal. For instance, SIP/VoIP proxy 44210 can transform the first telecommunications signal into the SIP telecommunications signal. In a second example, the first telecommunications signal can be transformed into a VoIP telecommunications signal. For instance, SIP/VoIP proxy 44210 can transform the first telecommunications signal into the VoIP telecommunications signal. In a third example, the first telecommunications signal can be transformed into a SMS telecommunications signal. For instance, SMS proxy 44220 can transform the first telecommunications signal into the SMS telecommunications signal. In another example, the first telecommunications signal can be transformed into a MMS telecommunications signal. For instance, SMS proxy 44220 can transform the first telecommunications signal into the MMS telecommunications signal.

At 49030, the second telecommunications signal can be provided to a telecommunications gateway. In one example, SIP/VoIP proxy 44210 can provide the second telecommunications signal to SIP gateway 44110. In another example, SMS proxy 44220 can provide the second telecommunications signal to SMS gateway 44120.

In one or more embodiments, the method illustrated in FIG. 49 can be repeated to transform additional telecommunications signals and provide the transformed telecommunications signals to one or more telecommunications gateways. In one or more embodiments, the second telecommunications signals can be routed to different telecommunications gateways and/or endpoints based on different network identifications associated with the first telecommunications signals. For example, the different network identifications associated with the first telecommunications signals can include different IP addresses (e.g., different IP version 4 addresses, different IP version 6 addresses, etc.), different MAC addresses, different ESNs, different MINs, and different MDNs, among others.

In one or more embodiments, the methods illustrated in FIGS. 48 and 49 can be utilized with local CS 30011, as well as CS 19010. For example, SIP/VoIP proxy 41210 of local CS 30011 can be utilized in place of SIP/VoIP proxy 44210 of CS 19010, and SMS proxy 41220 of local CS 30011 can be utilized in place of SIP/VoIP proxy 44220 of CS 19010.

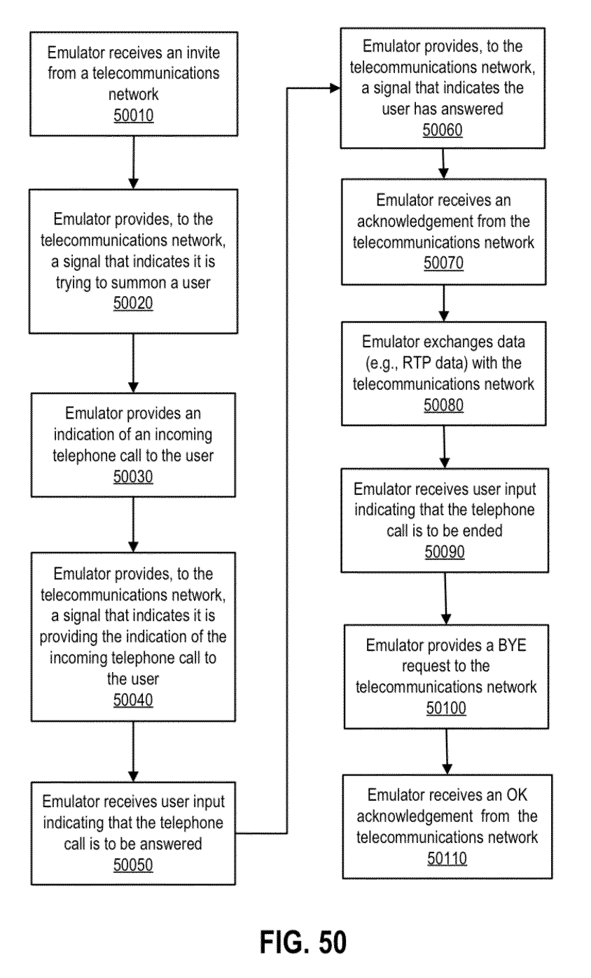

Turning now to FIG. 50, a method of utilizing an emulator is illustrated, according to one or more embodiments. At 50010, an emulator can receive an invite from a telecommunications network. In one or more embodiments, the invite can indicate that a telephone is calling the emulator.

In one or more embodiments, receiving the invite can include receiving the signal that indicates the invite. For example, receiving, via SIP, the signal that indicates the invite can include receiving the invite via one or more of a SIP gateway and a SIP proxy. In one instance, emulator 19422 can receive the signal that indicates the invite via SIP gateway 44110 and via SIP/VoIP proxy 41210. In another instance, emulator 19423 can receive the signal that indicates the invite via SIP gateway 44110 and via SIP/VoIP proxy 44210.

At 50020, the emulator can provide a signal to the telecommunications network that indicates it is trying to summon a user (e.g., a called party). At 50030, the emulator can provide an indication of an incoming telephone call to the user. In one example, emulator 19422 can provide the indication of the incoming telephone call to the user via client app 41230. In another example, emulator 19423 can provide the indication of the incoming telephone call to the user via client interface 63022. In one or more embodiments, client interface 63022 can be or include a web browser.

At 50040, the emulator can provide, to the telecommunications network, a signal that indicates that it is providing the indication of the incoming telephone call to the user. For example, the signal that indicates that the emulator is providing the indication of the incoming telephone call to the user can be provided to the telecommunications network via SIP. In one instance, emulator 19422 can provide the signal that indicates that emulator 19422 is providing the indication of the incoming telephone call to the user can be provided to the telecommunications network via SIP gateway 44110 and via SIP/VoIP proxy 41210. In another instance, emulator 19423 can provide the signal that indicates that emulator 19423 is providing the indication of the incoming telephone call to the user can be provided to the telecommunications network via SIP gateway 4410 and via SIP/VoIP proxy 44210.

At 50050, the emulator can receive user input that indicates that the telephone call is to be answered. In one example, emulator 19422 can receive the user input that indicates that the telephone call is to be answered via client app 41230. In another example, emulator 19423 can receive the user input that indicates that the telephone call is to be answered via client interface 63022.

At 50060, the emulator can provide, to the telecommunications network, a signal that indicates the user has answered the call. For example, the signal that indicates the user has answered the call can be provided to the telecommunications network via SIP. In one instance, emulator 19422 can provide the signal that indicates the user has answered the call can be provided to the telecommunications network via SIP gateway 44110 and via SIP/VoIP proxy 41210. In another instance, emulator 19423 can provide the signal that indicates the user has answered the call can be provided to the telecommunications network via SIP gateway 4410 and via SIP/VoIP proxy 44210.

At 50070, the emulator can receive an acknowledgement from the telecommunications network. For example, a signal that indicates the acknowledgement can be received from the telecommunications network via SIP. In one instance, emulator 19422 can receive the signal that indicates the acknowledgement from the telecommunications network via SIP gateway 44110 and via SIP/VoIP proxy 41210. In another instance, emulator 19423 can receive the signal that indicates the acknowledgement from the telecommunications network via SIP gateway 4410 and via SIP/VoIP proxy 44210.

At 50080, the emulator can exchange data (e.g., RTP (real-time protocol) data) with the telecommunications network. In one example, emulator 19422 can exchange the data with the telecommunications network via SIP gateway 44110 and via SIP/VoIP proxy 41210. In another example, emulator 19423 can exchange the data with the telecommunications network via SIP gateway 4410 and via SIP/VoIP proxy 44210. In one or more embodiments, the RTP can include a packet format for delivering audio and/or video via an IP network.

At 50090, the emulator can receive user input that indicates that the telephone call is to be ended. In one example, emulator 19422 can receive the user input that indicates that the telephone call is to be ended via client app 41230. In another example, emulator 19423 can receive the user input that indicates that the telephone call is to be ended via client interface 63022.

At 50100, the emulator can provide a BYE request to the telecommunications network. For example, a signal that indicates the BYE request can be provided to the telecommunications network via SIP. In one instance, emulator 19422 can provide the signal that indicates the BYE request to the telecommunications network via SIP gateway 44110 and via SIP/VoIP proxy 41210. In another instance, emulator 19423 can provide the signal that indicates the BYE request to the telecommunications network via SIP gateway 4410 and via SIP/VoIP proxy 44210.

At 50110, the emulator can receive an OK acknowledgement from the telecommunications network. For example, a signal that indicates the OK acknowledgement can be received from the telecommunications network via SIP. In one instance, emulator 19422 can receive the signal that indicates the OK acknowledgement from the telecommunications network via SIP gateway 44110 and via SIP/VoIP proxy 41210. In another instance, emulator 19423 can receive the signal that indicates the OK acknowledgement from the telecommunications network via SIP gateway 4410 and via SIP/VoIP proxy 44210.

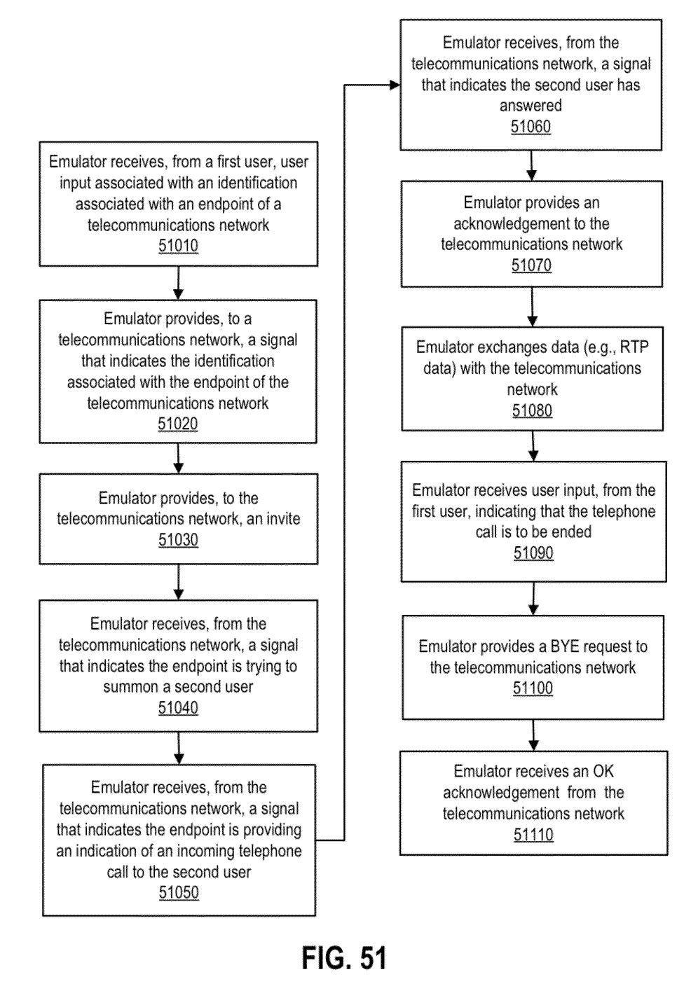

Turning now to FIG. 51, a method of utilizing an emulator is illustrated, according to one or more embodiments. At 51010, an emulator can receive, from a first user, user input associated with a network identification associated with an endpoint (e.g., a telephony device configured to be operated by a user, another emulator, a wireless telephone, a wired telephone, an auto-attendant, a conferencing system, etc.) of a telecommunications network. In one example, the user input from the first user can include a selection from a contacts list and/or database. For instance, each selectable element of the contacts list and/or database can be associated with at least one network identification associated with an endpoint of the telecommunications network. In another example, the user input from the first user can include a telephone number. In one or more embodiments, the network identification associated with the endpoint can include one or more of an IP addresses (e.g., an IP version 4 address, an IP version 6 address, etc.), a MAC address, an ESN, a MIN, and a MDN, among others.

At 51020, an emulator can provide, to a telecommunications network, a signal that indicates the network identification associated with the endpoint. In one or more embodiments, providing the signal that indicates the network identification associated with the endpoint can include providing the signal that indicates the network identification associated with the endpoint via SIP. In one example, emulator 19422 can provide the signal that indicates the network identification associated with the endpoint via SIP gateway 44110 and via SIP/VoIP proxy 41210. In another example, emulator 19423 can provide the signal that indicates the network identification associated with the endpoint via SIP gateway 44110 and via SIP/VoIP proxy 41210.

At 51030, the emulator can provide an invite to a telecommunications network. In one or more embodiments, providing the invite to the telecommunications network can include providing, to the telecommunications network, a signal that indicates the invite via SIP. In one example, emulator 19422 can provide the signal that indicates the invite via SIP gateway 44110 and via SIP/VoIP proxy 41210. In another example, emulator 19423 can receive the signal that indicates the invite via SIP gateway 44110 and via SIP/VoIP proxy 44210.

At 51040, the emulator can receive a signal from the telecommunications network that indicates the endpoint is trying to summon a second user (e.g., a called party). In one or more embodiments, receiving the signal from the telecommunications network that indicates the endpoint is trying to summon the second user can include receiving, via SIP, the signal from the telecommunications network that indicates the endpoint is trying to summon the second user. In one example, emulator 19422 can receive the signal that indicates the endpoint is trying to summon the second user via SIP gateway 44110 and via SIP/VoIP proxy 41210. In another example, emulator 19423 can receive the signal that indicates the endpoint is trying to summon the second user via SIP gateway 44110 and via SIP/VoIP proxy 44210.

At 51050, the emulator can receive, from the telecommunications network, a signal that indicates that the endpoint is providing an indication of an incoming telephone call to the second user. In one or more embodiments, receiving the signal that indicates that the endpoint is providing the indication of the incoming telephone call to the second user can include receiving the signal that indicates that the endpoint is providing the indication of the incoming telephone call to the second user via SIP. In one example, emulator 19422 can receive the signal that indicates that the endpoint is providing the indication of the incoming telephone call to the second user via SIP gateway 44110 and via SIP/VoIP proxy 41210. In another example, emulator 19423 can receive the signal that indicates that the endpoint is providing the indication of the incoming telephone call to the second user via SIP gateway 44110 and via SIP/VoIP proxy 44210.

In one or more embodiments, the emulator can indicate, to the first user, that the endpoint is providing the indication of the incoming telephone call to the second user. In one example, the emulator can indicate, to the first user, that the endpoint is providing the indication of the incoming telephone call to the second user via a message and/or a graphic. In one instance, emulator 19422 can display, to the first user, a message and/or a graphic that the endpoint is providing the indication of the incoming telephone call to the second user via client app 41230. In another instance, emulator 19423 can display, to the first user, a message and/or a graphic that the endpoint is providing the indication of the incoming telephone call to the second user via client interface 63022.

In another example, the emulator can indicate, to the first user, that the endpoint is providing the indication of the incoming telephone call to the second user via one or more sounds. In one instance, emulator 19422 can indicate, to the first user, via a speaker associated with local CS 30011. In another instance, emulator 19422 can indicate, to the first user, via a speaker associated with CCD 1112. In one or more embodiments, one or more sounds that indicate, to the first user, that the endpoint is providing the indication of the incoming telephone call to the second user can include a ring-back.

At 51060, the emulator can receive, from the telecommunications network, a signal that indicates the second user has answered. For example, the signal that indicates the second user has answered the telephone call can be received from the telecommunications network via SIP. In one instance, emulator 19422 can receive the signal that indicates the second user has answered the telephone call can be received from the telecommunications network via SIP gateway 44110 and via SIP/VoIP proxy 41210. In another instance, emulator 19423 can receive the signal that indicates the second user has answered the telephone call can be received from the telecommunications network via SIP gateway 4410 and via SIP/VoIP proxy 44210.

At 51070, the emulator can provide an acknowledgement to the telecommunications network. For example, a signal that indicates the acknowledgement can be provided to the telecommunications network via SIP. In one instance, emulator 19422 can provide the signal that indicates the acknowledgement to the telecommunications network via SIP gateway 44110 and via SIP/VoIP proxy 41210. In another instance, emulator 19423 can provide the signal that indicates the acknowledgement to the telecommunications network via SIP gateway 4410 and via SIP/VoIP proxy 44210.

At 51080, the emulator can exchange data (e.g., RTP (real-time protocol) data) with the telecommunications network. In one example, emulator 19422 can exchange the data with the telecommunications network via SIP gateway 44110 and via SIP/VoIP proxy 41210. In another example, emulator 19423 can exchange the data with the telecommunications network via SIP gateway 4410 and via SIP/VoIP proxy 44210. In one or more embodiments, the RTP can include a packet format for delivering audio and/or video via an IP network.

At 51090, the emulator can receive user input, from the first user, that indicates that the telephone call is to be ended. In one example, emulator 19422 can receive the user input, from the first user, that indicates that the telephone call is to be ended via client app 41230. In another example, emulator 19423 can receive the user input, from the first user, that indicates that the telephone call is to be ended via client interface 63022.

At 51100, the emulator can provide a BYE request to the telecommunications network. For example, a signal that indicates the BYE request can be provided to the telecommunications network via SIP. In one instance, emulator 19422 can provide the signal that indicates the BYE request to the telecommunications network via SIP gateway 44110 and via SIP/VoIP proxy 41210. In another instance, emulator 19423 can provide the signal that indicates the BYE request to the telecommunications network via SIP gateway 4410 and via SIP/VoIP proxy 44210.

At 51110, the emulator can receive an OK acknowledgement from the telecommunications network. For example, a signal that indicates the OK acknowledgement can be received from the telecommunications network via SIP. In one instance, emulator 19422 can receive the signal that indicates the OK acknowledgement from the telecommunications network via SIP gateway 44110 and via SIP/VoIP proxy 41210. In another instance, emulator 19423 can receive the signal that indicates the OK acknowledgement from the telecommunications network via SIP gateway 4410 and via SIP/VoIP proxy 44210.

In one or more embodiments, the term “memory medium” can mean a “memory”, a “memory device”, and/or “tangible computer readable storage medium”. In one example, one or more of a “memory”, a “memory device”, and “tangible computer readable storage medium” can include volatile storage such as SRAM, DRAM, Rambus RAM, EDO RAM, random access memory, etc. In another example, one or more of a “memory”, a “memory device”, and “tangible computer readable storage medium” can include nonvolatile storage such as a CD-ROM, a DVD-ROM, a floppy disk, a magnetic tape, EEPROM, EPROM, flash memory, NVRAM, FRAM, a magnetic media (e.g., a hard drive), optical storage, etc. In one or more embodiments, a memory medium can include one or more volatile storages and/or one or more nonvolatile storages.

In one or more embodiments, a computer system, a computing device, and/or a computer can be broadly characterized to include any device that includes a processor that executes instructions from a memory medium. For example, a processor (e.g., a central processing unit or CPU) can execute instructions from a memory medium that stores the instructions which can include one or more software programs in accordance with one or more of methods, processes, and/or flowcharts described herein. For instance, the processor and the memory medium, that stores the instructions which can include one or more software programs in accordance with one or more of methods, processes, and/or flowcharts described herein, can form one or more means for one or more functionalities described with references to methods, processes, and/or flowcharts described herein. In one or more embodiments, a memory medium can be and/or can include an article of manufacture, a program product, and/or a software product. For example, the memory medium can be coded and/or encoded with instructions in accordance with one or more of methods, processes, and/or flowcharts described herein to produce an article of manufacture, a program product, and/or a software product.

One or more of the method elements described herein and/or one or more portions of an implementation of a method element can be repeated, can be performed in varying orders, can be performed concurrently with one or more of the other method elements and/or one or more portions of an implementation of a method element, or can be omitted, according to one or more embodiments. In one or more embodiments, concurrently can mean simultaneously. In one or more embodiments, concurrently can mean apparently simultaneously according to some metric. For example, two tasks can be context switched such that such that they appear to be simultaneous to a human. In one instance, a first task of the two tasks can include a first method element and/or a first portion of a first method element. In a second instance, a second task of the two tasks can include a second method element and/or a first portion of a second method element. In another instance, a second task of the two tasks can include the first method element and/or a second portion of the first method element. Further, one or more of the system elements described herein can be omitted and additional system elements can be added as desired, according to one or more embodiments. Moreover, supplementary, additional, and/or duplicated method elements can be instantiated and/or performed as desired, according to one or more embodiments.

One or more modifications and/or alternatives of the embodiments described herein may be apparent to those skilled in the art in view of this description. Hence, descriptions of the embodiments, described herein, are to be taken and/or construed as illustrative and/or exemplary only and are for the purpose of teaching those skilled in the art the general manner of carrying out an invention described in the appended claims. In one or more embodiments, one or more materials and/or elements can be swapped or substituted for those illustrated and described herein. In one or more embodiments, one or more parts and/or processes can be reversed, and/or certain one or more features of the described one or more embodiments can be utilized independently, as would be apparent to one skilled in the art after having the benefit of this description.

What is claimed is:

1. A method, comprising:
receiving first information, associated with a first network address, from a first computing device via a network;
receiving second information, associated with a second network address that is different from the first network address, from a second computing device, different from the first computing device, via the network;
in response to said receiving the first information, providing third information, associated with the first network address, to the network, wherein the third information includes first data utilizable, by a first client interface associated with the first computing device, to display a three-dimensional simulation of a first simulated object and to change a viewing angle of the first simulated object; and
in response to said receiving the second information, providing fourth information, associated with the second network address, to the network, wherein the fourth information includes second data utilizable, by a second client interface associated with the second computing device, to display a three-dimensional simulation of a second simulated object and to change a viewing angle of the second simulated object.

2. The method of claim 1,
wherein the three-dimensional simulation of the first simulated object includes a first series of two-dimensional graphics; and
wherein the three-dimensional simulation of the second simulated object includes a second series of two-dimensional graphics.

3. The method of claim 2,
wherein each of the first series of two-dimensional graphics is a projection of first three-dimensional data associated with the first simulated object; and
wherein each of the second series of two-dimensional graphics is a projection of second three-dimensional data associated with the second simulated object.

4. The method of claim 1,
wherein the first data includes a first icon that is selectable to change the viewing angle of the first simulated object; and
wherein the second data includes a second icon that is selectable to change the viewing angle of the second simulated object.

5. The method of claim 1, wherein the first simulated object includes at least one of a computer, a cellular telephone, a satellite telephone, a tablet computing device, a personal digital assistant, a digital music player device, a television, and a printer device.

6. The method of claim 5, wherein the first simulated object includes at least one icon that is user selectable to simulate at least one of a simulated keypad, a simulated calculator application, a simulated clock application, a simulated calendar application, a simulated web browser application, a simulated video chat application, and a simulated setting/configuration application.

7. The method of claim 1,
wherein the first data includes a first operational aid that simulates a process of coupling the first simulated object with at least one of a first computing device, a charging device, and an audio output device;
wherein the second data includes a second operational aid that simulates a process of coupling the second simulated object with at least one of the computing device, the charging device, and the audio output device.

8. The method of claim 1, wherein the third information is configured for a web browser.

9. A computer readable memory device that includes instructions, which when executed by a processor, the processor receives first information, associated with a first network address, from a first computing device via a network; receives second information, associated with a second network address that is different from the first network address, from a second computing device, different from the first computing device, via the network; provides, in response to receiving the first information, third information, associated with the first network address, to the network, wherein the third information includes first data utilizable, by a first client interface associated with the first computing device, to display a three-dimensional simulation of a first simulated object and to change a viewing angle of the first simulated object; and provides, in response to said receiving the second information, fourth information, associated with the second network address, to the network, wherein the fourth information includes second data utilizable, by a second client interface associated with the second computing device, to display a three-dimensional simulation of a second simulated object and to change a viewing angle of the second simulated object.

10. The computer readable memory device of claim 9,
wherein the three-dimensional simulation of the first simulated object includes a first series of two-dimensional graphics; and
wherein the three-dimensional simulation of the second simulated object includes a second series of two-dimensional graphics.

11. The computer readable memory device of claim 10,
wherein each of the first series of two-dimensional graphics is a projection of first three-dimensional data associated with the first simulated object; and
wherein each of the second series of two-dimensional graphics is a projection of second three-dimensional data associated with the second simulated object.

12. The computer readable memory device of claim 9,
wherein the first data includes a first icon that is selectable to change the viewing angle of the first simulated object; and
wherein the second data includes a second icon that is selectable to change the viewing angle of the second simulated object.

13. The computer readable memory device of claim 9, wherein the first simulated object includes at least one of a computer, a cellular telephone, a satellite telephone, a tablet computing device, a personal digital assistant, a digital music player device, a television, and a printer device.

14. The computer readable memory device of claim 13, wherein the first simulated object includes at least one icon that is user selectable to simulate at least one of a simulated keypad, a simulated calculator application, a simulated clock application, a simulated calendar application, a simulated web browser application, a simulated video chat application, and a simulated setting/configuration application.

15. The computer readable memory device of claim 9,
wherein the first data includes a first operational aid that simulates a process of coupling the first simulated object with at least one of a first computing device, a charging device, and an audio output device;
wherein the second data includes a second operational aid that simulates a process of coupling the second simulated object with at least one of the computing device, the charging device, and the audio output device.

16. The computer readable memory device of claim 9, wherein the third information is configured for a web browser.

17. A system, comprising:
a first means for receiving first information, associated with a first network address, from a first computing device via a network;
a second means for receiving second information, associated with a second network address that is different from the first network address, from a second computing device, different from the first computing device, via the network;
a third means for providing, in response to the first means receiving the first information, third information, associated with the first network address, to the network, wherein the third information includes first data utilizable, by a first client interface associated with the first computing device, to display a three-dimensional simulation of a first simulated object and to change a viewing angle of the first simulated object; and
a fourth means for providing, in response to the second means receiving the second information, fourth information, associated with the second network address, to the network, wherein the fourth information includes second data utilizable, by a second client interface associated with the second computing device, to display a three-dimensional simulation of a second simulated object and to change a viewing angle of the second simulated object.

18. The system of claim 17,
wherein the three-dimensional simulation of the first simulated object includes a first series of two-dimensional graphics; and
wherein the three-dimensional simulation of the second simulated object includes a second series of two-dimensional graphics.

19. The system of claim 18,
wherein each of the first series of two-dimensional graphics is a projection of first three-dimensional data associated with the first simulated object; and
wherein each of the second series of two-dimensional graphics is a projection of second three-dimensional data associated with the second simulated object.

20. The system of claim 17,
wherein the first data includes a first icon that is selectable to change the viewing angle of the first simulated object; and
wherein the second data includes a second icon that is selectable to change the viewing angle of the second simulated object.

21. The system of claim 17, wherein the first simulated object includes at least one of a computer, a cellular telephone, a satellite telephone, a tablet computing device, a personal digital assistant, a digital music player device, a television, and a printer device.

22. The system of claim 21, wherein the first simulated object includes at least one icon that is user selectable to simulate at least one of a simulated keypad, a simulated calculator application, a simulated clock application, a simulated calendar application, a simulated web browser application, a simulated video chat application, and a simulated setting/configuration application.

23. The system of claim 17,
wherein the first data includes a first operational aid that simulates a process of coupling the first simulated object with at least one of a first computing device, a charging device, and an audio output device;
wherein the second data includes a second operational aid that simulates a process of coupling the second simulated object with at least one of the computing device, the charging device, and the audio output device.

24. The system of claim 17, wherein the third information is configured for a web browser.

25. An article of manufacture comprising a computer readable memory device that includes instructions, which when executed by a processor, the processor receives first information, associated with a first network address, from a first computing device via a network; receives second information, associated with a second network address that is different from the first network address, from a second computing device, different from the first computing device, via the network; provides, in response to receiving the first information, third information, associated with the first network address, to the network, wherein the third information includes first data utilizable, by a first client interface associated with the first computing device, to display a three-dimensional simulation of a first simulated object and to change a viewing angle of the first simulated object; and provides, in response to said receiving the second information, fourth information, associated with the second network address, to the network, wherein the fourth information includes second data utilizable, by a second client interface associated with the second computing device, to display a three-dimensional simulation of a second simulated object and to change a viewing angle of the second simulated object.
